(19) United States
(12) Patent Application Publication
(10) Pub. No.: US 2016/0259546 A1
(43) Pub. Date: Sep. 8, 2016

(54) Electronic Device, Operating Method Thereof, and Recording Medium

(71) Applicant: Samsung Electronics Co., Ltd., Suwon-si (KR)

(72) Inventor: Hyun-Jun SHIM, Hwaseong-si (KR)

(21) Appl. No.: 15/060,143

(22) Filed: Mar. 3, 2016

(30) Foreign Application Priority Data
Mar. 4, 2015 (KR) 10-2015-0030563

(51) Int. Cl. G06F 3/0488; G06F 3/0484; G06F 3/0489

(52) U.S. Cl. CPC G06F 3/04886; G06F 3/04897; G06F 3/04842

(57) ABSTRACT

Disclosed are an electronic device, an operating method thereof, and a recording medium. The electronic device, according to various embodiments of the present disclosure, includes: a display module; and a processor that controls to display, on the display module, a keypad that contains input elements for inputting a character to the electronic device, wherein at least some of the displayed input elements are displayed to correspond to at least one of a location where at least one character element that forms the character is disposed in the character and a pattern in which a user actually uses the character.

### RELATED APPLICATION(S)

This application claims the priority under 35 U.S.C. §119(a) to Korean Application Serial No. 10-2015-0030563, which was filed in the Korean Intellectual Property Office on Mar. 4, 2015, the entire content of which is hereby incorporated by reference.

### BACKGROUND

The present disclosure relates to an electronic device, an operating method thereof, and a recording medium.

As portable terminals, such as smart phones (e.g., Samsung Galaxy S™, etc.), have been widely used by users, the demand for wearable devices (e.g., SAMSUNG Galaxy Gear™, etc.) that are connected to the portable terminals through wireless (or wired) communication has also rapidly increased. The wearable devices may perform various function(s) or operation(s) for controlling the portable terminals while being connected to the portable terminals.

FIG. 1 is an exemplary view illustrating a function or operation by which a keypad 100a is provided to a user through a wearable device 10b in the related art. In FIG. 1, a smart watch is illustrated as the wearable device 10b.

Referring to FIG. 1, the keypad 100a in the related art may be generally provided to the user in a 3×4 array through a portable terminal 10a, as illustrated in FIG. 1. The keypad 100a in the related art may be provided to the user in such a manner that the keypad 100a is displayed on the portable terminal 10a. As illustrated in FIG. 1, the keypad 100a in the related art may be provided to the user through the wearable device 10b that includes a display module that is smaller in size than the portable terminal 10a. The keypad 100a in the related art may be provided to the user in such a manner that the keypad 100a is displayed on the wearable device 10b. In FIG. 1, the keypad 100a for inputting the Hangul characters is illustrated as an example.

### SUMMARY

In cases where the keypad 100a in the related art is provided to the user through the wearable device 10b as illustrated in FIG. 1, the reduced keypad 100a may be provided to the user due to a limitation in the size of the display module equipped to the wearable device 10b, which makes it difficult to accurately receive the user's input through the keypad 100a in the related art.

Further, in cases where the keypad 100a in the related art is provided to the user through the wearable device 10b as illustrated in FIG. 1, the area where the keypad 100a in the related art is displayed occupies a large portion of the display module equipped to the wearable device 10b so that it is difficult to effectively provide different information to the user while the keypad 100a in the related art is displayed on the wearable device 10b.

Disclosed in the present disclosure is an electronic device that provides a keypad that can accurately receive an input from a user even in the case where a character is input through the keypad displayed on the electronic device that has a small display module like the wearable device 10b.

Disclosed in the present disclosure is an electronic device that provides a keypad that includes input elements that are determined based on the locations of character elements constituting the input character and/or the actual use pattern of the input character, thereby enabling the user to intuitively input the character.

Disclosed in the present disclosure is a method of operating an electronic device that provides a keypad that can accurately receive an input from a user even in the case where a character is input through the keypad that is displayed on the electronic device that has a small display module like the wearable device 10b.

Disclosed in the present disclosure is a method of operating an electronic device that provides a keypad that includes input elements that are determined based on the locations of character elements constituting the input character and/or the actual use pattern of the input character, thereby enabling the user to intuitively input the character.

The technical objectives disclosed in the present disclosure are not limited to the aforementioned technical objectives, and unmentioned or other technical objectives will be clearly appreciated by those skilled in the art from the following description.

The present disclosure provides an electronic device that includes: a display module; and a processor that controls to display, on the display module, a keypad having a plurality of input elements to input a character to the electronic device, wherein some of the plurality of the input elements displayed correspond to a location where a character element that forms the character is disposed and a pattern in which a user uses the character.

The present disclosure provides a method of operating an electronic device, including: displaying a keypad that contains input elements for inputting a character; receiving an input for selecting at least one of the displayed input elements; and displaying a character corresponding to some of the plurality of input elements selected, wherein some of the plurality of the input elements displayed correspond to a location of a character element that forms the character and a use pattern of the character.

According to the present disclosure, even when a character is input through an electronic device that has a small display module, it is possible to accurately receive the input from the user and to accurately provide the intended character to the user.

According to the present disclosure, a user can intuitively input a character through a keypad that includes input elements that are determined based on the locations of character elements constituting the input character and/or the actual use pattern of the input character.

It will be apparent to those skilled in the art that the advantages of the present disclosure are not limited to those mentioned above, and the present disclosure includes various implicit advantages.

### BRIEF DESCRIPTION OF THE DRAWINGS

The above and other aspects, features, and advantages of the present disclosure will be more apparent from the following detailed description taken in conjunction with the accompanying drawings, in which:

FIGS. 1A and 1B are exemplary views illustrating a function or operation by which a keypad is provided to a user through a wearable device in the related art;

FIG. 2 is a block diagram of an electronic device according to various embodiments of the present disclosure;

FIG. 3 is an exemplary view illustrating a keypad, according to various embodiments of the present disclosure, which is provided to a user through an electronic device according to various embodiments of the present disclosure;

FIG. 4 is an exemplary view illustrating a correspondence relation between input elements and character elements, according to various embodiments of the present disclosure;

FIG. 5 is a reference view schematically (e.g., as listed in Tables I through IV) illustrating actual examples of inputting a character, which will be described in the present disclosure;

FIGS. 6A through 6N are exemplary views illustrating actual examples of inputting characters (e.g., Hangul consonants) through a keypad, according to various embodiments of the present disclosure;

FIGS. 7A through 7J are exemplary views illustrating actual examples of inputting characters (e.g., Hangul vowels) through a keypad, according to various embodiments of the present disclosure;

FIGS. 8A through 8R are exemplary views illustrating actual examples of inputting a character (e.g., a character that includes a Hangul consonant and a Hangul vowel) through a keypad, according to various embodiments of the present disclosure;

FIGS. 9A through 9L are exemplary views illustrating actual examples of inputting a character (e.g., a character that includes a Hangul consonant and a Hangul vowel) through a keypad, according to various embodiments of the present disclosure;

FIG. 10 is a flowchart illustrating a method of operating an electronic device according to various embodiments of the present disclosure;

FIGS. 11A and 11B are exemplary views illustrating a function/operation of changing an input mode according to various embodiments of the present disclosure;

FIGS. 12A through 12Z are exemplary views illustrating examples of inputting the English alphabet in an English input mode according to various embodiments of the present disclosure;

FIGS. 13A through 13D are exemplary views illustrating various function(s) or operation(s) that are performed by an electronic device according to a user input;

FIG. 13E is a flowchart illustrating a case in which the method of operating an electronic device, according to the various embodiments of the present disclosure, which is illustrated in FIG. 10, is performed in connection with the function(s) or operation(s) that are illustrated in FIGS. 13A through 13D;

FIG. 14 is a block diagram of an electronic device according to various embodiments of the present disclosure; and

FIG. 15 is a block diagram of a program module according to various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have,” “may have,” “include,” or “may include” refers to the existence of a corresponding feature (e.g., numeral, function, operation, or constituent element such as component), and does not exclude one or more additional features.

In the present disclosure, the expression “A or B,” “at least one of A or/and B,” or “one or more of A or/and B” may include all possible combinations of the items listed. For example, the expression “A or B,” “at least one of A and B,” or “at least one of A or B” refers to all of (1) including at least one A, (2) including at least one B, or (3) including all of at least one A and at least one B.

The expression “a first,” “a second,” “the first,” or “the second” used in various embodiments of the present disclosure may modify various components regardless of the order and/or the importance but does not limit the corresponding components. The above expressions are used merely for the purpose of distinguishing an element from the other elements. For example, a first user device and a second user device indicate different user devices although both of them are user devices. For example, a first element may be termed a second element, and similarly, a second element may be termed a first element without departing from the scope of the present disclosure.

When it is mentioned that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for,” “having the capacity to,” “designed to,” “adapted to,” “made to,” or “capable of” according to the situation. The term “configured to” may not necessarily imply “specifically designed to” in hardware. Alternatively, in some situations, the expression “device configured to” may mean that the device, together with other devices or components, “is able to.” For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure. In some cases, even the term defined in the present disclosure should not be interpreted to exclude embodiments of the present disclosure.

For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point-of-sales (POS) in a shop, or interne device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

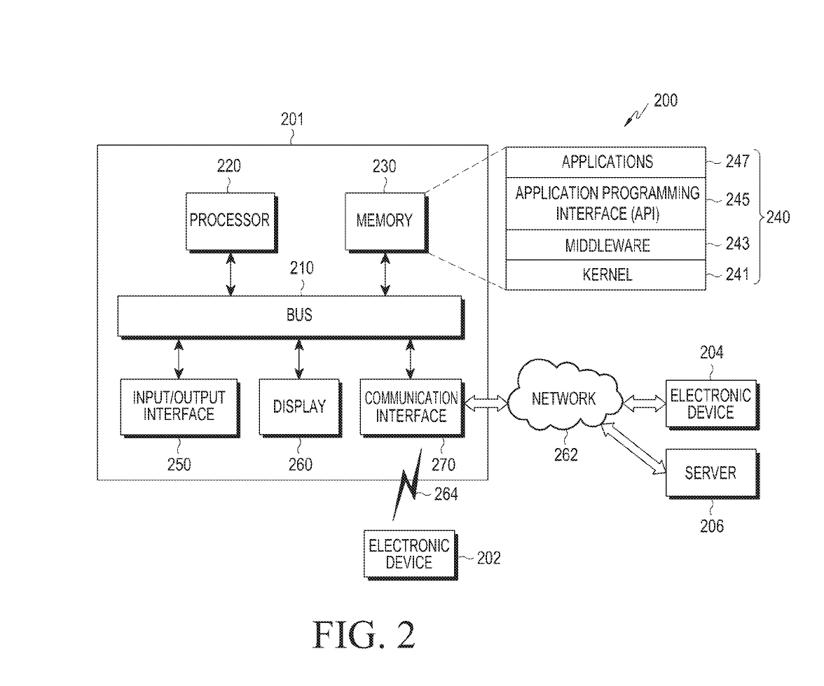

An electronic device 201 within a network environment 100, according to various embodiments, will be described with reference to FIG. 2. The electronic device 201 may include a bus 210, a processor 220, a memory 230, an input/output interface 250, a display 260, and a communication interface 270. In an embodiment, the electronic device 201 may omit at least some of the elements, or may further include other elements.

The bus 210 may include, for example, a circuit that interconnects the bus 210 to the processor 220, the memory 230, the input/output interface 250, the display 260, and the communication interface 270, and transfers communication (e.g., a control message and/or data) between the elements.

The processor 220 may include one or more of a Central Processing Unit (CPU), an Application Processor (AP), and a Communication Processor (CP). Further, according to various embodiments of the present disclosure, the processor 220 may include a Micro Controller Unit (MCU). For example, the processor 220 may carry out operations or data processing related to control and/or communication of at least one other element of the electronic device 201.

The memory 230 may include a volatile memory and/or a non-volatile memory. The memory 230 may store, for example, instructions or data related to at least one other element of the electronic device 201. According to an embodiment, the memory 230 may store software and/or a program 240. The program 240 may include, for example, a kernel 241, middleware 243, an Application Programming Interface (API) 245, and/or application programs (or “applications”) 147. At least some of the kernel 241, the middleware 243, and the API 245 may be referred to as an Operating System (OS).

The kernel 241 may control or manage, for example, system resources (e.g., the bus 210, the processor 220, and the memory 230) that are used to execute operations or functions implemented in the other programs (e.g., the middleware 243, the API 245, and applications 247). Furthermore, the kernel 241 may provide an interface by which the middleware 243, the API 245, or the applications 247 may access individual elements of the electronic device 201 to control or manage the system resources.

The middleware 243 may serve as, for example, a relay that allows the API 245 or the applications 247 to communicate with the kernel 241 in order to exchange data therewith. Furthermore, in regard to task requests received from the applications 247, the middleware 243 may perform a control (e.g., scheduling or load balancing) for the task requests by using, for example, a method of assigning a priority for using the system resources (e.g., the bus 210, the processor 220, the memory 230, etc.) of the electronic device 201 to at least one of the applications 247.

The API 245, which is an interface by which the application 247 control functions provided from the kernel 241 or the middleware 243, may include, for example, at least one interface or function (e.g., instruction) for file control, window control, image processing, text control, etc.

The input/output interface 250 may serve as, for example, an interface that may transfer instructions or data, which is input from a user or another external device, to the other element(s) of the electronic device 201. Furthermore, the input/output interface 250 may output, to the user or the other external device, instructions or data that are received from the other element(s) of the electronic device 201.

The display 260 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 260 may display, for example, various types of content (e.g., text, images, videos, icons, symbols, etc.) to users. The display 260 may include a touch screen and may receive, for example, a touch input, a gesture input, a proximity input, or a hovering input using an electronic pen or a user's body part.

The communication interface 270 may set, for example, communication between the electronic device 201 and an external device (e.g., a first electronic device 202, a second electronic device 204, or a server 206). For example, the communication interface 270 may be connected to a network 262 through wireless or wired communication to communicate with the external device.

The wireless communication may use, for example, at least one of long term evolution (LTE), long term evolution-advanced (LTE-A), Code Division Multiple Access (CDMA), Wideband Code Division Multiple Access (WCDMA), Universal Mobile Telecommunications System (UMTS), Wireless Broadband (WiBro), Global System for Mobile Communications (GSM), etc., as, for example, a cellular communication protocol. The wired communication may include, for example, at least one of a Universal Serial Bus (USB), a High Definition Multimedia Interface (HDMI), Recommended Standard 232 (RS-232), a Plain Old Telephone Service (POTS), etc. The network 262 may include a telecommunication networks, for example, at least one of a computer network (e.g., a local area network (LAN) or a wide area network (WAN)), the Internet, and a telephone network.

Each of the first electronic device 202 and the second electronic device 204 may be the same or a different device from the electronic device 201. According to an embodiment, the server 206 may include a group of one or more servers. According to various embodiments, all or some of the operations performed in the electronic device 201 may be performed in another or a plurality of electronic devices (e.g., the first electronic device 202, the second electronic device 204, and the server 206). According to an embodiment, when the electronic device 201 has to perform a function or a service automatically or in response to a request, the electronic device 201 may request another device (e.g., the first electronic device 202, the second electronic device 204, or the server 206) to perform at least some functions relating to the function or service, instead of, or in addition to, performing the function or service by itself. The other electronic device (e.g., the first electronic device 202, the second electronic device 204, or the server 206) may carry out the requested function or an additional function and may transfer the result, obtained by carrying out the function, to the electronic device 201. The electronic device 201 may provide the requested function or service by processing the received result as it is or additionally. To achieve this, for example, cloud computing, distributed computing, or client-server computing technology may be used.

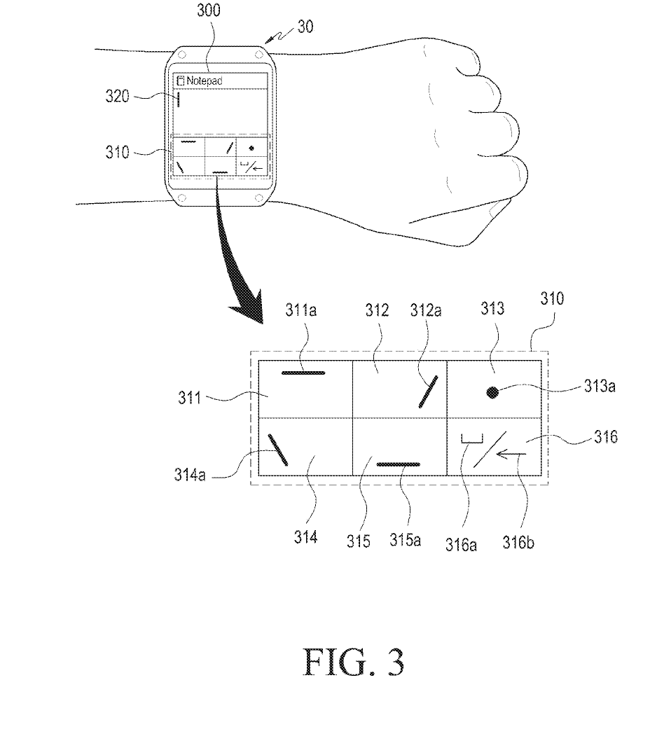

FIG. 3 is an exemplary view illustrating a keypad, according to various embodiments of the present disclosure, which is provided to a user through an electronic device according to various embodiments of the present disclosure. Although a smart watch is described as an example of the electronic device 30 in the present disclosure, it is obvious to a person skilled in the art that this is only for convenience of description of the present disclosure, and the electronic device 30 is not limited thereto.

Referring to FIG. 3, the electronic device 30, according to the various embodiments of the present disclosure, may be worn on a user's body part (e.g., the user's wrist). The keypad 310, according to the various embodiments of the present disclosure, may be displayed on a display 300 (e.g., the display 260) that is equipped to the electronic device 30. As will be described below, a text desired by the user may be input to the electronic device 30 through the keypad 310.

The keypad 310 may include, for example, a first sub-area 311, a second sub-area 312, a third sub-area 313, a fourth sub-area 314, a fifth sub-area 315, and a sixth sub-area 316. A first input element 311a, a second input element 312a, a third input element 313a, a fourth input element 314a, a fifth input element 315a, a sixth input element 316a, and a seventh input element 316b may be included in the first sub-area 311, the second sub-area 312, the third sub-area 313, the fourth sub-area 314, the fifth sub-area 315, and the sixth sub-area 316 such that the user may input a desired text. As illustrated in FIG. 3, the sixth input element 316a, and the seventh input element 316b may be included in the sixth sub-area 316. The text “input elements may be included” may be replaced by the text “input elements may be displayed” according to various embodiments of the present disclosure. In cases where “Hangul (Korean)” is described as an example of a text that the user wants to input, the keypad 310 may include the first input element 311a, the second input element 312a, the third input element 313a, the fourth input element 314a, and the fifth input element 315a for inputting consonants and vowels of the Hangul. The keypad 310 may include the sixth input element 316a for word spacing and/or the seventh input element 316b for modifying an input text. One (e.g., the third input element 313a) of the first input element 311a, the second input element 312a, the third input element 313a, a fourth input element 314a, and a fifth input element 315a may be an input element for inputting the Hangul consonant “ [symbol] ” As will be described below, the first input element 311a, the second input element 312a, the third input element 313a, the fourth input element 314a, the fifth input element 315a, the sixth input element 316a, and the seventh input element 316b may also be used when the English alphabet is input.

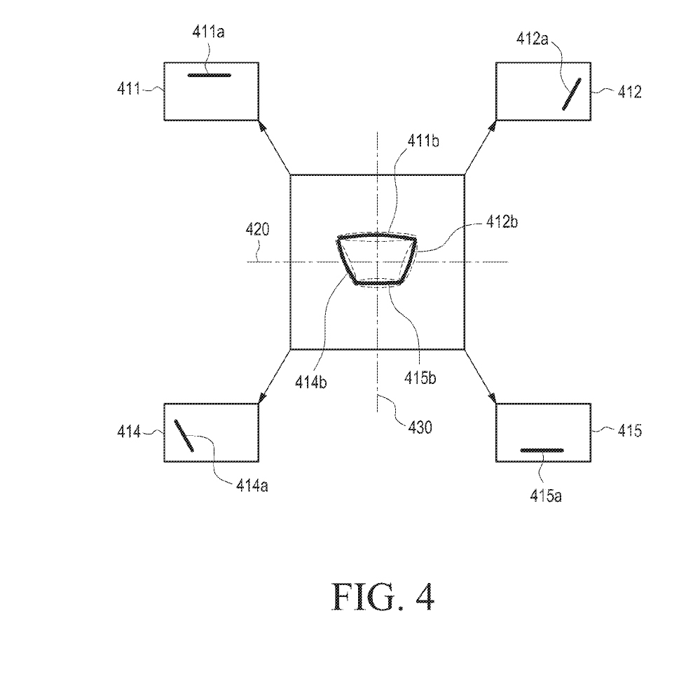

FIG. 4 is an exemplary view illustrating a correspondence relation between input elements and character elements, according to various embodiments of the present disclosure.

Referring to FIG. 4, the locations of input elements (e.g., a first input element 411a, a second input element 412a, a fourth input element 414a, and a fifth input element 415a) in respective sub-areas (e.g., a first sub-area 411, a second sub-area 412, a fourth sub-area 414, and a fifth sub-area 415) may correspond to locations where one or more character elements (e.g., a first character element 411b, a second character element 412b, a fourth character element 414b, and a fifth character element 415b), which make up a character (e.g., the Hangul consonant “ [symbol] ”) that a user wants to input, are disposed in the character. Namely, the first input element 411a is located on the upper side of the first sub-area 411 rather than in the center thereof so that the first input element 411a may correspond to the first character element 411b that is located on the upper side of the character with respect to a first center line 420. Further, the fifth input element 415a is located on the lower side of the fifth sub-area 415 rather than in the center thereof so that the fifth input element 415a may correspond to the fifth character element 415b that is located on the lower side of the character with respect to the first center line 420. Likewise, the second input element 412a is located on the right side of the second sub-area 412 so that the second input element 412a may correspond to the second character element 412b that is located on the right side of the character with respect to a second center line 430. In addition, the fourth input element 414a is located on the left side of the fourth sub-area 414 so that the fourth input element 414a may correspond to the fourth character element 414b that is located on the left side of the character with respect to the second center line 430. The third input element 313a for inputting the Hangul consonant “ [symbol] ” may be provided to a user while being disposed around the center of a third sub-area (e.g., the third sub-area 313).

According to various embodiments of the present disclosure, the shape of at least one of the first input element 411a, the second input element 412a, the fourth input element 414a, and the fifth input element 415a may be provided to the user, reflecting an actual use pattern of a character that the user wants to input. Namely, in cases where the user wants to input the Hangul consonant “ [symbol] ,” the Hangul consonant “ [symbol] ” is frequently used in the shape of a trapezoid as illustrated in FIG. 4, rather than in the shape of a rectangle or a square, when actually being used (e.g., when being written). Therefore, according to various embodiments of the present disclosure, the actual use pattern of the character, which the user wants to input, may be reflected in one or more of the first input element 411a, the second input element 412a, the fourth input element 414a, and the fifth input element 415a. In FIG. 4, reflecting the actual use pattern, the second input element 412a and the fourth input element 414a are provided to the user so as to be inclined at a predetermined angle. Reflecting the locations where the character elements are disposed in the character and/or the pattern in which the character is actually used, the keypad, according to the various embodiments of the present disclosure, may provide the user with an opportunity to intuitively input a character desired by the user.

The function or operation that the keypad provides to the user may include, for example, a method in which the keypad is controlled, by a processor (e.g., the processor 220) the electronic device (e.g., the electronic device 30), to be displayed on a display module (e.g., the display 260) of the electronic device. Data for the keypad may have been stored in a storage module (e.g., the memory 230) of the electronic device, or may be received from the first electronic device 202, the second electronic device 204, or the server 206 through a communication module (e.g., the communication interface 270) of the electronic device.

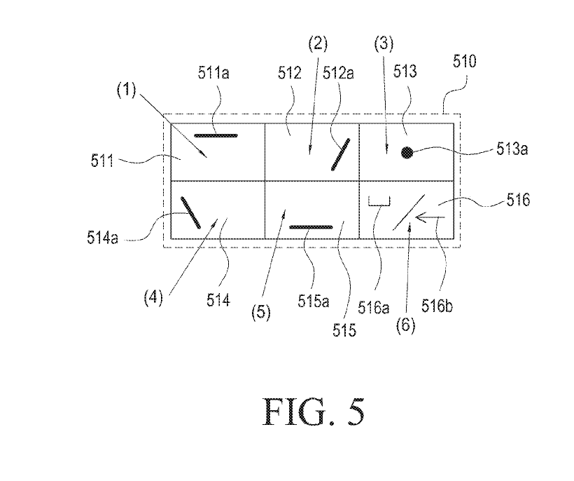

FIG. 5 is a reference view for briefly (e.g., as listed in Tables I to IV) describing actual examples of inputting a character, which will be described in the present disclosure.

In order to describe actual examples in which a character desired by the user is input through a keypad 510, according to various embodiments of the present disclosure, a first sub-area 511, a second sub-area 512, a third sub-area 513, a fourth sub-area 514, a fifth sub-area 515, and a sixth sub-area 516 are hereinafter indicated by (1), (2), (3), (4), (5), and (6) according to necessity as illustrated in FIG. 5. Further, a case in which the text “Hangul (Korean)” is input will be exemplified for the description of the present disclosure.

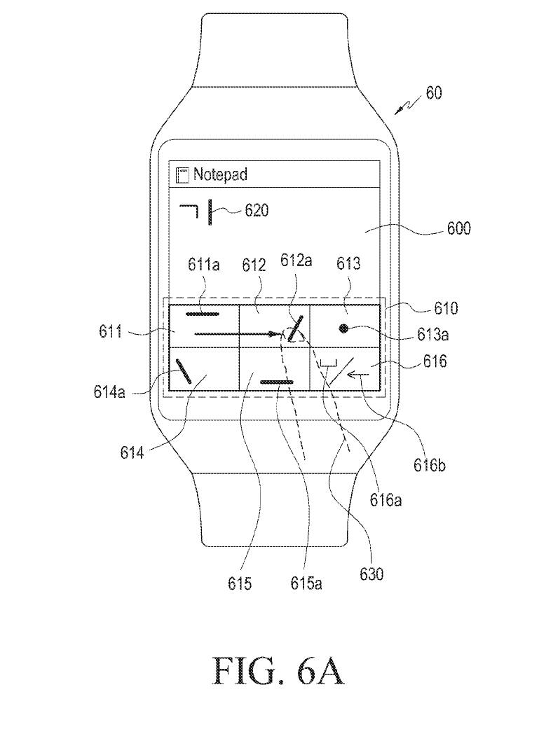

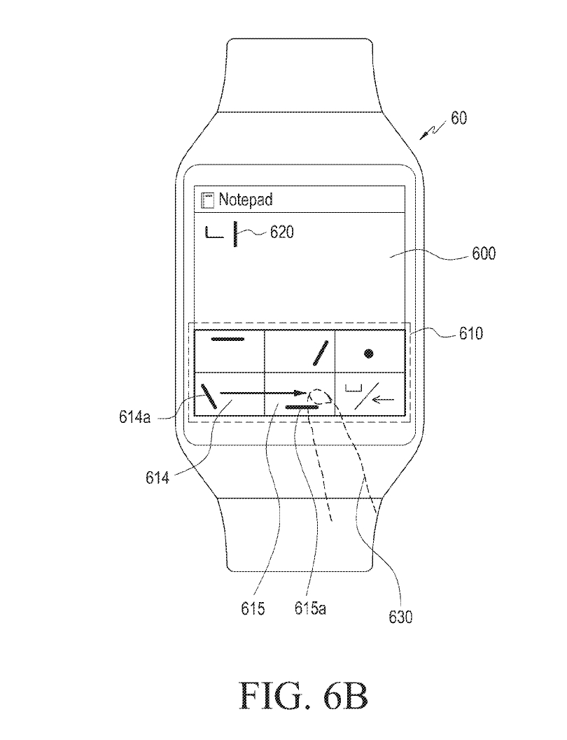

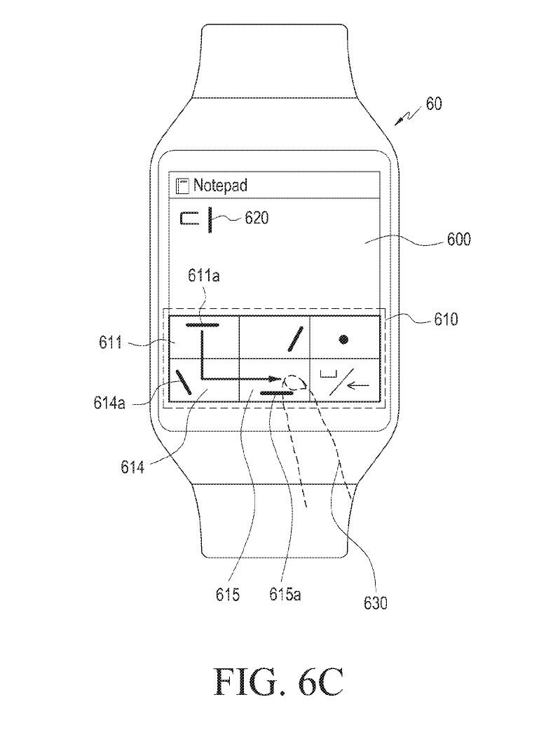

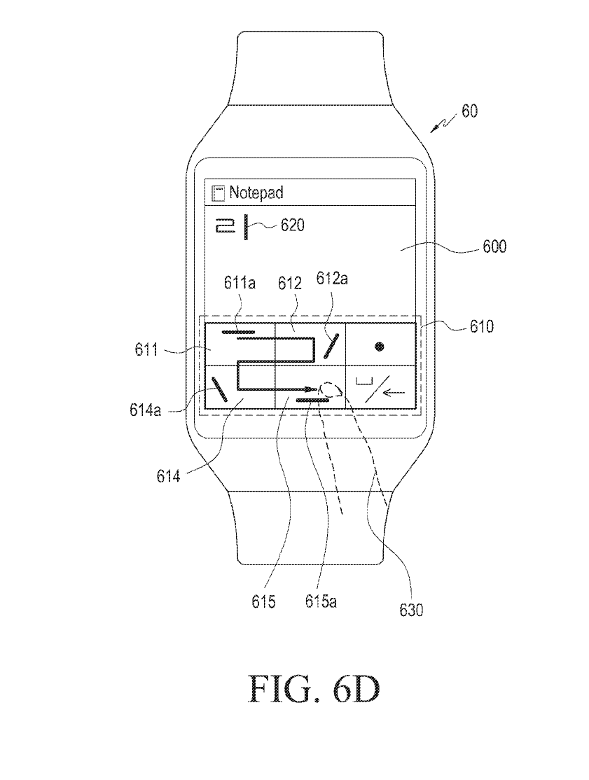

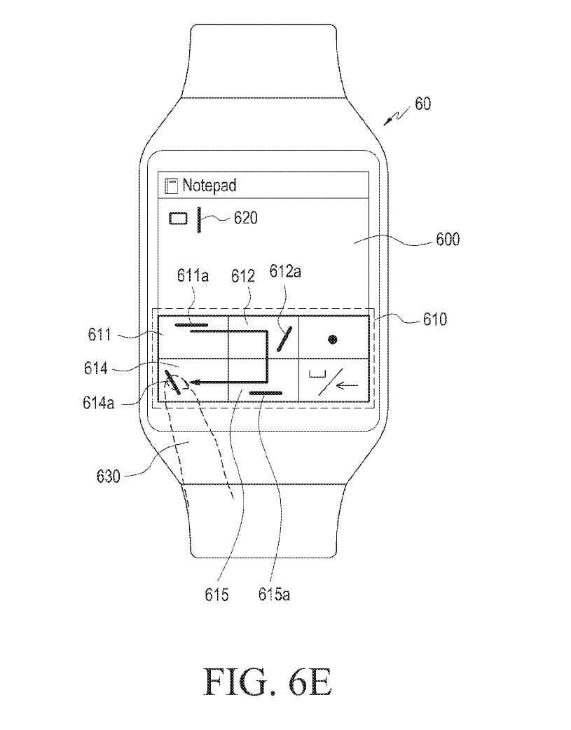

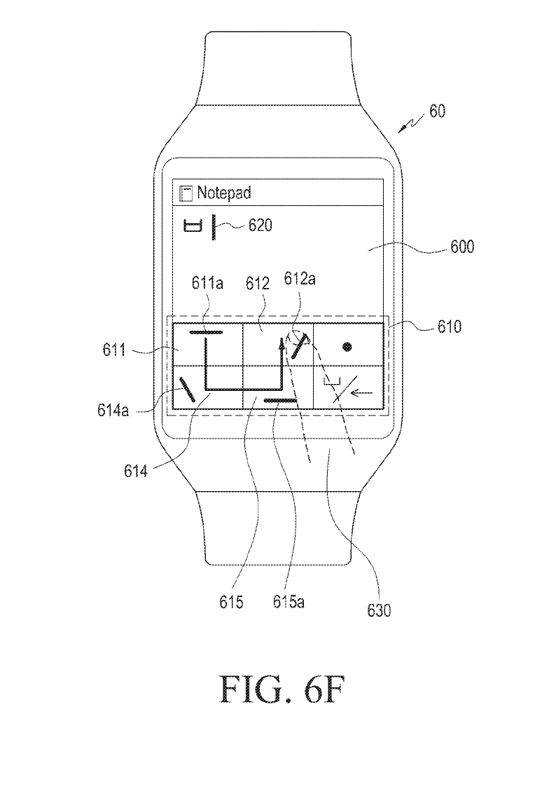

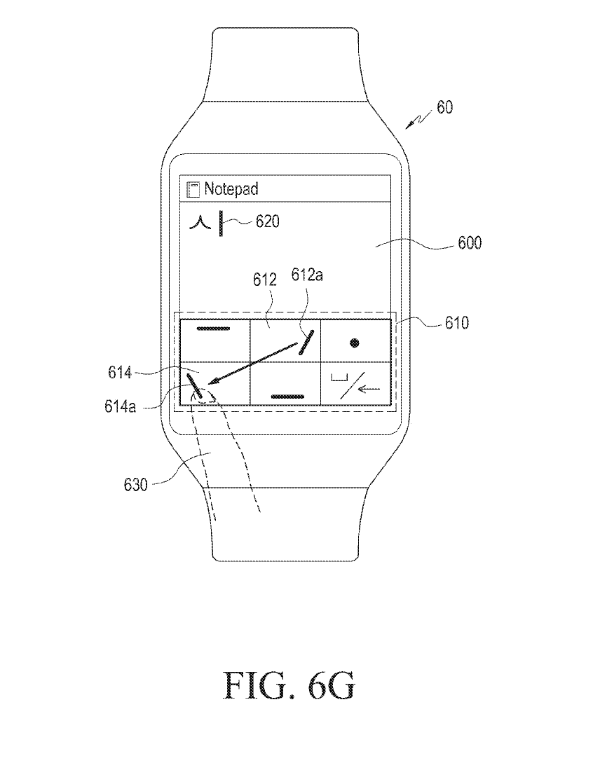

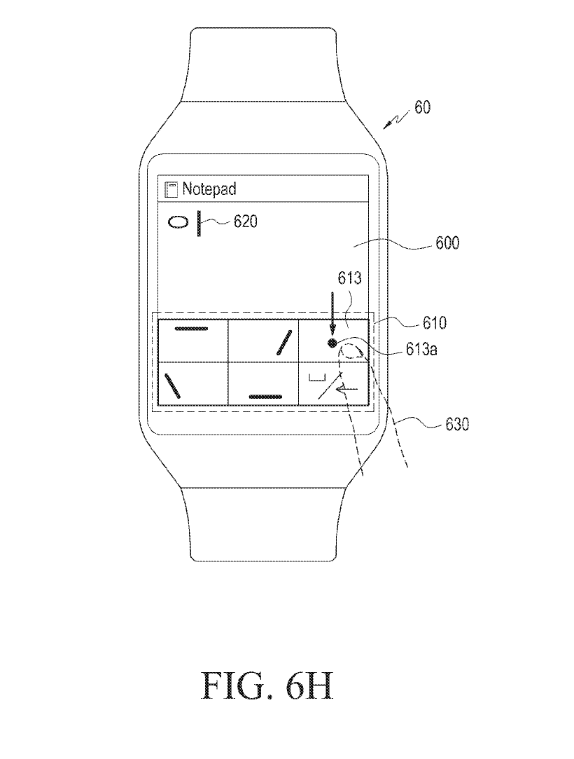

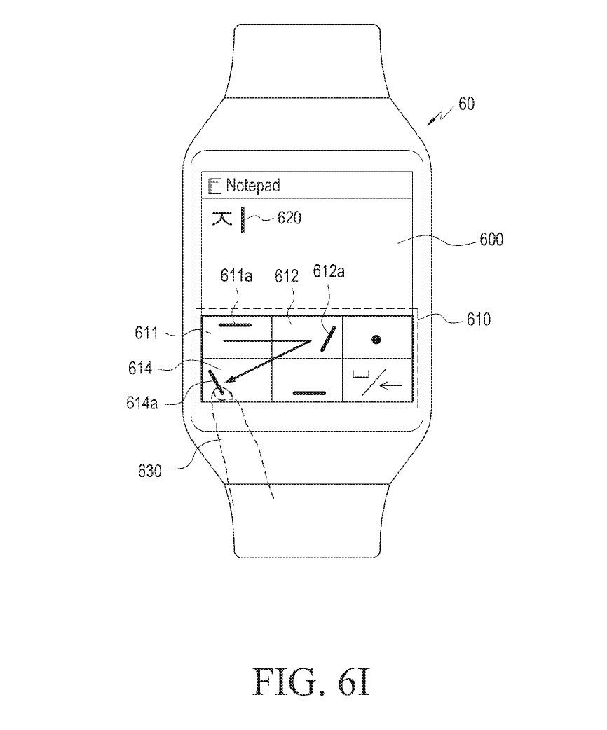

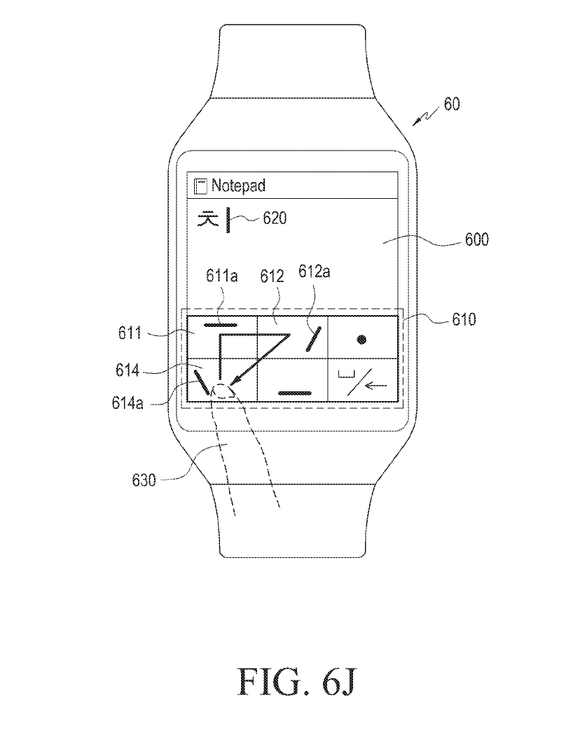

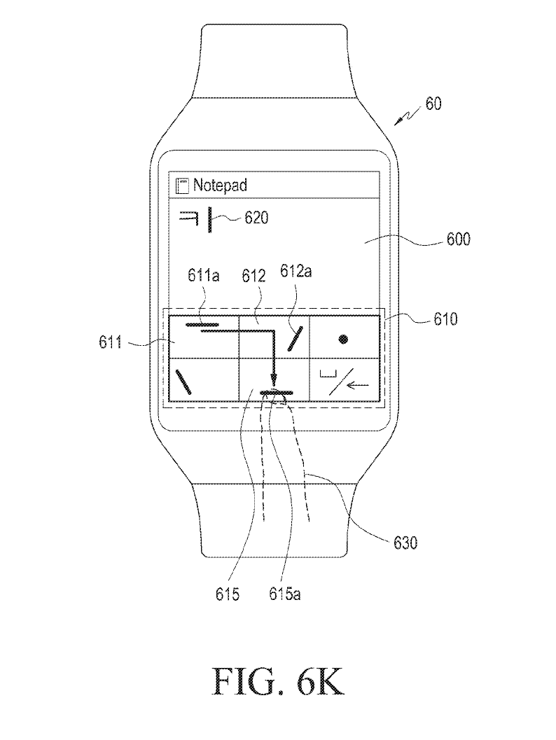

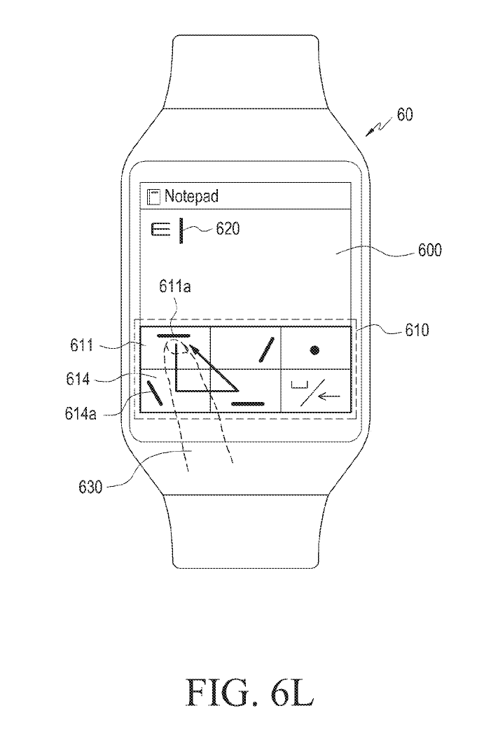

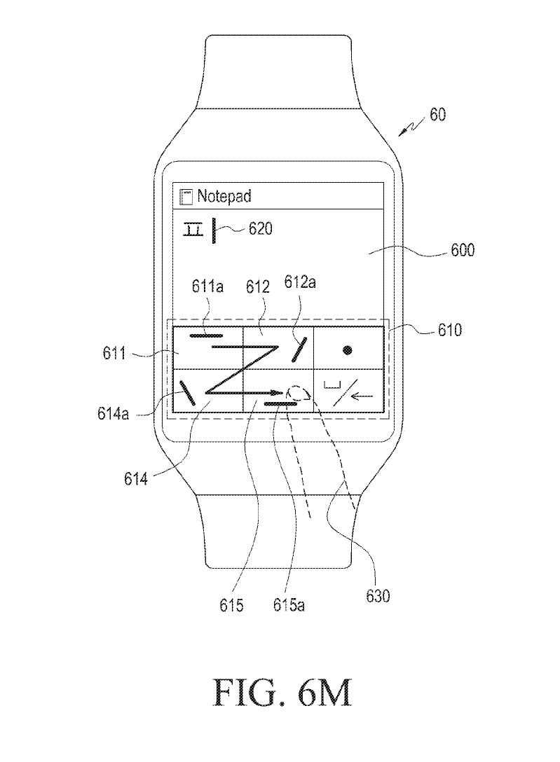

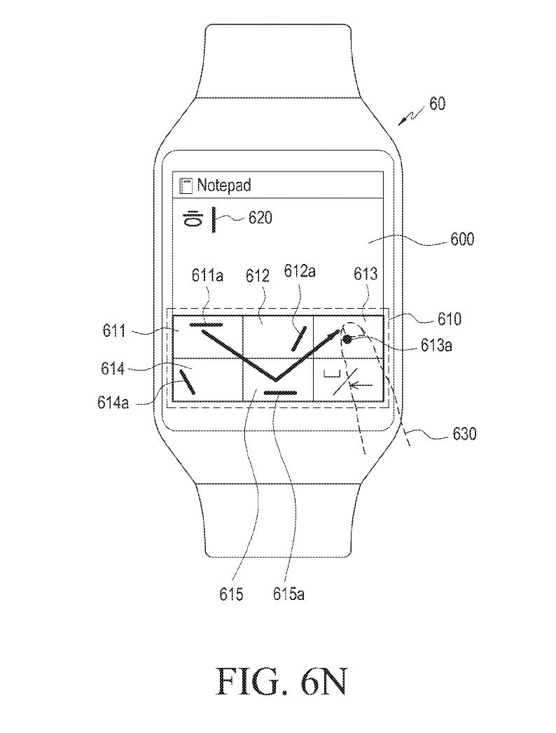

FIGS. 6A through 6N are exemplary views illustrating actual examples of inputting characters (e.g., Hangul consonants) through a keypad, according to various embodiments of the present disclosure.

Referring to FIG. 6A, a keypad 610 may be displayed on a display module 600 of an electronic device 60. The keypad 610 may include a first sub-area 611, a second sub-area 612, a third sub-area 613, a fourth sub-area 614, a fifth sub-area 615, and a sixth sub-area 616. A first input element 611a, a second input element 612a, a third input element 613a, a fourth input element 614a, a fifth input element 615a may be displayed in the first sub-area 611, the second sub-area 612, the third sub-area 613, the fourth sub-area 614, and the fifth sub-area 615, respectively. According to the various embodiments of the present disclosure, the sixth input element 616a and the seventh input element 616b may be displayed in the sixth sub-area 616. A cursor 620 may be displayed on the display module 600.

FIG. 6A illustrates an example of receiving, from a user 630, an input for displaying the Hangul consonant “ [symbol] ” on the electronic device 60. As illustrated in FIG. 6A, the input for displaying the Hangul consonant “ [symbol] ” on the electronic device 60 may include a continuous drag input from the first sub-area 611 to the second sub-area 612. The drag input may be received from, for example, the user 630. When the drag input is received, a processor (e.g., the processor 220) of the electronic device 60 may control to display the Hangul consonant “ [symbol] ” on the display module 600 in response to the drag input.

FIG. 6B illustrates an example of receiving, from the user 630, an input for displaying the Hangul consonant “ [symbol] ” on the electronic device 60. As illustrated in FIG. 6B, the input for displaying the Hangul consonant “ [symbol] ” on the electronic device 60 may include a continuous drag input from the fourth sub-area 614 to the fifth sub-area 615. The drag input may be received from, for example, the user 630. When the drag input is received, the processor may control to display the Hangul consonant “ [symbol] ” on the display module 600 in response to the drag input.

FIG. 6C illustrates an example of receiving, from the user 630, an input for displaying the Hangul consonant “ [symbol] ” on the electronic device 60. As illustrated in FIG. 6C, the input for displaying the Hangul consonant “ [symbol] ” on the electronic device 60 may include a continuous drag input from the first sub-area 611 to the fifth sub-area 615 via the fourth sub-area 614. The drag input may be received from, for example, the user 630. When the drag input is received, the processor may control to display the Hangul consonant “ [symbol] ” on the display module 600 in response to the drag input.

FIG. 6D illustrates an example of receiving, from the user 630, an input for displaying the Hangul consonant “ [symbol] ” on the electronic device 60. As illustrated in FIG. 6D, the input for displaying the Hangul consonant “ [symbol] ” on the electronic device 60 may include a continuous drag input from the first sub-area 611 to the fifth sub-area 615 via the second sub-area 612, the first sub-area 611, and the fourth sub-area 614. The drag input may be received from, for example, the user 630. When the drag input is received, the processor may control to display the Hangul consonant “ [symbol] ” on the display module 600 in response to the drag input. In some embodiments, each of the first sub-area 611, the second sub-area 612, the third sub-area 613, the fourth sub-area 614, the fifth sub-area 615, and the sixth sub-area 616 may have a respective boundary. The boundaries of the first sub-area 611, the second sub-area 612, the third sub-area 613, the fourth sub-area 614, the fifth sub-area 615, and the sixth sub-area 616 may have a predetermined space. In other words, the first sub-area 611, the second sub-area 612, the third sub-area 613, the fourth sub-area 614, the fifth sub-area 615, and the sixth sub-area 616 may be separated from each other by the predetermined space.

FIG. 6E illustrates an example of receiving, from the user 630, an input for displaying the Hangul consonant “ [symbol] ” on the electronic device 60. As illustrated in FIG. 6E, the input for displaying the Hangul consonant “ [symbol] ” on the electronic device 60 may include a continuous drag input from the first sub-area 611 to the fourth sub-area 614 via the second sub-area 612 and the fifth sub-area 615. The drag input may be received from, for example, the user 630. When the drag input is received, the processor may control to display the Hangul consonant “ [symbol] ” on the display module 600 in response to the drag input.

FIG. 6F illustrates an example of receiving, from the user 630, an input for displaying the Hangul consonant “ [symbol] ” on the electronic device 60. As illustrated in FIG. 6F, the input for displaying the Hangul consonant “ [symbol] ” on the electronic device 60 may include a continuous drag input from the first sub-area 611 to the second sub-area 612 via the fourth sub-area 614 and the fifth sub-area 615. The drag input may be received from, for example, the user 630. When the drag input is received, the processor may control to display the Hangul consonant “ [symbol] ” on the display module 600 in response to the drag input.

FIG. 6G illustrates an example of receiving, from a user 630, an input for displaying the Hangul consonant “ [symbol] ” on the electronic device 60. As illustrated in FIG. 6G, the input for displaying the Hangul consonant “ [symbol] ” on the electronic device 60 may include a continuous drag input from the second sub-area 612 to the fourth sub-area 614. The drag input may be received from, for example, the user 630. When the drag input is received, the processor may control to display the Hangul consonant “ [symbol] ” on the display module 600 in response to the drag input. In the embodiment as shown, the example of receiving inputs from a player is an exemplary setting for entering each character to be easily and sensibly understood by the user. There may be additional or other drag inputs for each of the characters (e.g., the Hangul consonant “ [symbol] ”, and “ [symbol] ”). In addition, the drag input method as described may perform an operation of receiving re-input from a user, if the drag is not inputted based on the process of the embodiment as described, for example, if the inputted drag does not correspond to any characters.

FIG. 6H illustrates an example of receiving, from the user 630, an input for displaying the Hangul consonant “ [symbol] ” on the electronic device 60. As illustrated in FIG. 6H, the input for displaying the Hangul consonant “ [symbol] ” on the electronic device 60 may include a touch input in the third sub-area 613. The touch input may be received from, for example, the user 630. According to various embodiments of the present disclosure, the touch input may include a touch input (that is, a long touch input) that is made for more than a predetermined period of time, but the long touch input is illustrative for the description of the present disclosure. According to the various embodiments of the present disclosure, the input of the user 630 for inputting the Hangul consonant “ [symbol] ” may include various types of input events, such as a tap, a swipe, hovering, a flick, rotation, etc., in the third sub-area 613, in addition to the touch input. When the input (e.g., the touch input) for displaying the Hangul consonant “ [symbol] ” is received, the processor may control to display the Hangul consonant “ [symbol] ” on the display module 600 in response to the touch input.

FIG. 6I illustrates an example of receiving, from the user 630, an input for displaying the Hangul consonant “ [symbol] ” on the electronic device 60. As illustrated in FIG. 6I, the input for displaying the Hangul consonant “ [symbol] ” on the electronic device 60 may include a continuous drag input from the first sub-area 611 to the fourth sub-area 614 via the second sub-area 612. The drag input may be received from, for example, the user 630. When the drag input is received, the processor may control to display the Hangul consonant “ [symbol] ” on the display module 600 in response to the drag input.

FIG. 6J illustrates an example of receiving, from the user 630, an input for displaying the Hangul consonant “ [symbol] ” on the electronic device 60. As illustrated in FIG. 6J, the input for displaying the Hangul consonant “ [symbol] ” on the electronic device 60 may include a continuous drag input that starts from the fourth sub-area 614 and returns to the fourth sub-area 614 via the first sub-area 611 and the second sub-area 612. The drag input may be received from, for example, the user 630. When the drag input is received, the processor may control to display the Hangul consonant “ [symbol] ” on the display module 600 in response to the drag input.

FIG. 6K illustrates an example of receiving, from the user 630, an input for displaying the Hangul consonant “ [symbol] ” on the electronic device 60. As illustrated in FIG. 6K, the input for displaying the Hangul consonant “ [symbol] ” on the electronic device 60 may include a continuous drag input from the first sub-area 611 to the fifth sub-area 615 via the second sub-area 612. The drag input may be received from, for example, the user 630. When the drag input is received, the processor may control to display the Hangul consonant “ [symbol] ” on the display module 600 in response to the drag input.

FIG. 6L illustrates an example of receiving, from a user 630, an input for displaying the Hangul consonant “ [symbol] ” on the electronic device 60. As illustrated in FIG. 6L, the input for displaying the Hangul consonant “ [symbol] ” on the electronic device 60 may include a continuous drag input that starts from the first sub-area 611 and returns to the first sub-area 611 via the fourth sub-area 614 and the fifth sub-area 615. The drag input may be received from, for example, the user 630. When the drag input is received, the processor may control to display the Hangul consonant “ [symbol] ” on the display module 600 in response to the drag input.

FIG. 6M illustrates an example of receiving, from a user 630, an input for displaying the Hangul consonant “ [symbol] ” on the electronic device 60. As illustrated in FIG. 6M, the input for displaying the Hangul consonant “ [symbol] ” on the electronic device 60 may include a continuous drag input from the first sub-area 611 to the fifth sub-area 615 via the second sub-area 612 and the fourth sub-area 614. The drag input may be received from, for example, the user 630. When the drag input is received, the processor may control to display the Hangul consonant “ [symbol] ” on the display module 600 in response to the drag input.

FIG. 6N illustrates an example of receiving, from the user 630, an input for displaying the Hangul consonant “ [symbol] ” on the electronic device 60. As illustrated in FIG. 6N, the input for displaying the Hangul consonant “ [symbol] ” on the electronic device 60 may include a continuous drag input from the first sub-area 611 to the third sub-area 613 via the fifth sub-area 615. The drag input may be received from, for example, the user 630. When the drag input is received, the processor may control to display the Hangul consonant “ [symbol] ” on the display module 600 in response to the drag input. According to the various embodiments of the present disclosure, the input for the Hangul consonant “ [symbol] ” may also include a long touch input of the user 630 that is continuously made in the third sub-area 613 at the same time that the user 630 completes the drag gesture. Based on the input, the processor may determine whether the input for “ [symbol] ” included in the Hangul consonant “ [symbol] ” has been made. According to the various embodiments of the present disclosure, when the input (namely, the drag input and the long touch input that is continuously performed after the drag input) for displaying the Hangul consonant “ [symbol] ” is received as described above, the processor may control to display the Hangul consonant “ [symbol] ” on the display module 600 in response to the input.

In FIGS. 6A through 6N, the drag inputs and/or the touch inputs have been exemplified as the inputs for displaying the Hangul consonants. However, the drag inputs and/or the touch inputs may be replaced by various types of input events, such as a touch, a tap, a swipe, hovering, a flick, and/or rotation. The inputs for displaying the characters (e.g., the Hangul consonants) may be listed in Table I below with reference to FIG. 5. A mapping table, which is defined as in Table I below, may have been stored in a storage module (e.g., the memory 230) of the electronic device 60, and when an input for displaying a Hangul consonant is received, the processor may determine which character (e.g., Hangul consonant) is indicated by the received input based on the mapping table, such as Table I below, which has been stored in a storage module. Various Hangul characters may be included in addition to the Hangul consonants included in the mapping table, such as Table I below, and characters (e.g., radicals of Chinese characters) of various languages (e.g., Chinese language) may be additionally or alternatively included.

TABLE I

| Character | Input Sequence |
|---|---|
| “ [symbol] ” | (1) → (2) |
| “ [symbol] ” | (4) → (5) |
| “ [symbol] ” | (1) → (4) → (5) |
| “ [symbol] ” | (1) → (2) → (1) → (4) → (5) |
| “ [symbol] ” | (1) → (2) → (5) → (4) |
| “ [symbol] ” | (1) → (4) → (5) → (2) |
| “ [symbol] ” | (2) → (4) |
| “ [symbol] ” | (3) : Long touch |
| “ [symbol] ” | (1) → (2) → (4) |
| “ [symbol] ” | (4) → (1) → (2) → (4) |
| “ [symbol] ” | (1) → (2) → (5) |
| “ [symbol] ” | (1) → (4) → (5) → (1) |
| “ [symbol] ” | (1) → (2) → (4) → (5) |
| “ [symbol] ” | (1) → (5) → (3)→ |

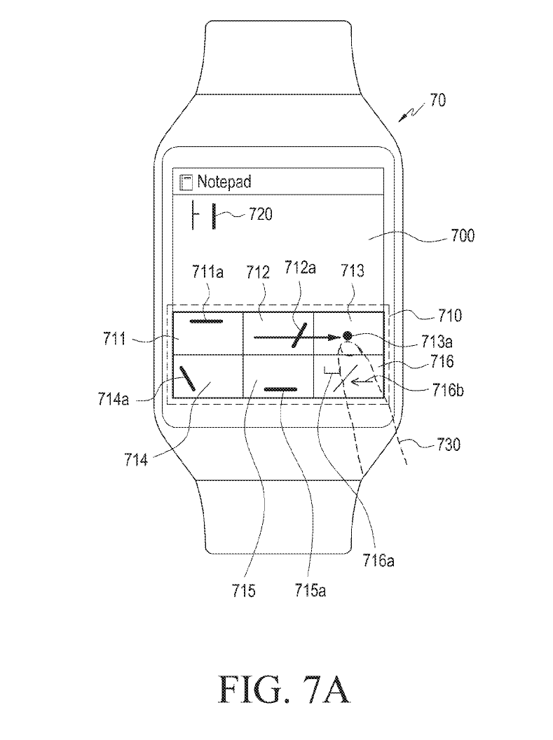

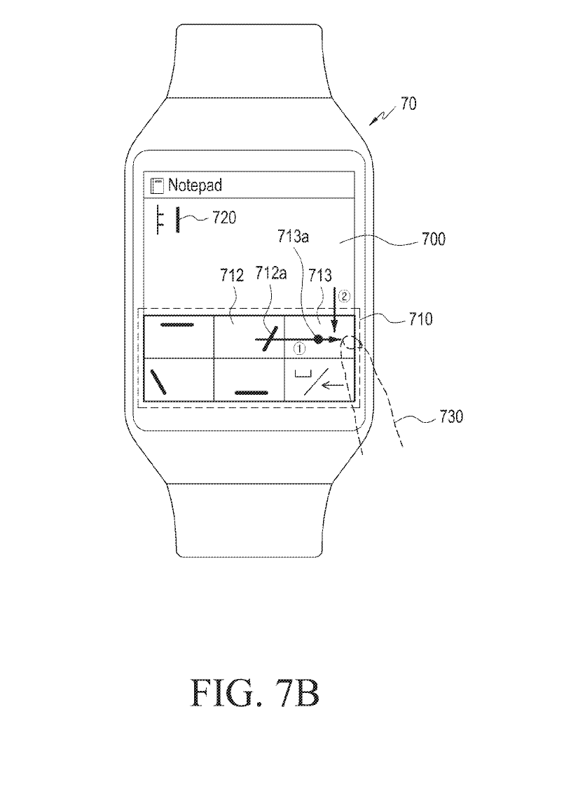

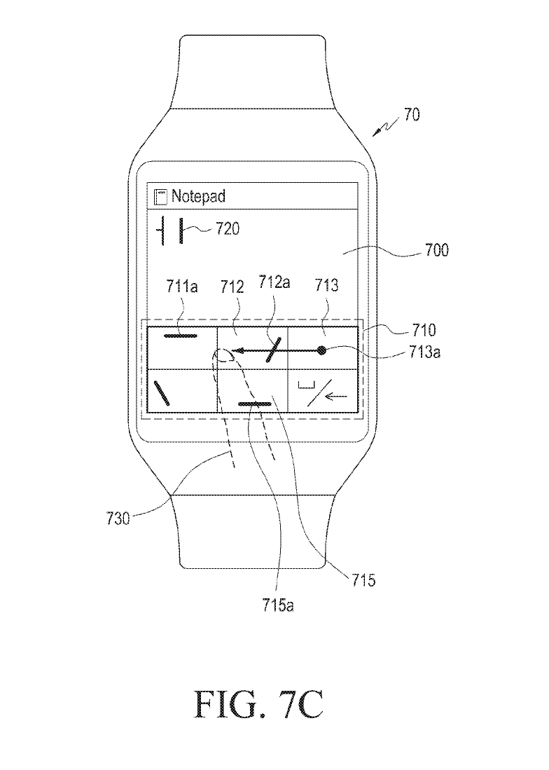

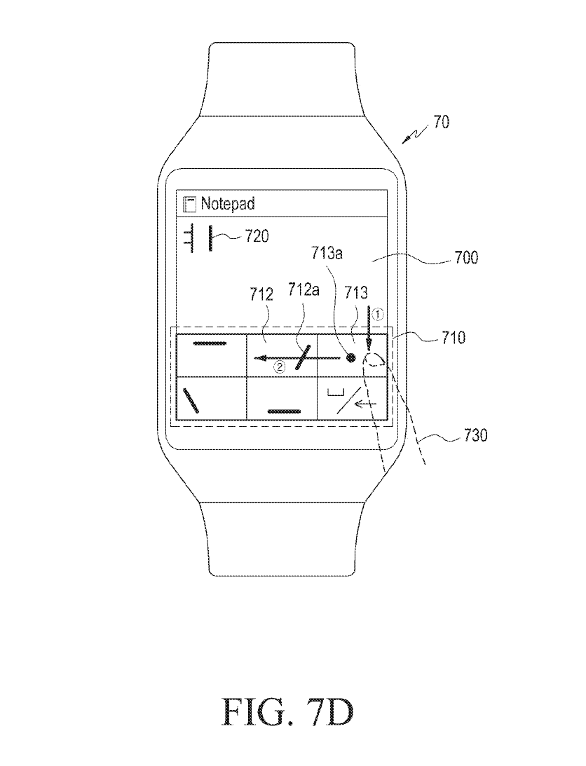

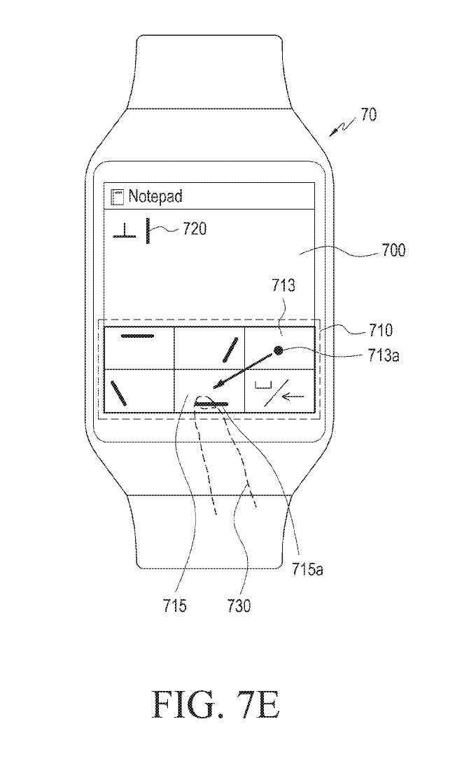

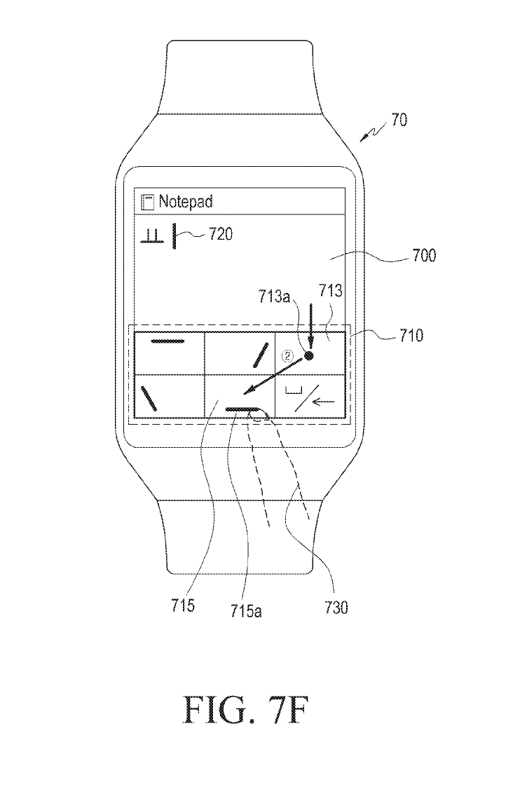

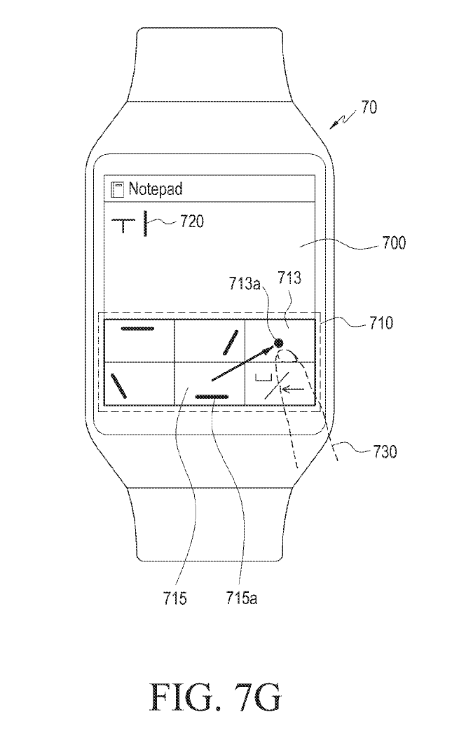

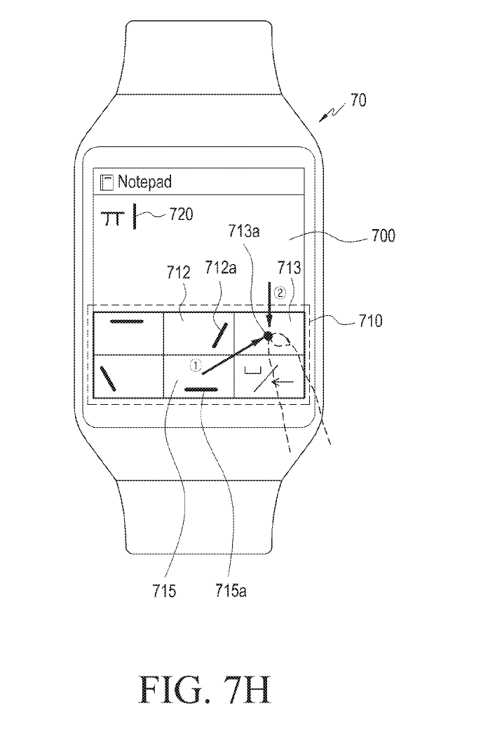

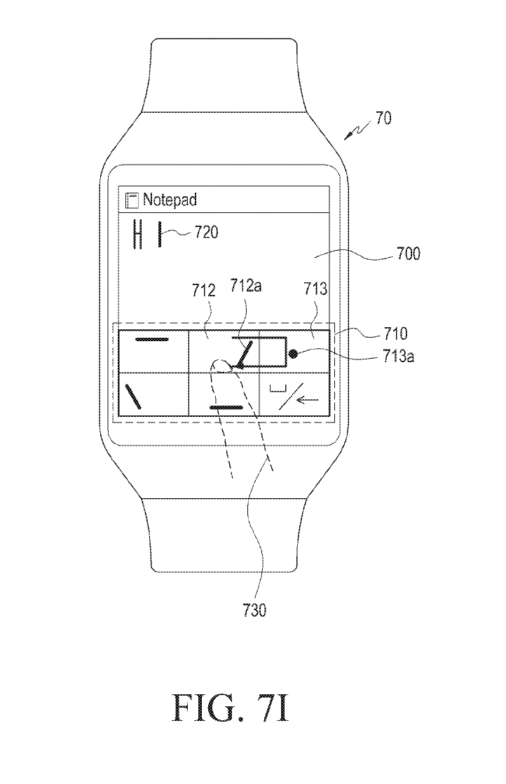

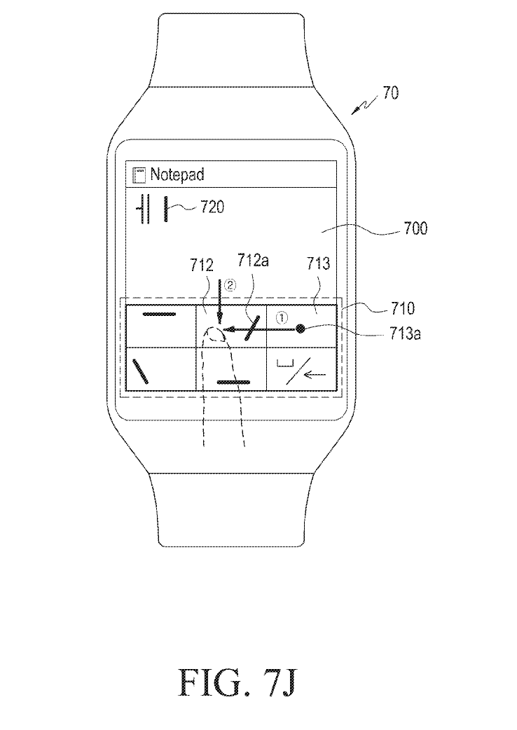

FIGS. 7A through 7J are exemplary views illustrating actual examples of inputting a character (e.g., a Hangul vowel) through a keypad, according to various embodiments of the present disclosure.

Referring to FIG. 7A, a keypad 710 may be displayed on a display module 700 of an electronic device 70. The keypad 710 may include a first sub-area 711, a second sub-area 712, a third sub-area 713, a fourth sub-area 714, a fifth sub-area 715, and a sixth sub-area 716. A first input element 711a, a second input element 712a, a third input element 713a, a fourth input element 714a, a fifth input element 715a may be displayed in the first sub-area 711, the second sub-area 712, the third sub-area 713, the fourth sub-area 714, and the fifth sub-area 715, respectively. According to the various embodiments of the present disclosure, a sixth input element 716a and a seventh input element 716b may be displayed in the sixth sub-area 716. A cursor 720 may be displayed on the display module 700.

FIG. 7A illustrates an example of receiving, from a user 730, an input for displaying the Hangul vowel “ [symbol] ” on the electronic device 70. As illustrated in FIG. 7A, the input for displaying the Hangul vowel “ [symbol] ” on the electronic device 70 may include a continuous drag input from the second sub-area 712 to the third sub-area 713. The drag input may be received from, for example, the user 730. When the drag input is received, a processor (e.g., the processor 220) of the electronic device 70 may control to display the Hangul vowel “ [symbol] ” on the display module 700 in response to the drag input.

FIG. 7B illustrates an example of receiving, from the user 730, an input for displaying the Hangul vowel “ [symbol] ” on the electronic device 70. As illustrated in FIG. 7B, the input for displaying the Hangul vowel “ [symbol] ” on the electronic device 70 may include a touch input for the third sub-area 713 after a continuous drag input from the second sub-area 712 to the third sub-area 713. The drag input and the touch input may be received from, for example, the user 730. The touch input (namely, \textcircled{2} of FIG. 7B) for the third sub-area 713 may include a short touch such that the touch input is distinguished from that for the Hangul consonant “ [symbol] ” When the drag input and the touch input are received, the processor may control to display the Hangul vowel “ [symbol] ” on the display module 700 in response to the drag input. Likewise to the long touch input, the short touch input is illustrative and may include various types of inputs.

FIG. 7C illustrates an example of receiving, from the user 730, an input for displaying the Hangul vowel “ [symbol] ” on the electronic device 70. As illustrated in FIG. 7C, the input for displaying the Hangul vowel “ [symbol] ” on the electronic device 70 may include a continuous drag input from the third sub-area 713 to the second sub-area 712. The drag input may be received from, for example, the user 730. When the drag input is received, the processor may control to display the Hangul vowel “ [symbol] ” on the display module 700 in response to the drag input.

FIG. 7D illustrates an example of receiving, from the user 730, an input for displaying the Hangul vowel “ [symbol] ” on the electronic device 70. As illustrated in FIG. 7D, the input for displaying the Hangul vowel “ [symbol] ” on the electronic device 70 may include a continuous drag input \textcircled{2} from the third sub-area 713 to the second sub-area 712, which is input within a predetermined period of time after a touch input \textcircled{1} for the third sub-area. The touch input and the drag input may be received from, for example, the user 730. The touch input \textcircled{1} may include, for example, a short touch input. When the touch input and the drag input are received, the processor may control to display the Hangul vowel “ [symbol] ” on the display module 700 in response to the drag input.

FIG. 7E illustrates an example of receiving, from the user 730, an input for displaying the Hangul vowel “ [symbol] ” on the electronic device 70. As illustrated in FIG. 7E, the input for displaying the Hangul vowel “ [symbol] ” on the electronic device 70 may include a drag input from the third sub-area 713 to the fifth sub-area 715. The drag input may be received from, for example, the user 730. When the drag input is received, the processor may control to display the Hangul vowel “ [symbol] ” on the display module 700 in response to the drag input.

FIG. 7F illustrates an example of receiving, from the user 730, an input for displaying the Hangul vowel “ [symbol] ” on the electronic device 70. As illustrated in FIG. 7F, the input for displaying the Hangul vowel “ [symbol] ” on the electronic device 70 may include a drag input \textcircled{2} from the third sub-area 713 to the fifth sub-area 715, which is input within a predetermined period of time after a touch input \textcircled{1} for the third sub-area. The touch input \textcircled{1} and the drag input \textcircled{2} may be received from, for example, the user 730. The touch input \textcircled{1} may include, for example, a short touch input. When the touch input and the drag input are received, the processor may control to display the Hangul vowel “ [symbol] ” on the display module 700 in response to the drag input.

FIG. 7G illustrates an example of receiving, from the user 730, an input for displaying the Hangul vowel “ [symbol] ” on the electronic device 70. As illustrated in FIG. 7G, the input for displaying the Hangul vowel “ [symbol] ” on the electronic device 70 may include a drag input from the fifth sub-area 715 to the third sub-area 713. The drag input may be received from, for example, the user 730. When the drag input is received, the processor may control to display the Hangul vowel “ [symbol] ” on the display module 700 in response to the drag input.

FIG. 7H illustrates an example of receiving, from the user 730, an input for displaying the Hangul vowel “ [symbol] ” on the electronic device 70. As illustrated in FIG. 7H, the input for displaying the Hangul vowel “ [symbol] ” on the electronic device 70 may include a touch input \textcircled{2} for the third sub-area 713, which is input within a predetermined period of time after a drag input \textcircled{1} from the fifth sub-area 715 to the third sub-area 713. The drag input \textcircled{1} and the touch input \textcircled{2} may be received from, for example, the user 730. The touch input \textcircled{2} may include, for example, a short touch input. When the drag input and the touch input are received, the processor may control to display the Hangul vowel “ [symbol] ” on the display module 700 in response to the drag input. In some embodiments, a predetermined period of time may be between about 0.5 and about 1.5 seconds.

FIG. 7I illustrates an example of receiving, from the user 730, an input for displaying the Hangul vowel “ [symbol] ” on the electronic device 70. As illustrated in FIG. 7I, the input for displaying the Hangul vowel “ [symbol] ” on the electronic device 70 may include a continuous drag input that starts from the second sub-area 712 and returns to the second sub-area 712 via the third sub-area 713. The drag input may be received from, for example, the user 730. When the drag input is received, the processor may control to display the Hangul vowel “ [symbol] ” on the display module 700 in response to the drag input.

FIG. 7J illustrates an example of receiving, from the user 730, an input for displaying the Hangul vowel “ [symbol] ” on the electronic device 70. As illustrated in FIG. 7J, the input for displaying the Hangul vowel “ [symbol] ” on the electronic device 70 may include a touch input \textcircled{2} for the second sub-area 712, which is input within a predetermined period of time after a drag input \textcircled{1} from the third sub-area 713 to the second sub-area 712. The drag input \textcircled{1} and the touch input \textcircled{2} may be received from, for example, the user 730. The touch input \textcircled{2} may include, for example, a short touch input. When the drag input and the touch input are received, the processor may control to display the Hangul vowel “ [symbol] ” on the display module 700 in response to the drag input.

In FIGS. 7A through 7J, the drag inputs and/or the touch inputs have been exemplified as the inputs for displaying the Hangul vowels. However, the drag inputs and/or the touch inputs may be replaced by various types of input events, such as a touch, a tap, a swipe, hovering, a flick, and/or rotation. The inputs for displaying the characters (e.g., the Hangul vowels) may be listed in Table II below with reference to FIG. 5. A mapping table, which is defined as in Table II below, may have been stored in a storage module (e.g., the memory 230) of the electronic device 70, and when an input for displaying a Hangul vowel is received, the processor may determine which character (e.g., Hangul vowel) is indicated by the received input based on the mapping table, such as Table II below, which has been stored in storage module. Various Hangul characters may be included in addition to the Hangul vowels included in the mapping table, such as Table II below, and characters (e.g., radicals of Chinese characters) of various languages (e.g., Chinese language) may be additionally or alternatively included. “Comma (,)” in Table II below may mean that inputs before and after the “Comma (,)” are not continuously performed.

TABLE II

| Character | Input Sequence |
|---|---|
| “ [symbol] ” | (2) → (3) |
| “ [symbol] ” | (2) → (3), (3) |
| “ [symbol] ” | (3) → (2) |
| “ [symbol] ” | (3) → (2), (3) |
| “ [symbol] ” | (3) → (5) |
| “ [symbol] ” | (3) → (5), (3) |
| “ [symbol] ” | (5) → (3) |
| “ [symbol] ” | (5) → (3), (3) |
| “ [symbol] ” | (2) → (3) → (2) |
| “ [symbol] ” | (3) → (2) → (2) |

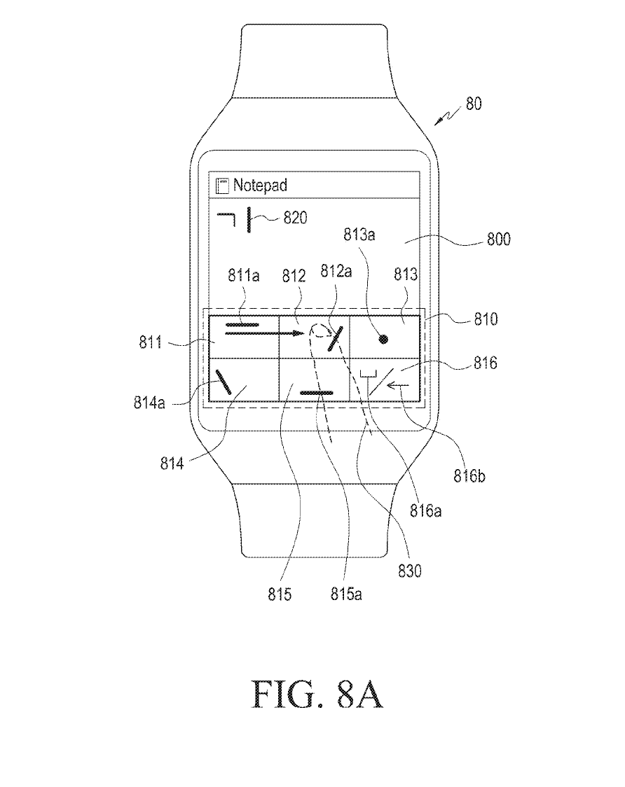

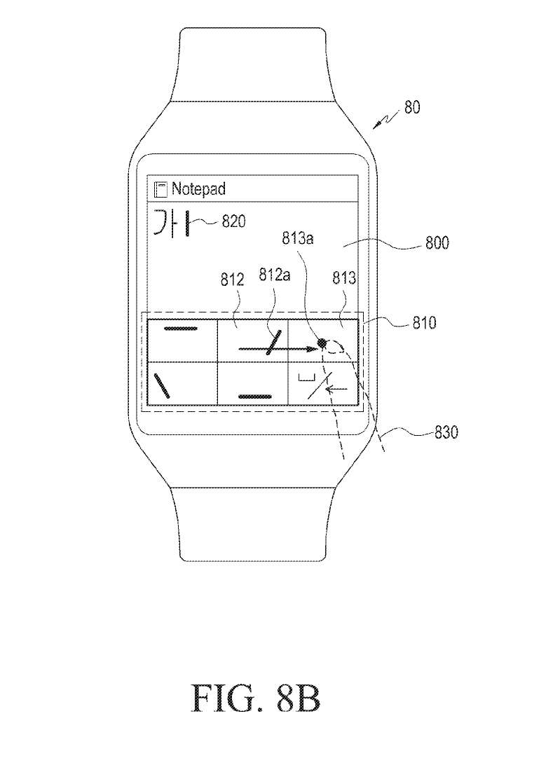

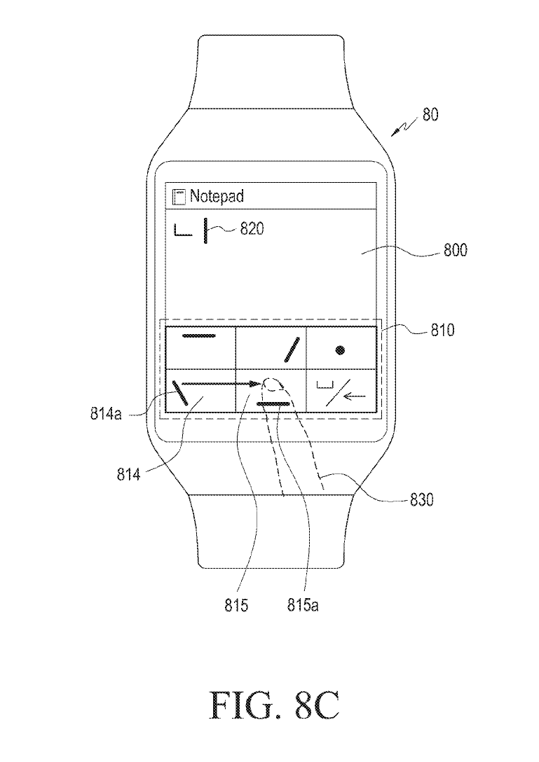

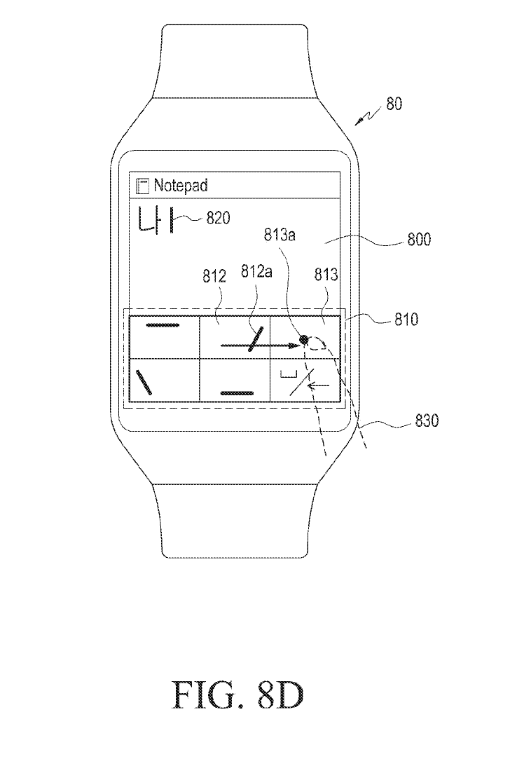

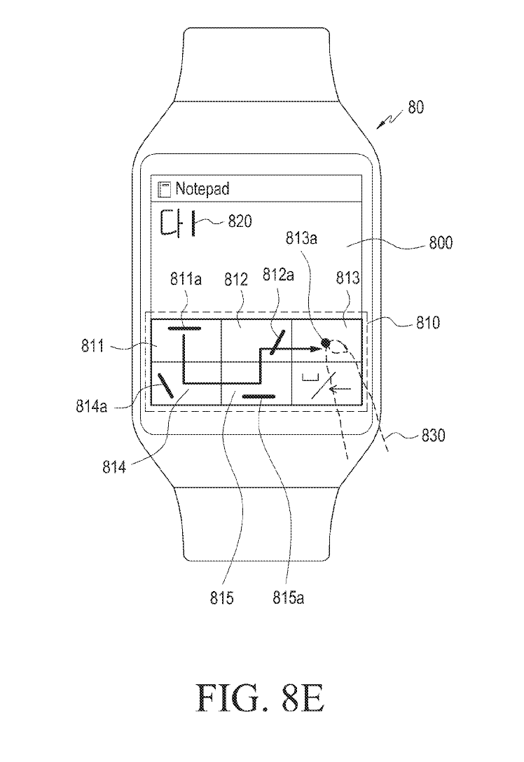

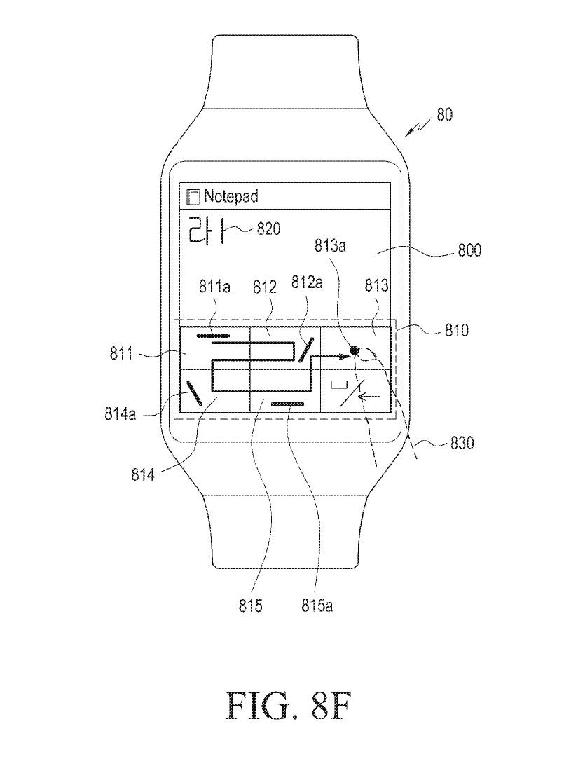

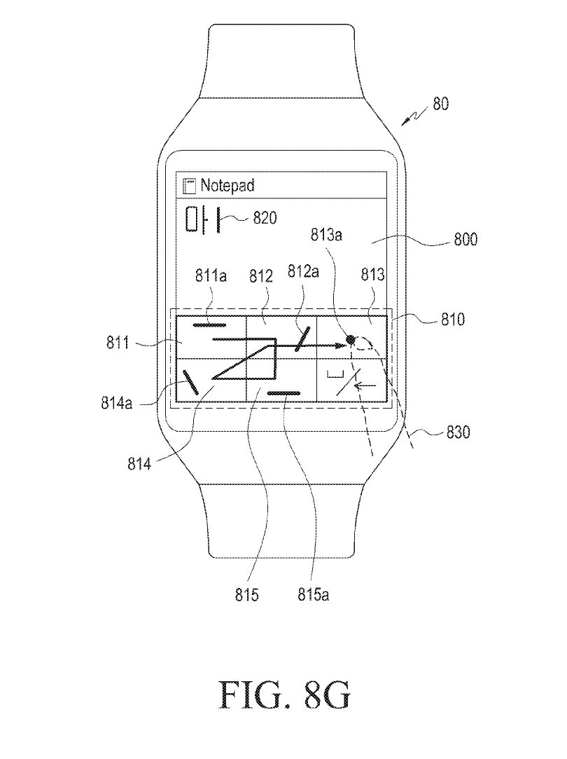

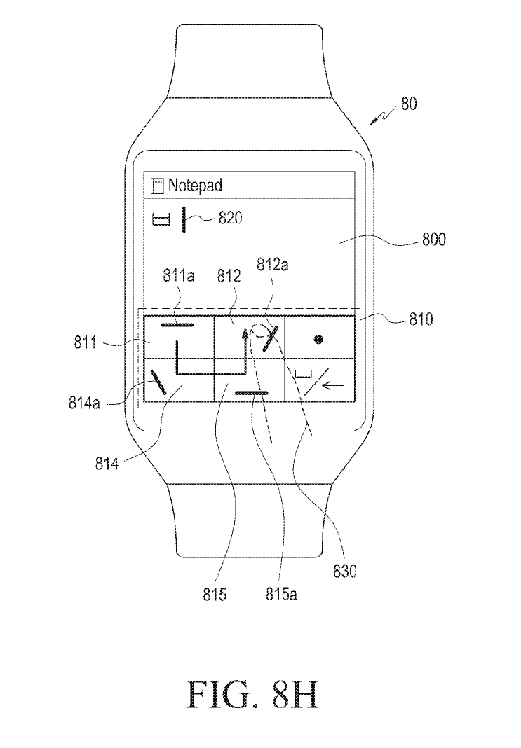

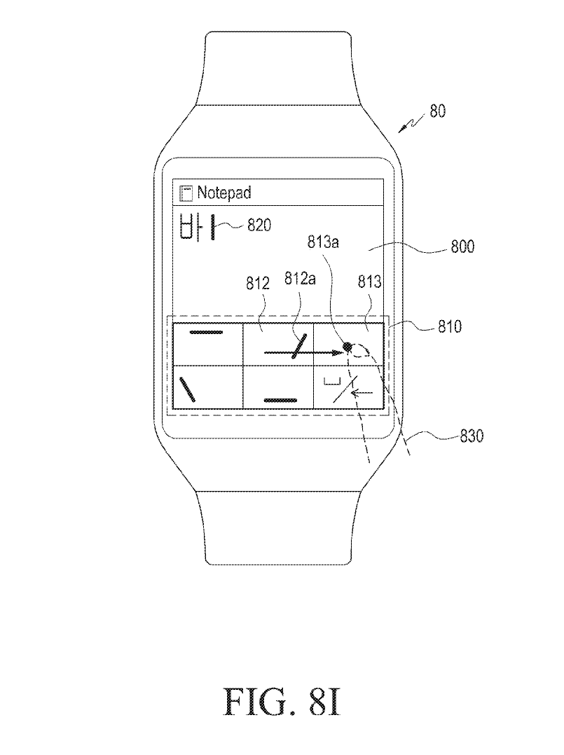

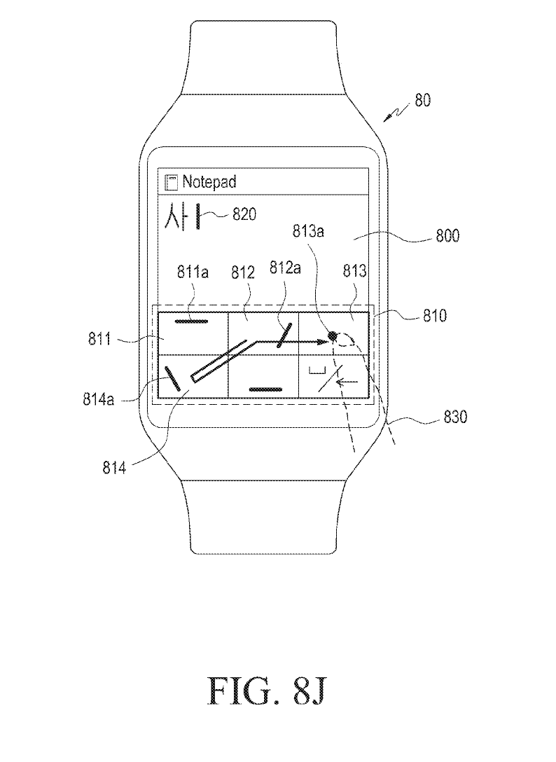

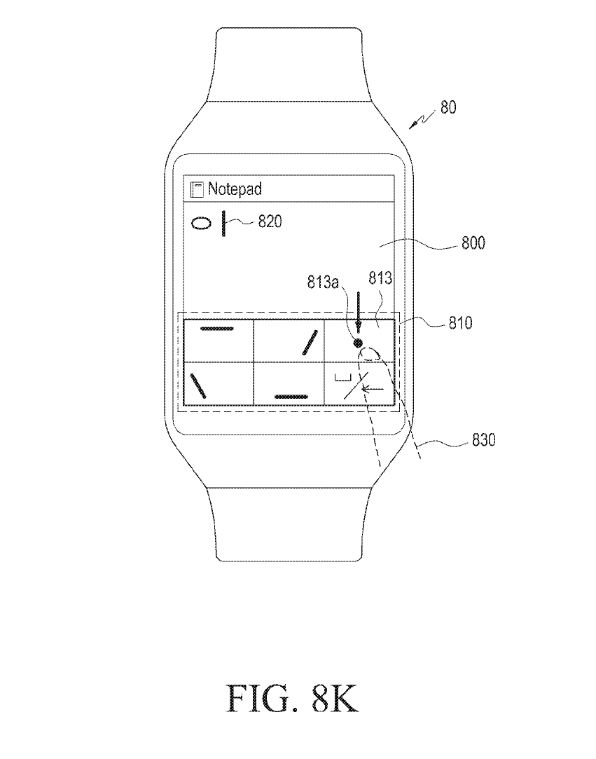

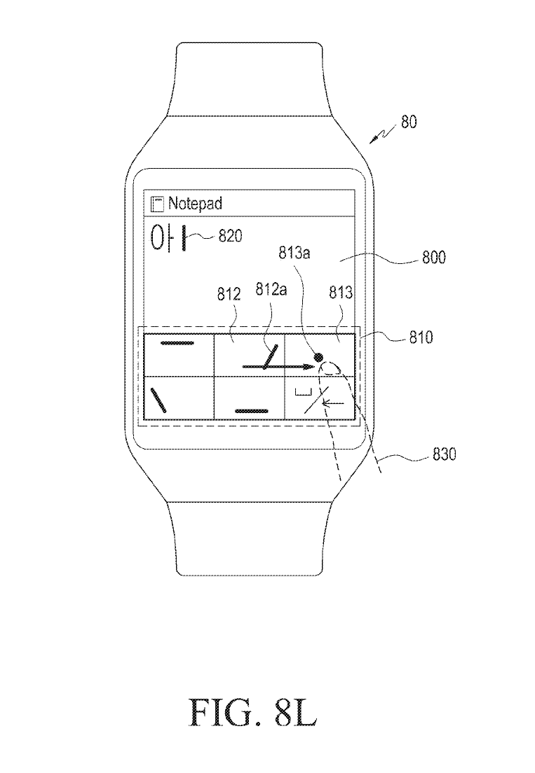

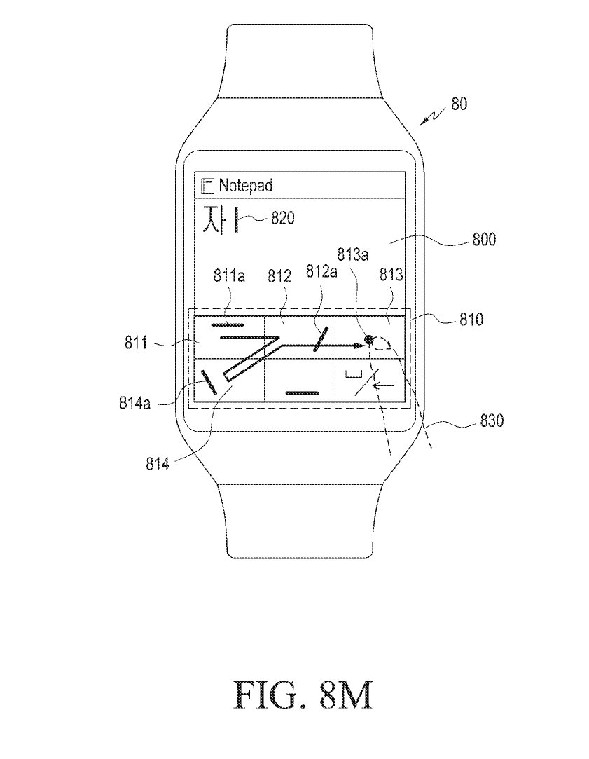

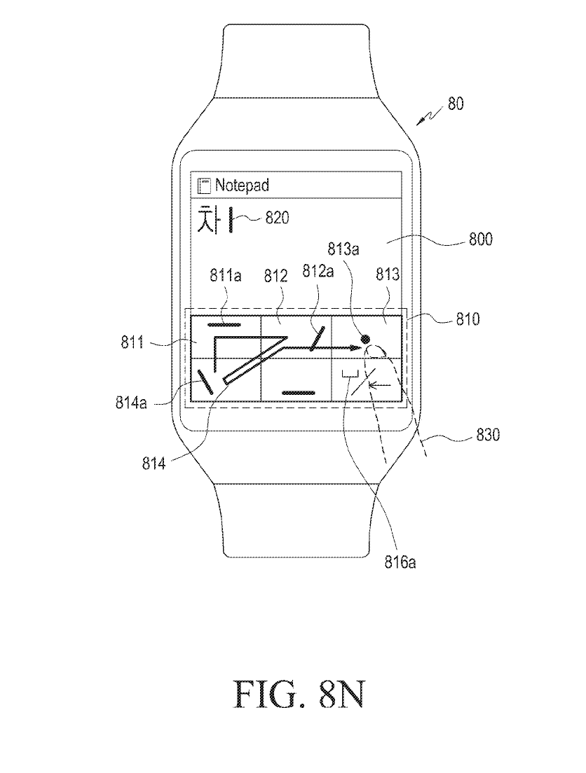

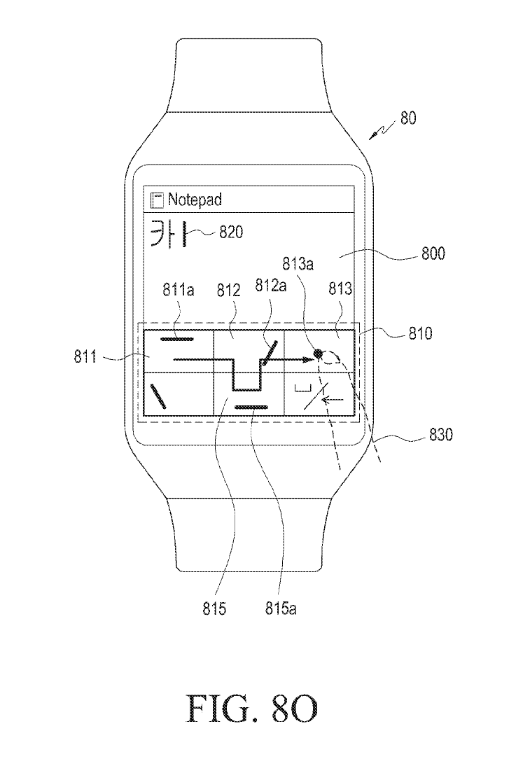

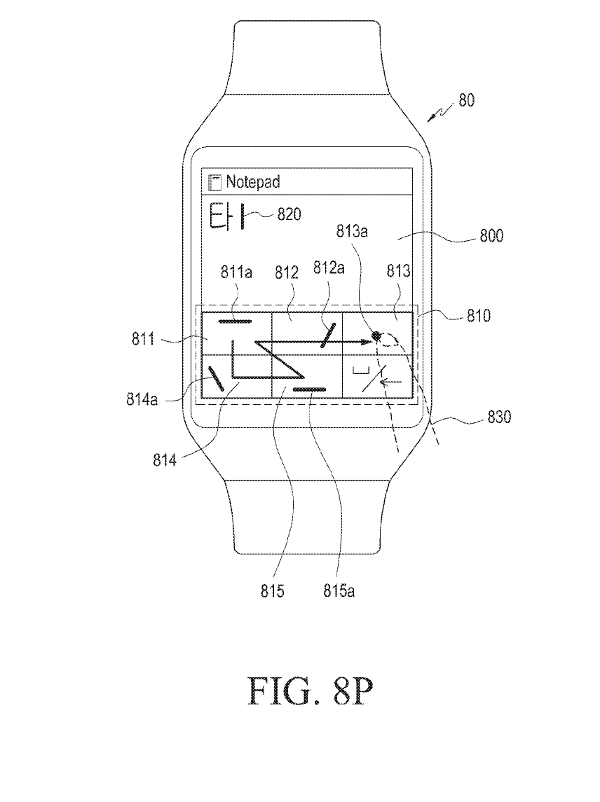

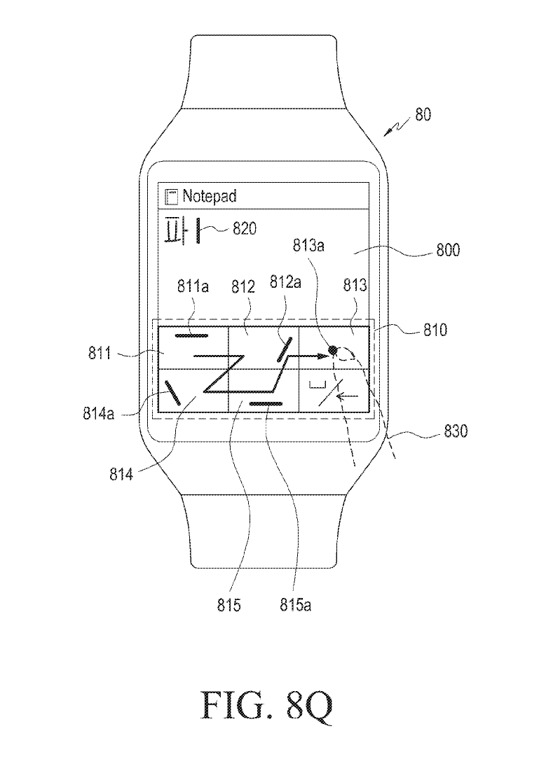

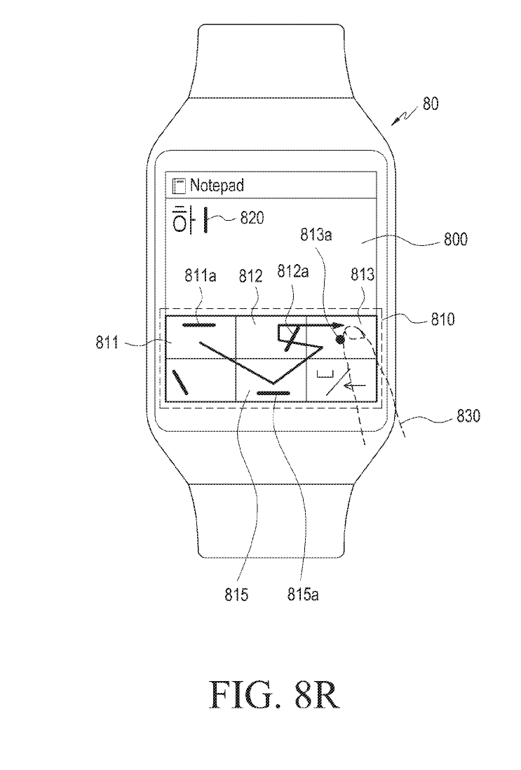

FIGS. 8A through 8R are exemplary views illustrating actual examples of inputting a character (e.g., a character that includes a Hangul consonant and a Hangul vowel) through a keypad, according to various embodiments of the present disclosure.

Referring to FIG. 8A, a keypad 810 may be displayed on a display module 800 of an electronic device 80. The keypad 810 may include a first sub-area 811, a second sub-area 812, a third sub-area 813, a fourth sub-area 814, a fifth sub-area 815, and a sixth sub-area 816. A first input element 811a, a second input element 812a, a third input element 813a, a fourth input element 814a, a fifth input element 815a may be displayed in the first sub-area 811, the second sub-area 812, the third sub-area 813, the fourth sub-area 814, and the fifth sub-area 815, respectively. According to the various embodiments of the present disclosure, sixth and seventh input elements 816a and 816b may be displayed in the sixth sub-area 816. A cursor 820 may be displayed on the display module 800.

FIGS. 8A and 8B illustrate an example of receiving, from a user 830, an input for displaying the Hangul character “ [symbol] ” on the electronic device 80. When the electronic device 80 receives, from the user 830, an input for displaying the Hangul consonant “ [symbol] ” as illustrated in FIG. 8A and receives an input for displaying the Hangul vowel “ [symbol] ” as illustrated in FIG. 8B within a predetermined period of time, a processor (e.g., the processor 220) of the electronic device 80 may control to display the Hangul character “ [symbol] ” on the display module. The descriptions of the function(s) or operation(s) illustrated in FIGS. 6A and 7A may be identically applied to the function(s) or operation (s) illustrated in FIGS. 8A and 8B, respectively.

FIGS. 8C and 8D illustrate an example of receiving, from the user 830, an input for displaying the Hangul character “ [symbol] ” on the electronic device 80. When the electronic device 80 receives, from the user 830, an input for displaying the Hangul consonant “ [symbol] ” as illustrated in FIG. 8C and receives an input for displaying the Hangul vowel “ [symbol] ” as illustrated in FIG. 8D within a predetermined period of time, the processor may control to display the Hangul character “ [symbol] ” on the display module. The descriptions of the function(s) or operation(s) illustrated in FIGS. 6B and 7A may be identically applied to the function(s) or operation (s) illustrated in FIGS. 8C and 8D, respectively. According to the various embodiments of the present disclosure, the function(s) or operation(s) illustrated in FIGS. 8C and 8D may also be performed by a continuous drag input. Namely, when a continuous drag input from the fourth sub-area 814 to the third sub-area 813 via the fifth sub-area 815 and the second sub-area 812 is received from the user 830, the processor may control to display the Hangul character “ [symbol] ” on the display module 800.

FIG. 8E illustrates an example of receiving, from the user 830, an input for displaying the Hangul character “ [symbol] ” on the electronic device 80. As illustrated in FIG. 8E, the input for displaying the Hangul character “ [symbol] ” on the electronic device 80 may include a continuous drag input from the first sub-area 811 to the third sub-area 813 via the fourth sub-area 814, the fifth sub-area 815, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8E may also be performed by separate (namely, non-continuous) drag inputs. That is, when the electronic device 80 receives, from the user 830, an input for displaying the Hangul consonant “ [symbol] ” as illustrated in FIG. 6C and then receives an input for displaying the Hangul vowel “ [symbol] ” as illustrated in FIG. 7A within a predetermined period of time, the processor may control to display the Hangul character “ [symbol] ” on the display module 800.

FIG. 8F illustrates an example of receiving, from the user 830, an input for displaying the Hangul character “ [symbol] ” on the electronic device 80. As illustrated in FIG. 8F, the input for displaying the Hangul character “ [symbol] ” on the electronic device 80 may include a continuous drag input from the first sub-area 811 to the third sub-area 813 via the second sub-area 812, the first sub-area 811, the fourth sub-area 814, the fifth sub-area 815, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8F may also be performed by separate drag inputs. That is, when the electronic device 80 receives, from the user 830, an input for displaying the Hangul consonant “ [symbol] ” as illustrated in FIG. 6D and then receives an input for displaying the Hangul vowel “ [symbol] ” as illustrated in FIG. 7A within a predetermined period of time, the processor may control to display the Hangul character “ [symbol] ” on the display module 800.

FIG. 8G illustrates an example of receiving, from the user 830, an input for displaying the Hangul character “ [symbol] ” on the electronic device 80. As illustrated in FIG. 8G, the input for displaying the Hangul character “ [symbol] ” on the electronic device 80 may include a continuous drag input from the first sub-area 811 to the third sub-area 813 via the second sub-area 812, the fifth sub-area 815, the fourth sub-area 814, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8G may also be performed by separate drag inputs. That is, when the electronic device 80 receives, from the user 830, an input for displaying the Hangul consonant “ [symbol] ” as illustrated in FIG. 6E and then receives an input for displaying the Hangul vowel “ [symbol] ” as illustrated in FIG. 7A within a predetermined period of time, the processor may control to display the Hangul character “ [symbol] ” on the display module 800.

FIGS. 8H and 81 illustrate an example of receiving, from the user 830, an input for displaying the Hangul character “ [symbol] ” on the electronic device 80. When the electronic device 80 receives, from the user 830, an input for displaying the Hangul consonant “ [symbol] ” as illustrated in FIG. 8H and receives an input for displaying the Hangul vowel “ [symbol] ” as illustrated in FIG. 8I within a predetermined period of time, the processor may control to display the Hangul character “ [symbol] ” on the display module 800. The descriptions of the function(s) or operation(s) illustrated in FIGS. 6F and 7A may be identically applied to the function(s) or operation (s) illustrated in FIGS. 8C and 8D, respectively.

FIG. 8J illustrates an example of receiving, from the user 830, an input for displaying the Hangul character “ [symbol] ” on the electronic device 80. As illustrated in FIG. 8J, the input for displaying the Hangul character “ [symbol] ” on the electronic device 80 may include a continuous drag input from the second sub-area 812 to the third sub-area 813 via the fourth sub-area 814 and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8J may also be performed by separate drag inputs. That is, when the electronic device 80 receives, from the user 830, an input for displaying the Hangul consonant “ [symbol] ” as illustrated in FIG. 6G and then receives an input for displaying the Hangul vowel “ [symbol] ” as illustrated in FIG. 7A within a predetermined period of time, the processor may control to display the Hangul character “ [symbol] ” on the display module 800.

FIGS. 8K and 81 illustrate an example of receiving, from the user 830, an input for displaying the Hangul character “ [symbol] ” on the electronic device 80. When the electronic device 80 receives, from the user 830, an input for displaying the Hangul consonant “ [symbol] ” as illustrated in FIG. 8K and receives an input for displaying the Hangul vowel “ [symbol] ” as illustrated in FIG. 8L within a predetermined period of time, the processor may control to display the Hangul character “ [symbol] ” on the display module 800. The descriptions of the function(s) or operation(s) illustrated in FIGS. 6H and 7A may be identically applied to the function(s) or operation (s) illustrated in FIGS. 8K and 8L, respectively.

FIG. 8M illustrates an example of receiving, from the user 830, an input for displaying the Hangul character “ [symbol] ” on the electronic device 80. As illustrated in FIG. 8M, the input for displaying the Hangul character “ [symbol] ” on the electronic device 80 may include a continuous drag input from the first sub-area 811 to the third sub-area 813 via the second sub-area 812, the fourth sub-area 814, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8M may also be performed by separate drag inputs. That is, when the electronic device 80 receives, from the user 830, an input for displaying the Hangul consonant “ [symbol] ” as illustrated in FIG. 6I and then receives an input for displaying the Hangul vowel “ [symbol] ” as illustrated in FIG. 7A within a predetermined period of time, the processor may control to display the Hangul character “ [symbol] ” on the display module 800.

FIG. 8N illustrates an example of receiving, from the user 830, an input for displaying the Hangul character “ [symbol] ” on the electronic device 80. As illustrated in FIG. 8N, the input for displaying the Hangul character “ [symbol] ” on the electronic device 80 may include a continuous drag input from the fourth sub-area 814 to the third sub-area 813 via the first sub-area 811, the second sub-area 812, the fourth sub-area 814, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8N may also be performed by separate drag inputs. That is, when the electronic device 80 receives, from the user 830, an input for displaying the Hangul consonant “ [symbol] ” as illustrated in FIG. 6J and then receives an input for displaying the Hangul vowel “ [symbol] ” as illustrated in FIG. 7A within a predetermined period of time, the processor may control to display the Hangul character “ [symbol] ” on the display module 800.

FIG. 8O illustrates an example of receiving, from the user 830, an input for displaying the Hangul character “ [symbol] ” on the electronic device 80. As illustrated in FIG. 8O, the input for displaying the Hangul character “ [symbol] ” on the electronic device 80 may include a continuous drag input from the first sub-area 811 to the third sub-area 813 via the second sub-area 812, the fourth sub-area 814, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8O may also be performed by separate drag inputs. That is, when the electronic device 80 receives, from the user 830, an input for displaying the Hangul consonant “ [symbol] ” as illustrated in FIG. 6K and then receives an input for displaying the Hangul vowel “ [symbol] ” as illustrated in FIG. 7A within a predetermined period of time, the processor may control to display the Hangul character “ [symbol] ” on the display module 800.

FIG. 8P illustrates an example of receiving, from the user 830, an input for displaying the Hangul character “ [symbol] ” on the electronic device 80. As illustrated in FIG. 8P, the input for displaying the Hangul character “ [symbol] ” on the electronic device 80 may include a continuous drag input from the first sub-area 811 to the third sub-area 813 via the fourth sub-area 814, the fifth sub-area 815, the first sub-area 811, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8P may also be performed by separate drag inputs. That is, when the electronic device 80 receives, from the user 830, an input for displaying the Hangul consonant “ [symbol] ” as illustrated in FIG. 6L and then receives an input for displaying the Hangul vowel “ [symbol] ” as illustrated in FIG. 7A within a predetermined period of time, the processor may control to display the Hangul character “ [symbol] ” on the display module 800.

FIG. 8Q illustrates an example of receiving, from the user 830, an input for displaying the Hangul character “ [symbol] ” on the electronic device 80. As illustrated in FIG. 8Q, the input for displaying the Hangul character “ [symbol] ” on the electronic device 80 may include a continuous drag input from the first sub-area 811 to the third sub-area 813 via the second sub-area 812, the fourth sub-area 814, the fifth sub-area 815, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8Q may also be performed by separate drag inputs. That is, when the electronic device 80 receives, from the user 830, an input for displaying the Hangul consonant “ [symbol] ” as illustrated in FIG. 6M and then receives an input for displaying the Hangul vowel “ [symbol] ” as illustrated in FIG. 7A within a predetermined period of time, the processor may control to display the Hangul character “ [symbol] ” on the display module 800.

FIG. 8R illustrates an example of receiving, from the user 830, an input for displaying the Hangul character “ [symbol] ” on the electronic device 80. As illustrated in FIG. 8R, the input for displaying the Hangul character “ [symbol] ” on the electronic device 80 may include a continuous drag input from the first sub-area 811 to the third sub-area 813 via the fifth sub-area 815, the third sub-area 813, the fifth sub-area 815, and the second sub-area 812. The drag input may be received from, for example, the user 830. When the drag input is received, the processor may control to display the Hangul character “ [symbol] ” on the display module 800 in response to the drag input. According to various embodiments of the present disclosure, the function(s) or operation(s) illustrated in FIG. 8R may also be performed by separate drag inputs. That is, when the electronic device 80 receives, from the user 830, an input for displaying the Hangul consonant “ [symbol] ” as illustrated in FIG. 6N and then receives an input for displaying the Hangul vowel “ [symbol] ” as illustrated in FIG. 7A within a predetermined period of time, the processor may control to display the Hangul character “ [symbol] ” on the display module 800.

In FIGS. 8A to 8R, the drag inputs and/or the touch inputs have been exemplified as the inputs for displaying the Hangul characters. However, the drag inputs and/or the touch inputs may be replaced by various types of input events, such as a touch, a tap, a swipe, hovering, a flick, and/or rotation. The inputs for displaying the characters may be listed in Table III below with reference to FIG. 5. A mapping table, which is defined as in Table III below, may have been stored in a storage module (e.g., the memory 230) of the electronic device 80, and when an input for displaying a Hangul character is received, the processor may determine which character is indicated by the received input based on the mapping table, such as Table III below, which has been stored in storage module. Various Hangul characters may be included in addition to the Hangul characters included in the mapping table, such as Table III below, and characters (e.g., radicals of Chinese characters) of various languages (e.g., Chinese language) may be additionally or alternatively included. “Comma (,)” in Table III below may mean that inputs before and after the “Comma (,)” are not continuously performed.

TABLE III

| Character | Input Sequence |
|---|---|
| “ [symbol] ” | (1) → (2), (2) → (3) |
| “ [symbol] ” | (4) → (5), (2) → (3) |
| | (4) → (5) → (2) → (3) |
| “ [symbol] ” | (1) → (4) → (5) → (2) → (3) |
| | (1) → (4) → (5), (2) → (3) |
| “ [symbol] ” | (1) → (2) → (1) → (4) → (5) → (2) → (3) |
| | (1) → (2) → (1) → (4), (5) → (2) → (3) |
| “ [symbol] ” | (1) → (2) → (5) → (4) → (2) → (3) |
| | (1) → (2) → (5) → (4), (2) → (3) |
| “ [symbol] ” | (1) → (4) → (5) → (2), (2) → (3) |
| “ [symbol] ” | (2) → (4) → (2) → (3) |
| | (2) → (4), (2) → (3) |
| “ [symbol] ” | (3), (2) → (3) |
| “ [symbol] ” | (1) → (2) → (4) → (2) → (3) |
| | (1) → (2) → (4), (2) → (3) |
| “ [symbol] ” | (4) → (1) → (2) → (4) → (2) → (3) |
| | (4) → (1) → (2) → (4), (2) → (3) |
| “ [symbol] ” | (1) → (2) → (5) → (2) → (3) |
| | (1) → (2) → (5), (2) → (3) |
| “ [symbol] ” | (1) → (4) → (5) → (1) → (2) → (3) |
| | (1) → (4) → (5) → (1), (2) → (3) |
| “ [symbol] ” | (1) → (2) → (4) → (5) → (2) → (3) |
| | (1) → (2) → (4) → (5), (2) → (3) |
| “ [symbol] ” | (1) → (5) → (3) → (2) → (3) |
| | (1) → (5) → (3), (2) → (3) |

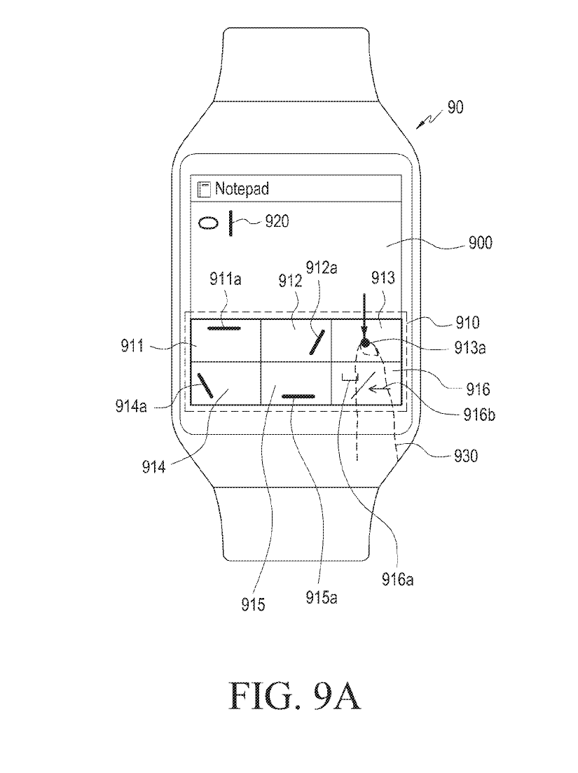

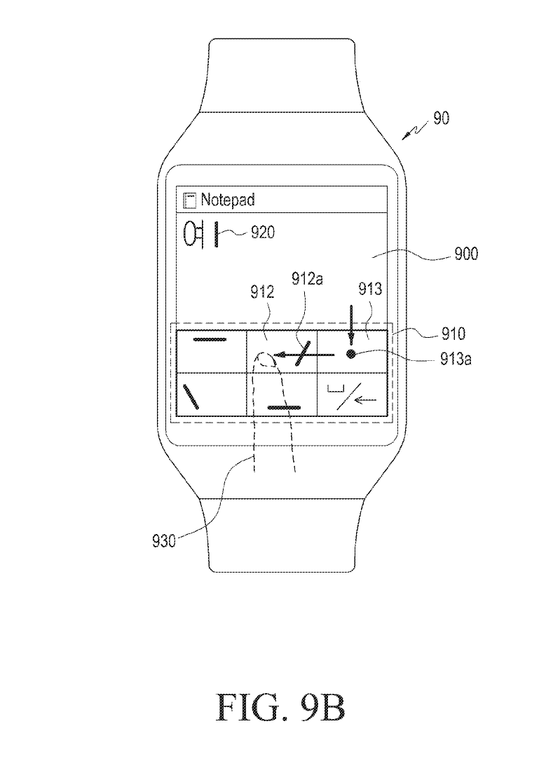

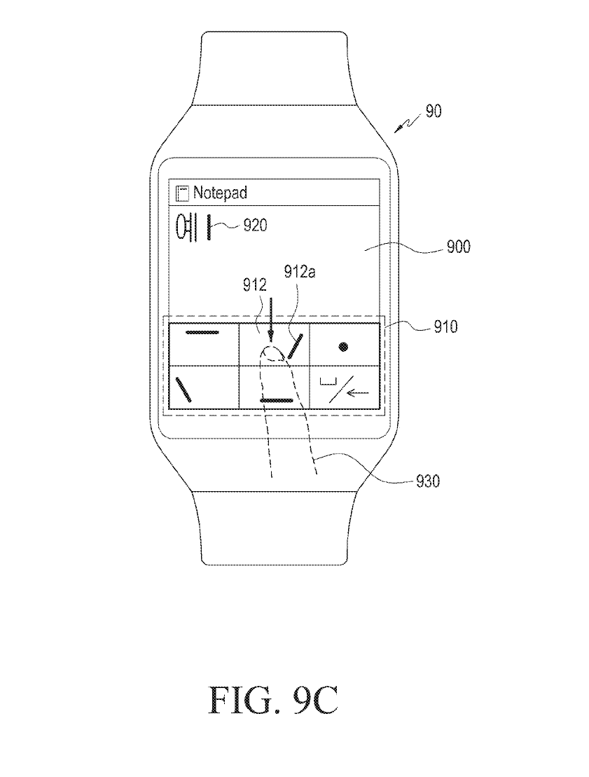

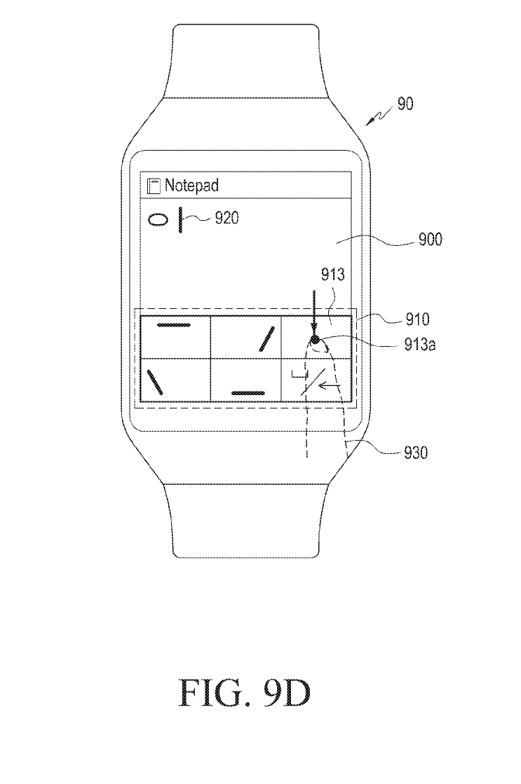

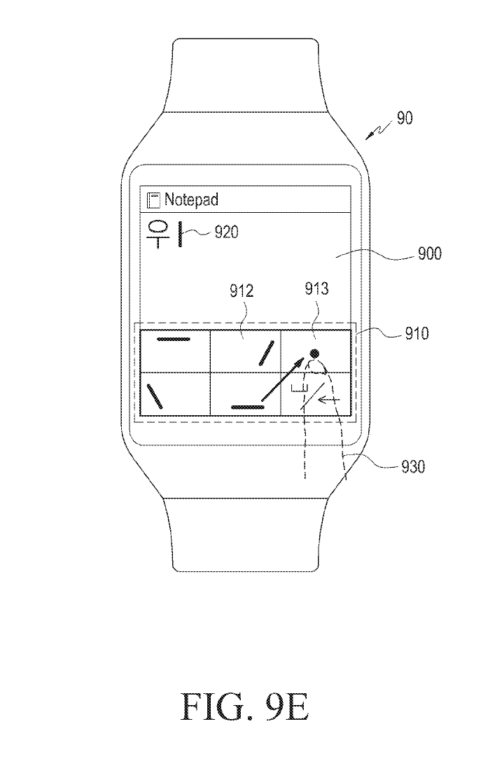

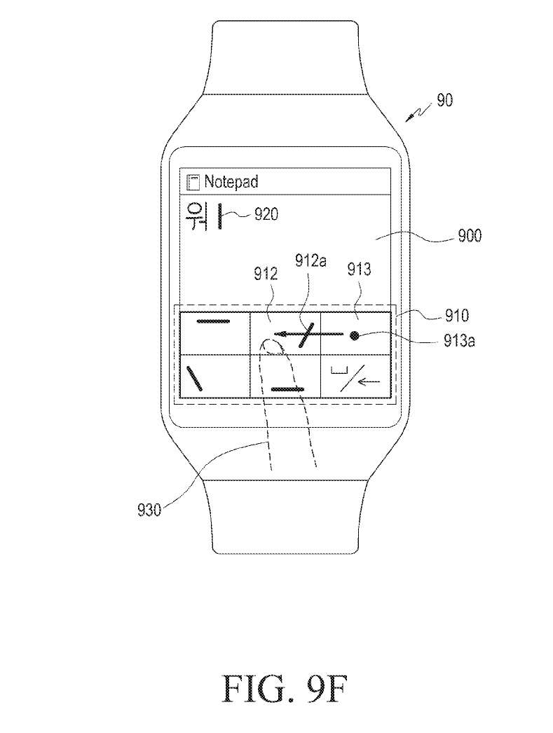

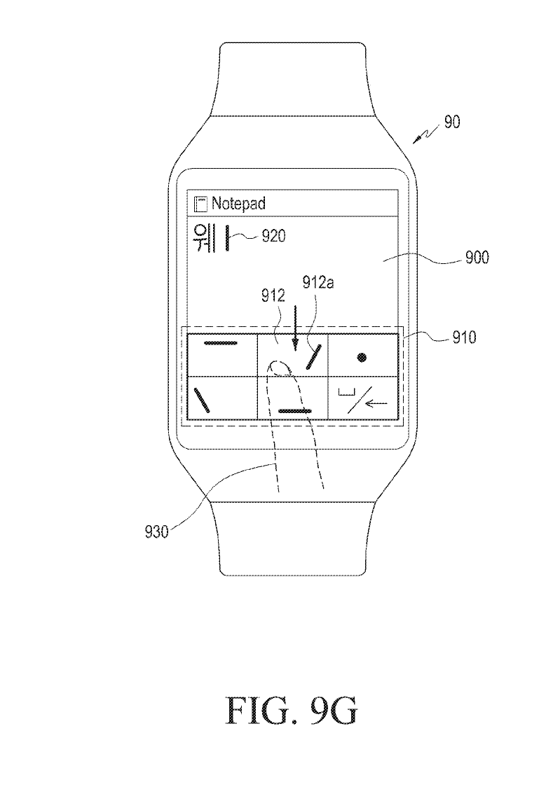

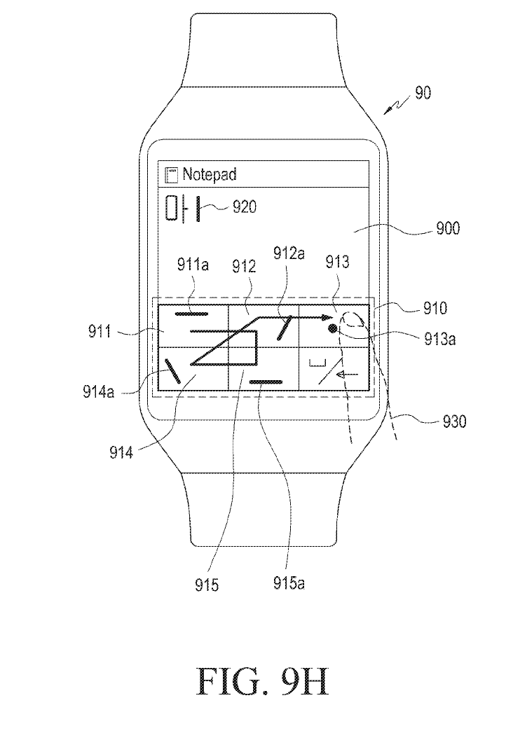

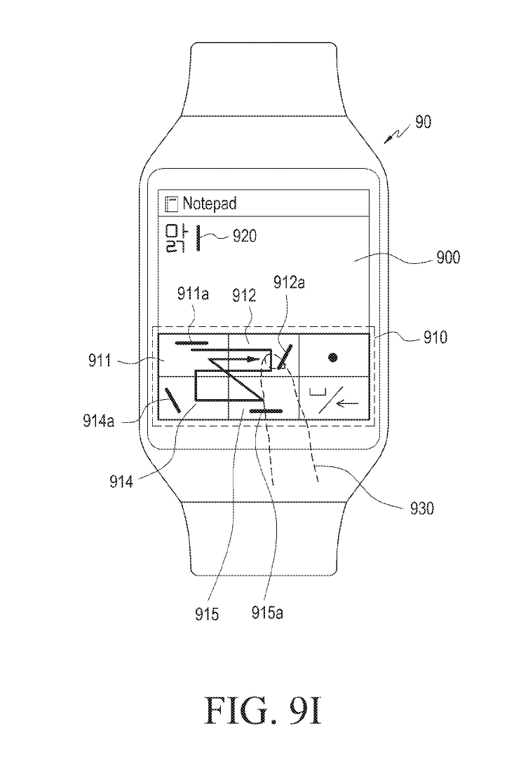

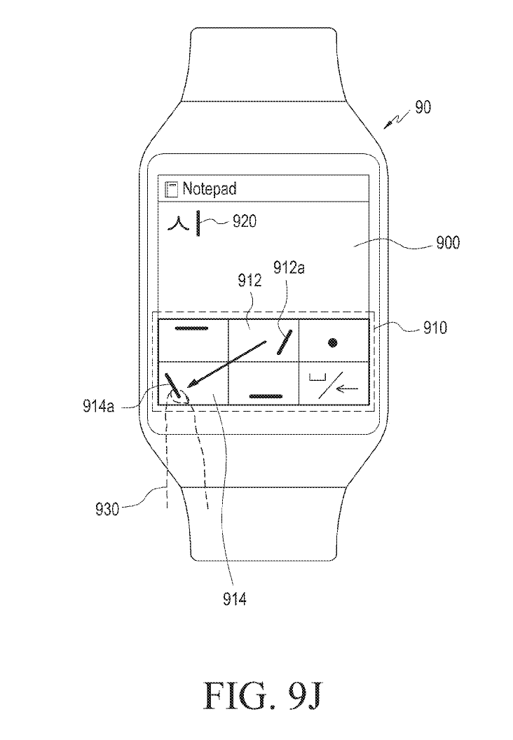

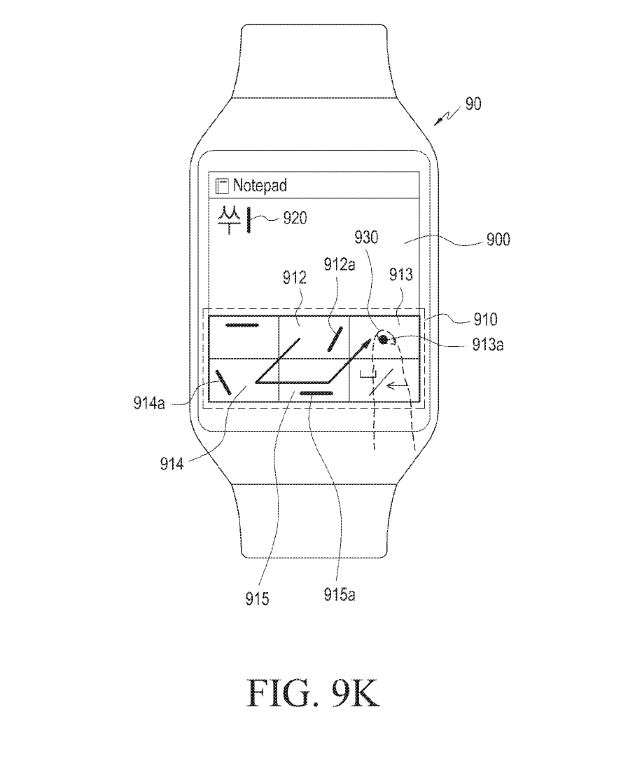

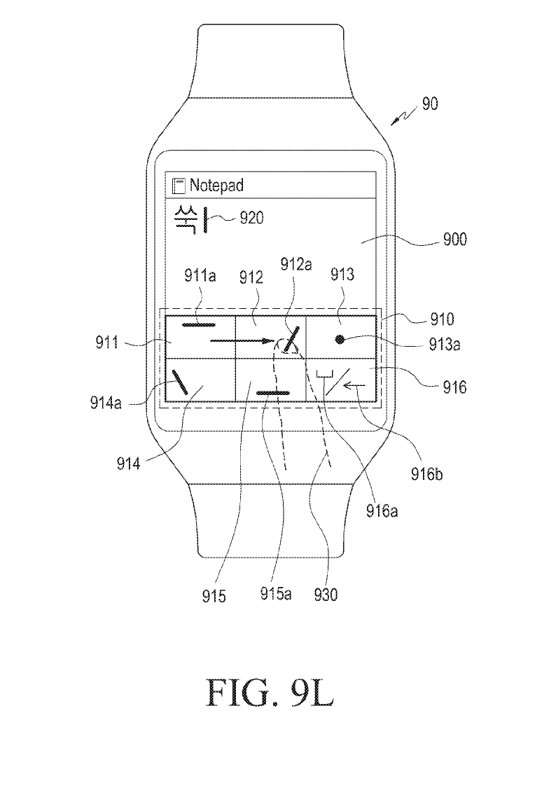

FIGS. 9A through 9L are exemplary views illustrating actual examples of inputting a character (e.g., a character that includes a Hangul consonant and a Hangul vowel) through a keypad, according to various embodiments of the present disclosure.

FIGS. 9A to 9C illustrate an example of receiving an input for displaying the Hangul character “ [symbol] .” As the input for displaying the Hangul character “ [symbol] ,” an input for displaying the Hangul consonant “ [symbol] ” may be received as illustrated in FIG. 9A, and an input for displaying the Hangul vowel “ [symbol] ” may be received as illustrated in FIGS. 9B and 9C. The input for displaying the Hangul character “ [symbol] ” may be carried out according to the input sequence (3), (3)→(3)→(2), (2) with reference to FIG. 5. In regard to the input of the Hangul consonant “ [symbol] ,” the above description of FIG. 6H may be identically applied.

FIGS. 9D to 9G illustrate an example of receiving an input for displaying the Hangul character “ [symbol] .” As for the input for displaying the Hangul character “ [symbol] ,” an input for displaying the Hangul consonant “ [symbol] ” may be received as illustrated in FIG. 9D, an input for displaying the Hangul vowel “ [symbol] ” may be received as illustrated in 9E, and an input for displaying the Hangul vowel “ [symbol] ” may be received as illustrated in FIGS. 9F and 9G. The input for displaying the Hangul character “ [symbol] ” may be carried out according to the input sequence (3)→(5)→(3)→(3)→(2), (2) with reference to FIG. 5. In regard to the input of the Hangul consonant “ [symbol] ,” the above description of FIG. 6H may be identically applied.

FIGS. 9H through 9I illustrate an example of receiving an input for displaying the Hangul character “ [symbol] .” As for the input for displaying the Hangul character “ [symbol] ,” an input for displaying the Hangul character “ [symbol] ” may be received as illustrated FIG. 9H, and inputs for displaying the Hangul consonants “ [symbol] ” and “ [symbol] ” may be received as illustrated in FIG. 9I. The input for displaying the Hangul character “ [symbol] ” may be carried out according to the input sequence (1)→(2)→(5)→(4)→(2)→(3), (1)→(2)→(1)→(4)→(5)→(1)→(2) with reference to FIG. 5. In addition, the various embodiments of the present disclosure, which have been described above, may be applied to the reception of the input for the character “ [symbol] .”

FIGS. 9J to 9L illustrate an example of receiving an input for displaying the Hangul character “ [symbol] .” As for the input for displaying the Hangul character “ [symbol] ,” an input for displaying the Hangul character “ [symbol] ” may be received as illustrated in FIGS. 9J and 9K, and an input for displaying the Hangul consonant “ [symbol] ” may be received as illustrated in FIG. 9L. The input for displaying the Hangul character “ [symbol] ” may be carried out according to the input sequence (2)→(4), (2)→(4)→(5)→(3), (1)→(2) with reference to FIG. 5.

According to various embodiments of the present disclosure, when a wearable device 90 receives, from a user, a continuous drag input from a third sub-area 913 to a sixth sub-area 916, the wearable device 90 may display a font menu for changing the font of a character (e.g., the Hangul, the English alphabet, etc.). The font menu may include various font items (e.g., “Batang,” “Gulim,” “Arial,” etc.). When the wearable device 90 receives a selection input for one of the various font items from the user, the wearable device 90 may change the font of the character into the font that corresponds to the selected font item. According to various embodiments of the present disclosure, when the wearable device 90 receives, from the user, the continuous drag input from the third sub-area 913 to the sixth sub-area 916, the wearable device 90 may also control to change the font of the character into a predetermined font.

According to various embodiments of the present disclosure, e.g., the first input element 311a, the second input element 312a, the third input element 313a, the fourth input element 314a, the fifth input element 315a, the sixth input element 316a, and the seventh input element 316b of FIG. 3 may be displayed in the first sub-area 311, the second sub-area 312, the third sub-area 313, the fourth sub-area 314, the fifth sub-area 315, and the sixth sub-area 316, respectively, that are included in the keypad (e.g., the keypad 310).

According to various embodiments of the present disclosure, the input elements (e.g., the first input element 311a, the second input element 312a, the third input element 313a, the fourth input element 314a, the fifth input element 315a, the sixth input element 316a, and the seventh input element 316b of FIG. 3) may include the first to seventh input elements, the sub-areas (e.g., the first sub-area 311, the second sub-area 312, the third sub-area 313, the fourth sub-area 314, the fifth sub-area 315, and the sixth sub-area 316) may include the first to sixth sub-areas, and the first to seventh input elements may be displayed to be included in at least one of the first to sixth sub-areas.

According to various embodiments of the present disclosure, the first input element (e.g., the first input element 311a) may be displayed to be located on the upper side of the first sub-area (e.g., the first sub-area 311) with respect to the center line of the first sub-area.

According to various embodiments of the present disclosure, the fifth input element (e.g., the fifth input element 315a) may be displayed to be located on the lower side of the fifth sub-area with respect to the center line of the fifth sub-area.

According to various embodiments of the present disclosure, the second input element (e.g., the second input element 312a) and the fourth input element (e.g., the fourth input element 314a) may be displayed in the second sub-area (e.g., the second sub-area 312) and the fourth sub-area (e.g., the fourth sub-area 314), respectively, so as to be inclined at a predetermined angle.

According to various embodiments of the present disclosure, the display module (e.g., the display 260) may include a touch screen, and the touch screen may receive a touch input for selecting at least one of the displayed input elements in order to input the character.

According to various embodiments of the present disclosure, the processor (e.g., the processor 220) of the electronic device may determine whether the selected input element or a combination of the selected input elements corresponds to one of the predetermined characters.

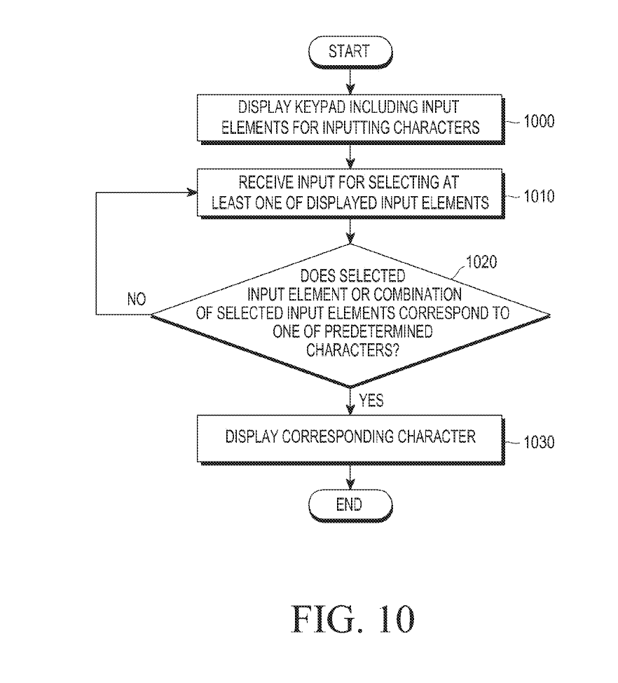

FIG. 10 is a flowchart illustrating a method of operating an electronic device according to various embodiments of the present disclosure.

Referring to FIG. 10, the method of operating the electronic device, according to the various embodiments of the present disclosure, may include an operation 1000 of displaying a keypad that includes input elements for inputting characters (e.g., the Hangul, the English alphabet to be described below, etc.). Further, the method of operating the electronic device, according to the various embodiments of the present disclosure, may include an operation 1010 of receiving an input for selecting at least one of the displayed input elements. In addition, the method of operating the electronic device, according to the various embodiments of the present disclosure, may include an operation 1020 of determining whether the selected input element or a combination of the selected input elements corresponds to one of the predetermined characters. The method of operating the electronic device, according to the various embodiments of the present disclosure, may include an operation 1030 of displaying the corresponding character when the selected input element or a combination of the selected input elements corresponds to one of the predetermined characters. The method of operating the electronic device, according to the various embodiments of the present disclosure, may include performing the operation 1010 again when the selected input element or a combination of the selected input elements does not correspond to one of the predetermined characters. In addition, the description of the electronic device, according to the various embodiments of the present disclosure that have been described above, may be identically applied to the method of operating the electronic device, according to the various embodiments of the present disclosure, within a range in which the description does not conflict with the contents that have been described in connection with FIG. 10.

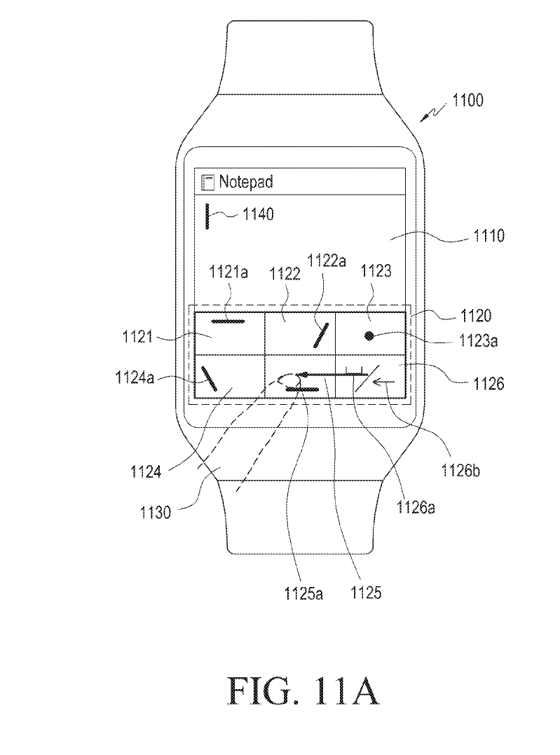

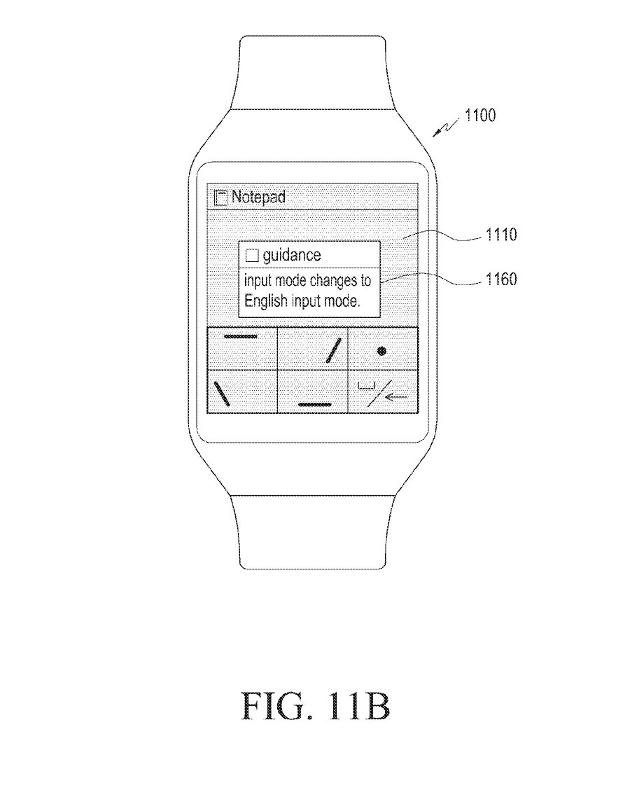

FIGS. 11A and 11B are exemplary views illustrating a function/operation of changing an input mode according to various embodiments of the present disclosure. Referring to FIG. 11A, a keypad 1120 may be displayed on a display module 1110 of an electronic device 1100 according to various embodiments of the present disclosure. The keypad 1120 may include a first sub-area 1121, a second sub-area 1122, a third sub-area 1123, a fourth sub-area 1124, a fifth sub-area 1125, and a sixth sub-area 1126. A first input element 1121a, a second input element 1122a, a third input element 1123a, a fourth input element 1124a, and a fifth input element 1125a may be displayed in the first sub-area 1121, the second sub-area 1122, the third sub-area 1123, the fourth sub-area 1124, and the fifth sub-area 1125, respectively. According to the various embodiments of the present disclosure, a sixth input element 1126a and a seventh input element 1126b may be displayed in the sixth sub-area 1126. A cursor 1140 may be displayed on the display module 1110.

Referring to FIG. 11A, the electronic device 1100 may receive, from a user 1130, a request for changing an input mode as illustrated in FIG. 11A. The change of the input mode may include, for example, a change from a Hangul input mode to an English input mode (or from the English input mode to the Hangul input mode). In FIG. 11A, a continuous drag input from the sixth sub-area 1126 to the fifth sub-area 1125 is illustrated as the request for changing the input mode. When the request for changing the input mode is received as illustrated in FIG. 11A, a processor (e.g., the processor 220) of the electronic device 1100 may control to change the input mode (e.g., from the Hangul input mode to the English input mode). As illustrated in FIG. 11B, the processor may control to display, on the display module 1110, a guidance message 1160 for informing that the input mode is changed. According to various embodiments of the present disclosure, at least a part of the contents described in connection with FIG. 4 may also be identically applied to the first input element 1121a, the second input element 1122a, the third input element 1123a, the fourth input element 1124a, the fifth input element 1125a, the sixth input element 1126a, and the seventh input element 1126b for inputting the English alphabet in the English input mode.

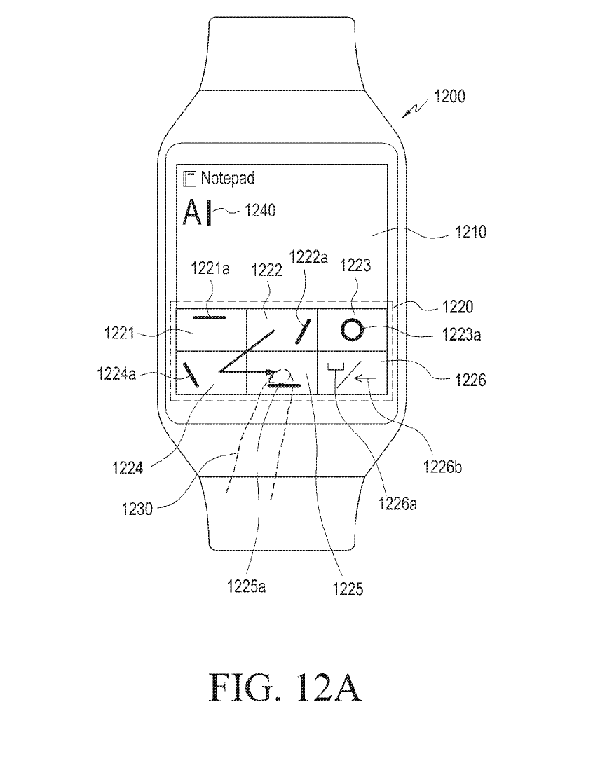

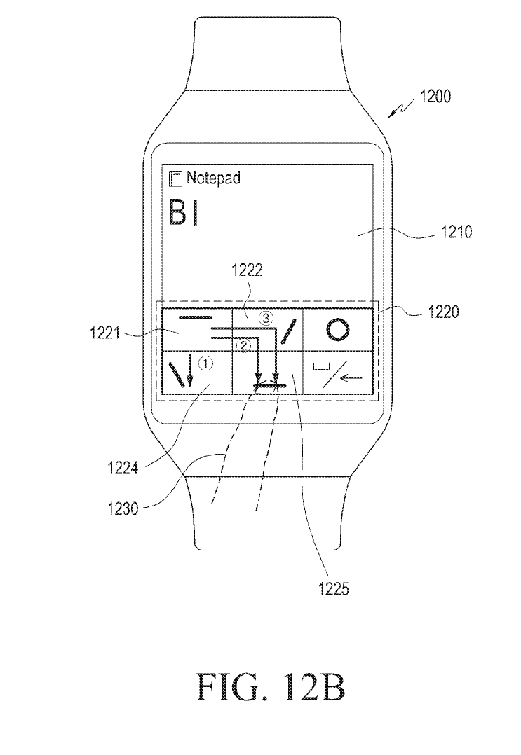

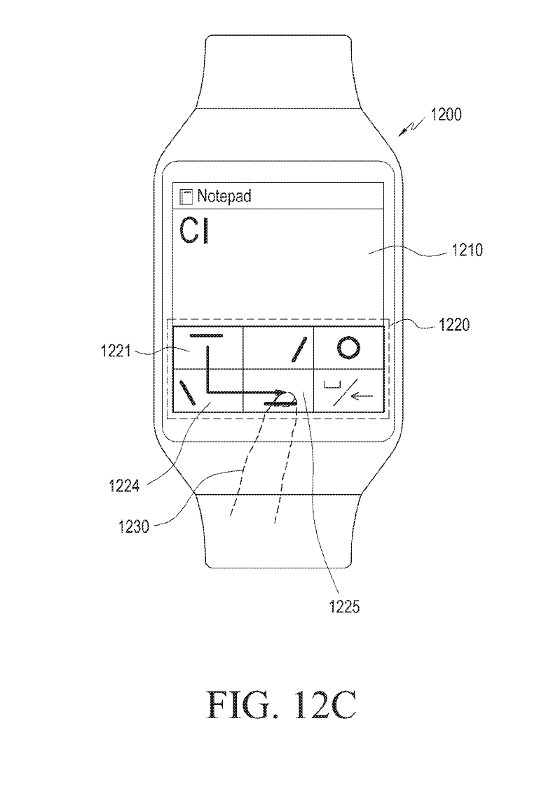

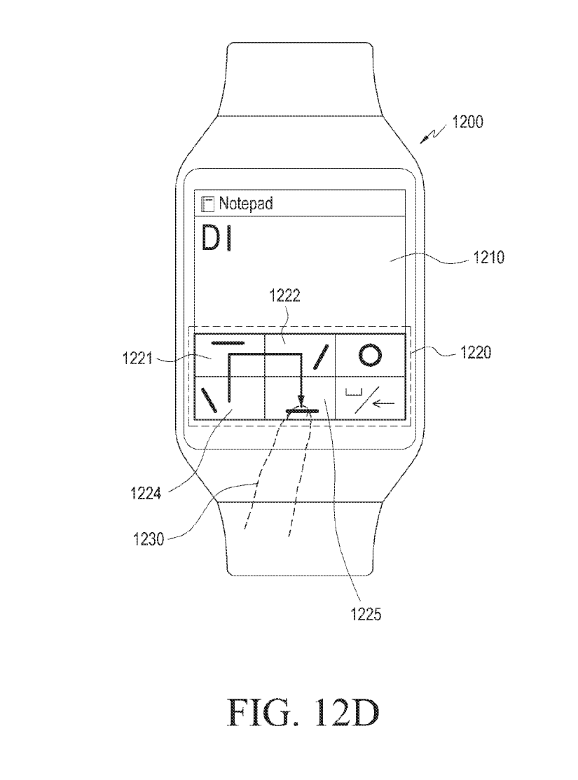

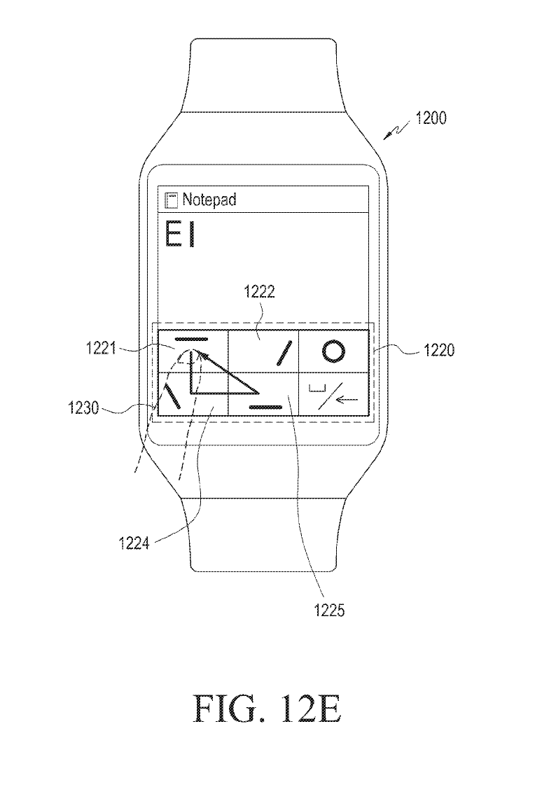

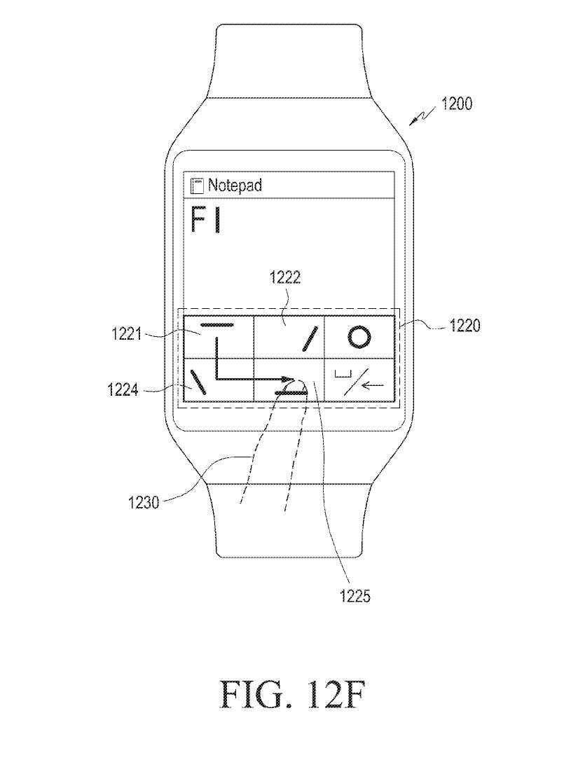

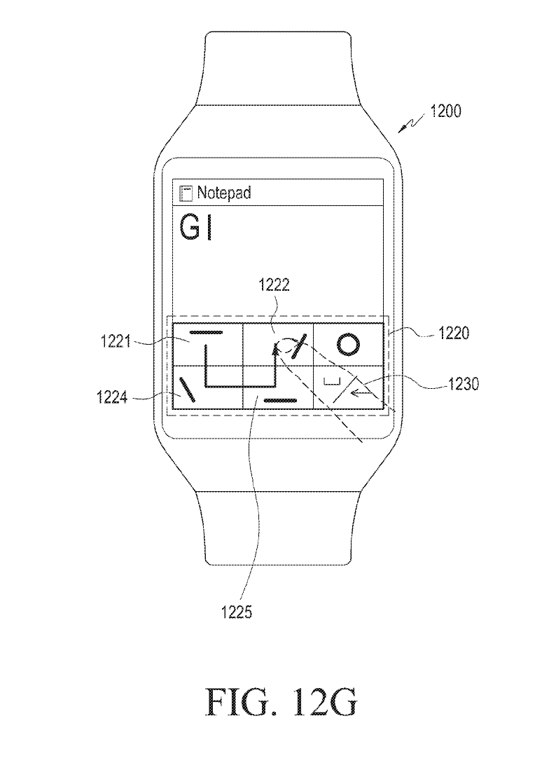

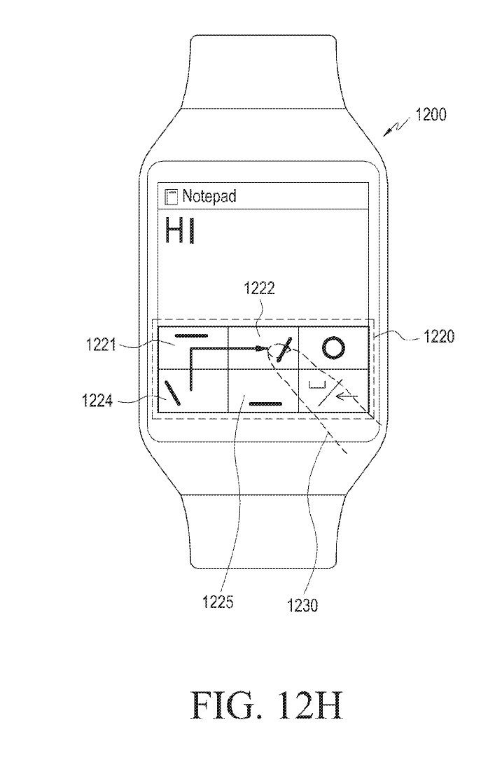

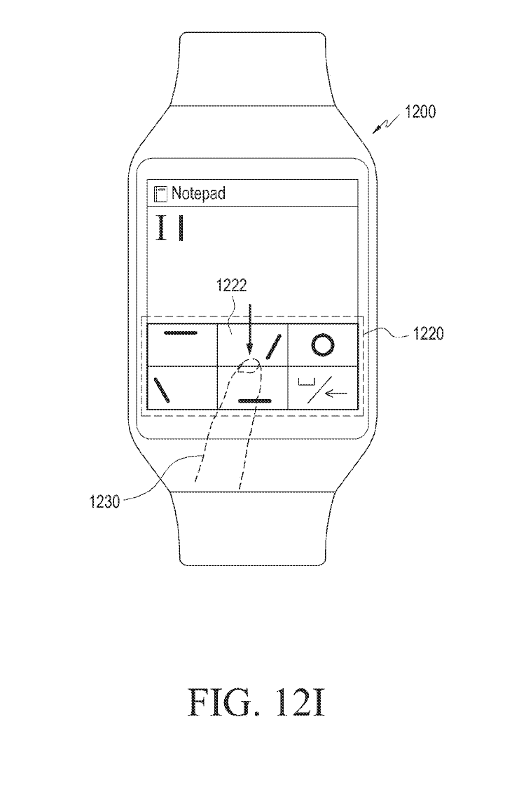

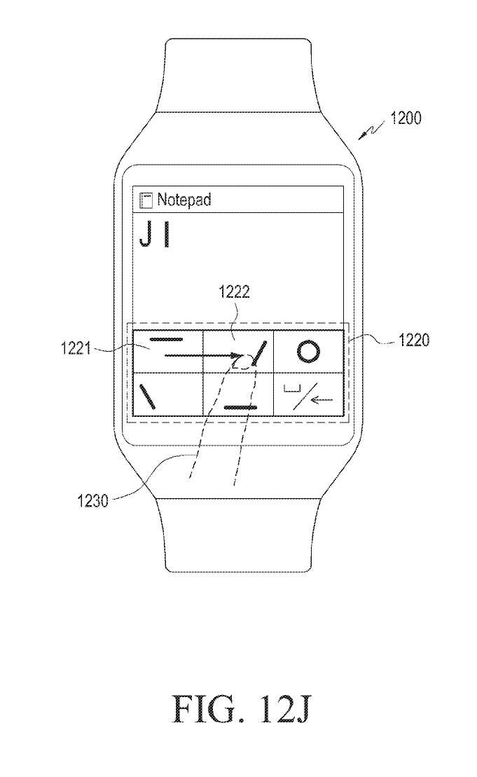

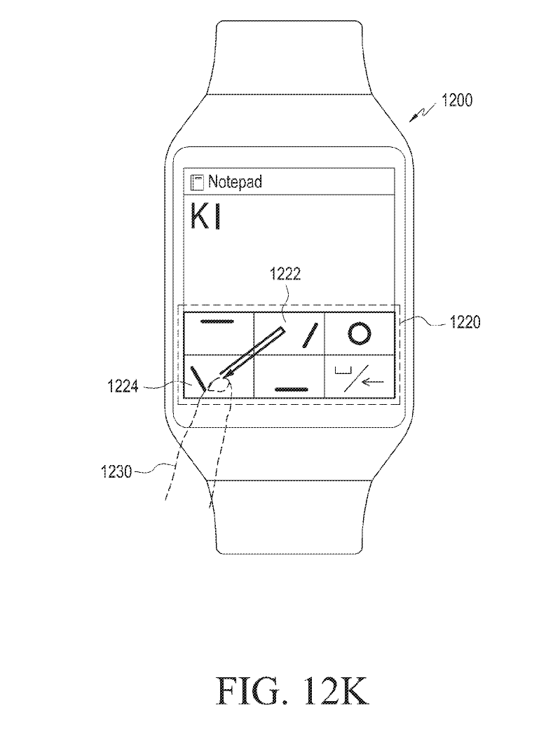

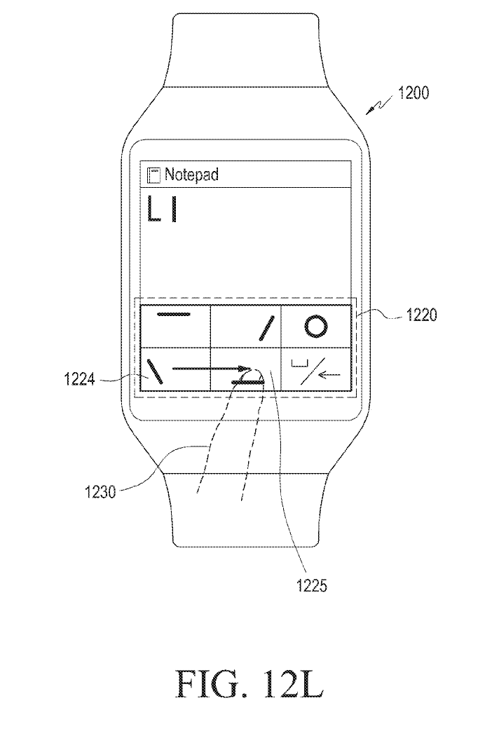

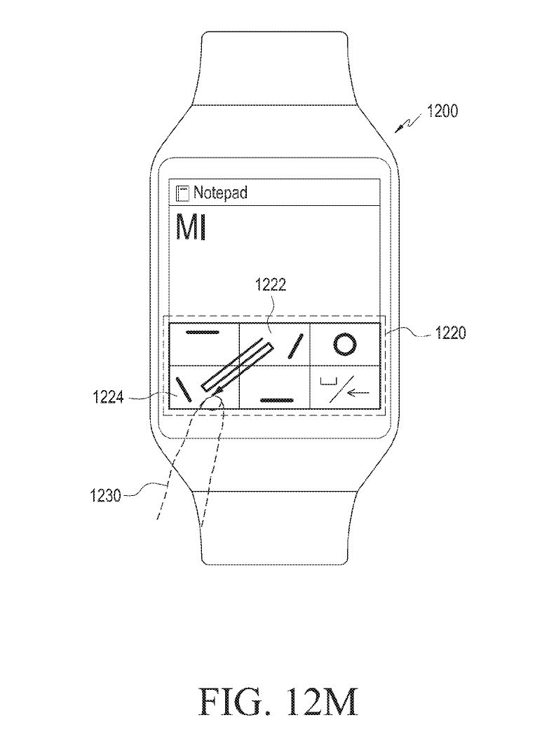

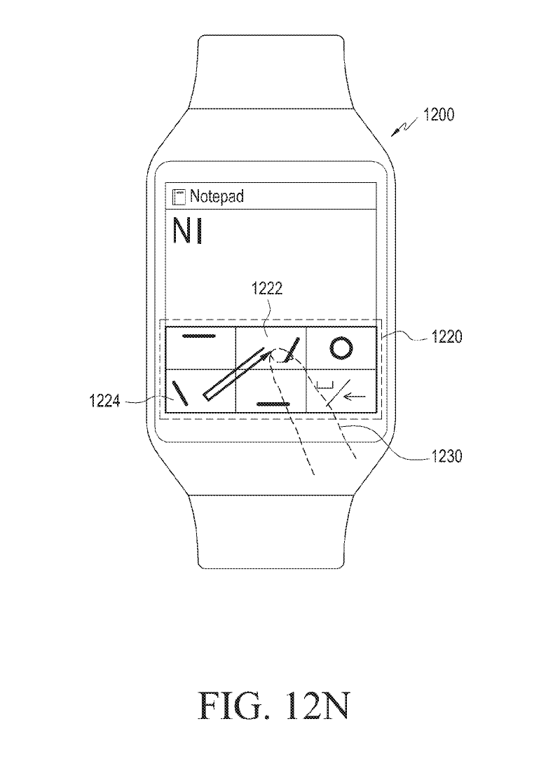

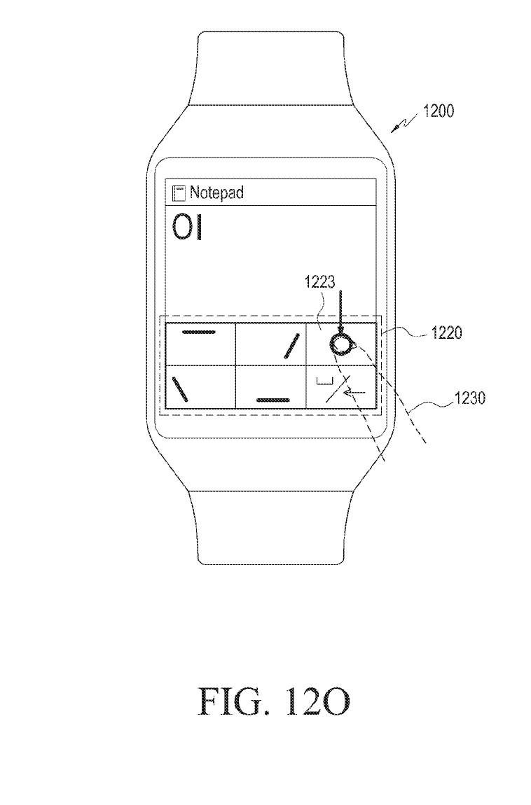

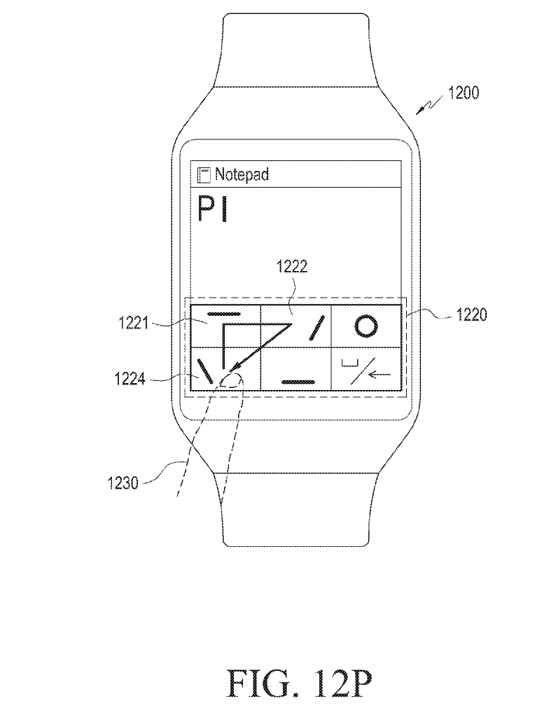

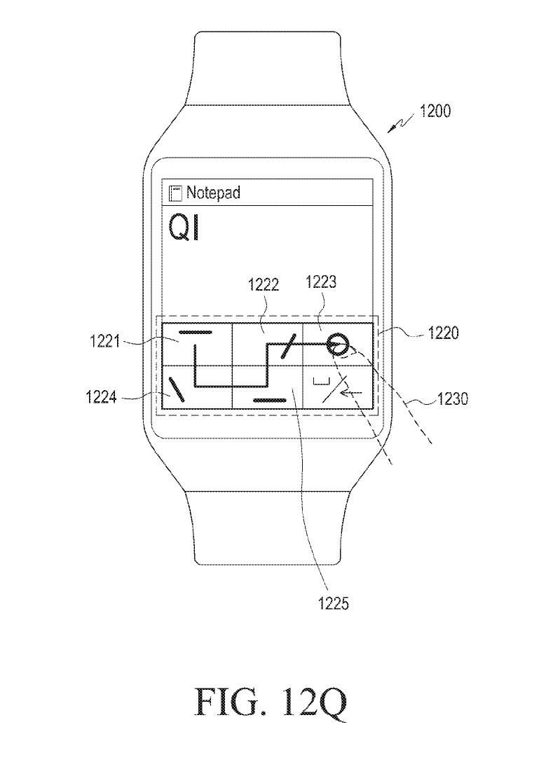

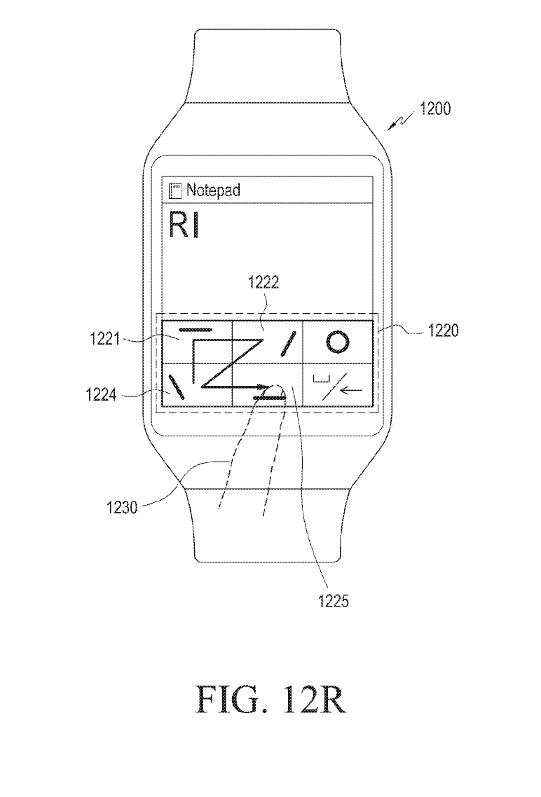

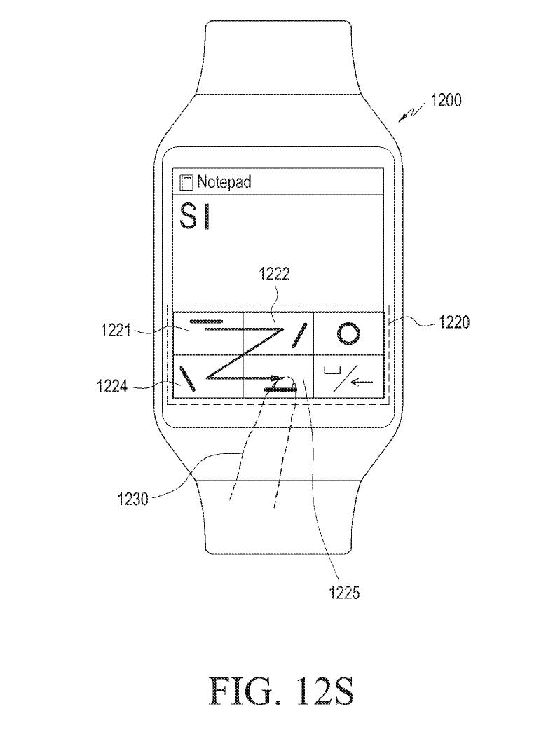

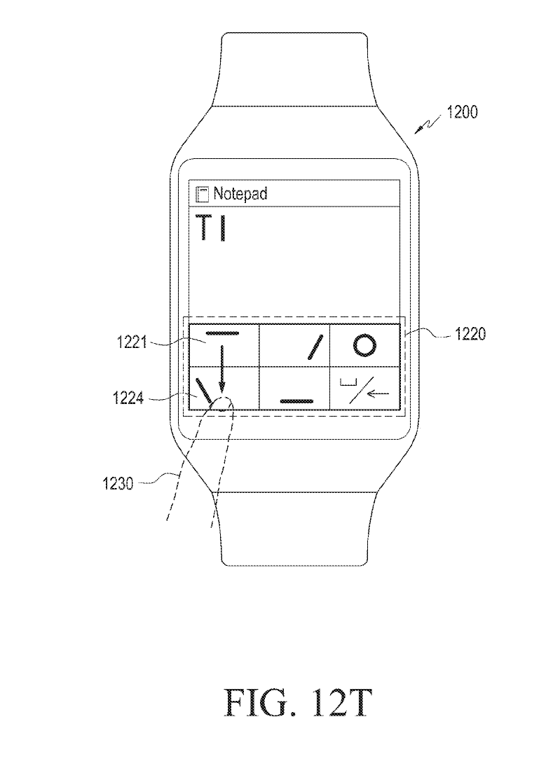

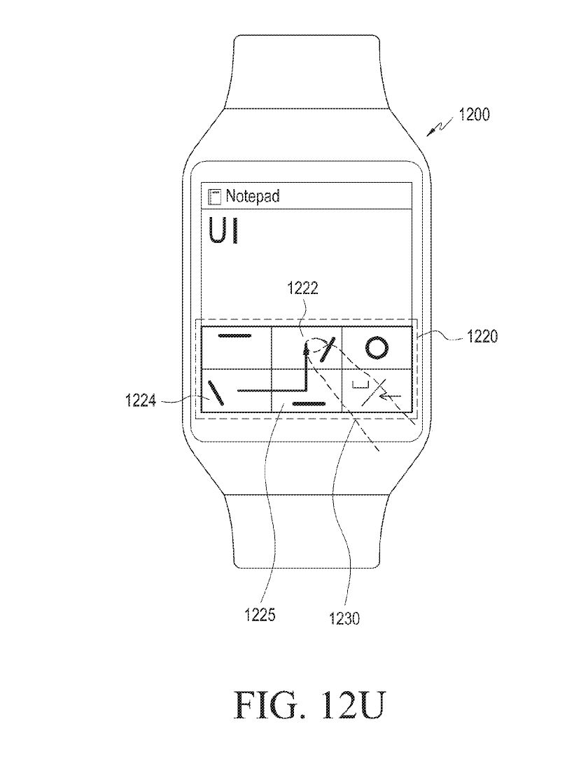

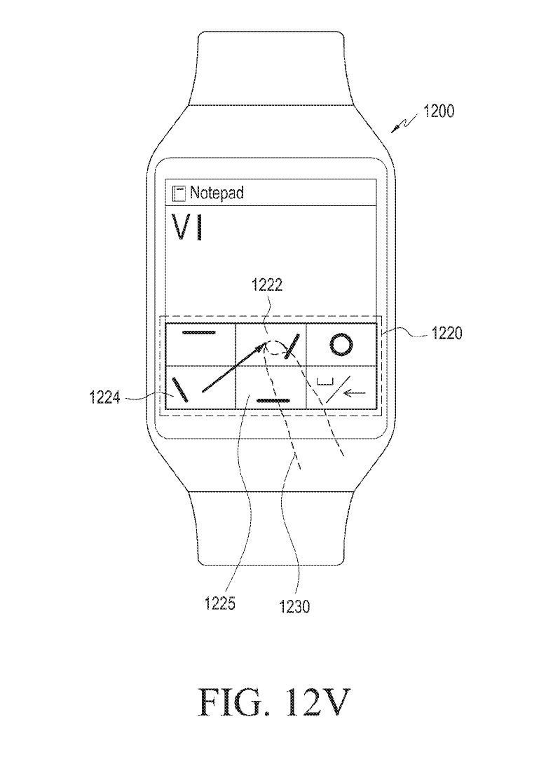

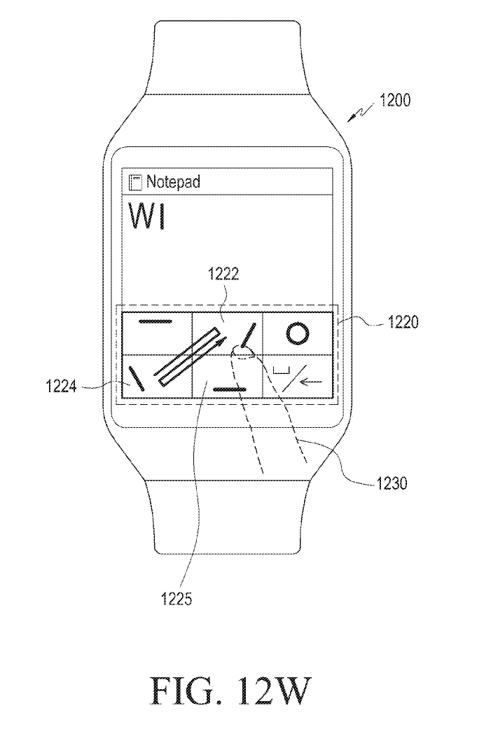

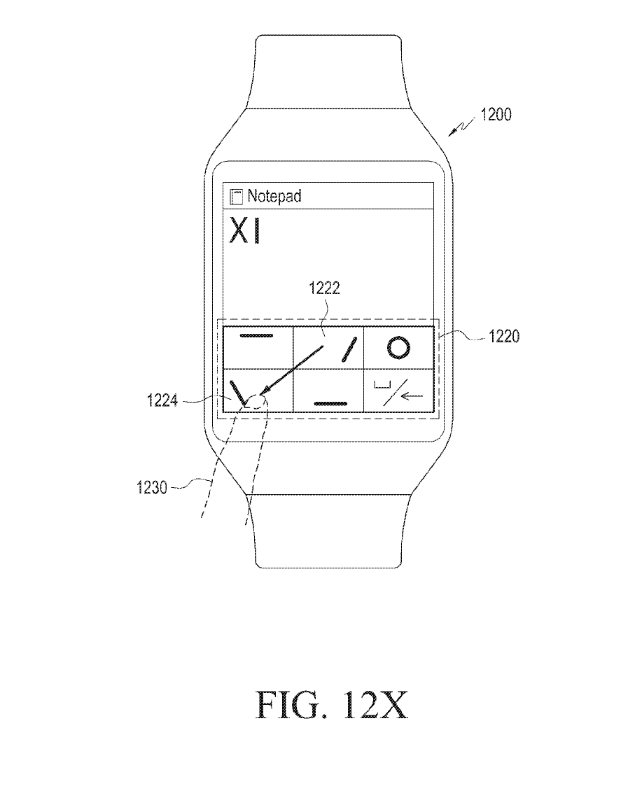

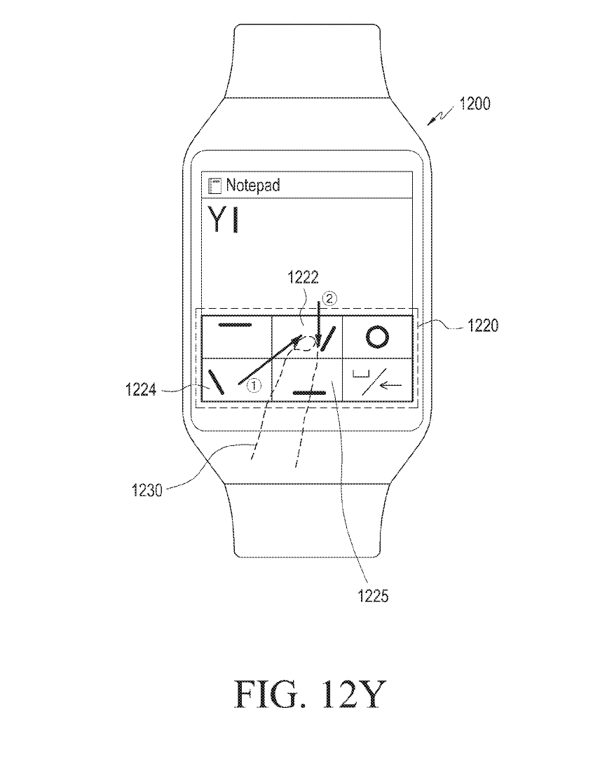

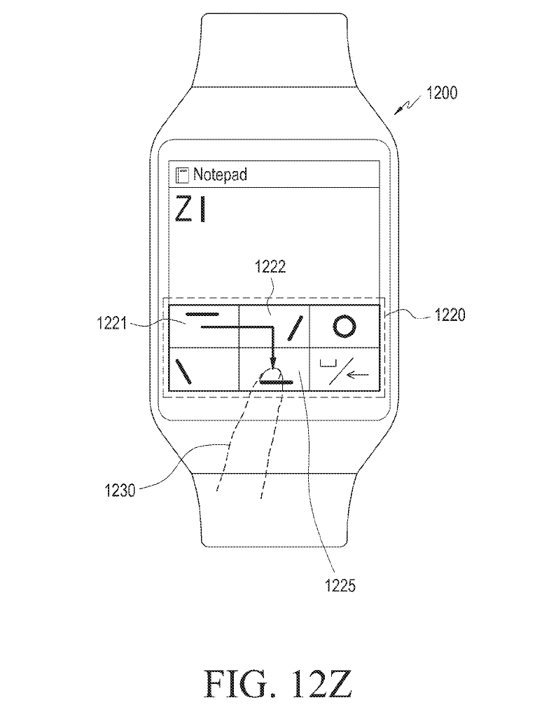

FIGS. 12A to 12Z are exemplary views illustrating examples of inputting the English alphabet in the English input mode according to various embodiments of the present disclosure.

Referring to FIG. 12A, a keypad 1220 may be displayed on a display module 1210 of an electronic device 1200 according to various embodiments of the present disclosure. The keypad 1220 may include the first sub-area 1221, the second sub-area 1222, the third sub-area 1223, the fourth sub-area 1224, the fifth sub-area 1225, and the sixth sub-area 1226. A first input element 1221a, a second input element 1222a, a third input element 1223a, a fourth input element 1224a, and a fifth input element 1225a may be displayed in the first sub-area 1221, the second sub-area 1222, the third sub-area 1223, the fourth sub-area 1224, and the fifth sub-area 1225, respectively. According to the various embodiments of the present disclosure, a sixth input element 1226a and a seventh input element 1226b may be displayed in the sixth sub-area 1226. A cursor 1240 may be displayed on the display module 1210. In the English input mode, according to the various embodiments of the present disclosure, a processor may control to display the shape of the third input element 1223a differently from that thereof in the Hangul input mode (namely, similarly to the shape of the English letter “O”) as illustrated in FIG. 12A. The third input element (e.g., 613a) in the Hangul input mode may be used to input various Hangul characters, such as Hangul vowels, in addition to the Hangul consonant “°,” but the third input element 1223a in the English input mode is mainly used to input the English letter “O.” Therefore, in the English input mode, the shape of the third input element 1223a may be displayed to be different from that of the third input element (e.g., 613a) in the Hangul input mode, which enables a user to intuitively understand that the third input element 1223a indicates the English letter “O.” However, this merely corresponds to one of various embodiments of the present disclosure, and the shape of the third input element 1223a illustrated in FIG. 12A may also be displayed to be identical to that of the third input element (e.g., 613a) in the Hangul input mode.

FIG. 12A illustrates an example of receiving, from a user 1230, an input for displaying the English letter “A” on the electronic device 1200. As illustrated in FIG. 12A, the input for displaying the English letter “A” on the electronic device 1200 may include a continuous drag input from the second sub-area 1222 to the fifth sub-area 1225 via the fourth sub-area 1224. The drag input may be received from, for example, the user 1230. When the drag input is received, the processor (e.g., the processor 220) of the electronic device 1200 may control to display the English letter “A” on the display module 1210 in response to the drag input.

FIG. 12B illustrates an example of receiving, from the user 1230, an input for displaying the English letter “B” on the electronic device 1200. As illustrated in FIG. 12B, the input for displaying the English letter “B” on the electronic device 1200 may include two continuous drag inputs \textcircled{2} and \textcircled{3} from the first sub-area 1221 to the fifth sub-area 1225 via the second sub-area 1222, which are input within a predetermined period of time after a touch input \textcircled{1} for the fourth sub-area 1224. The touch input \textcircled{1} and the drag inputs \textcircled{2} and \textcircled{3} may be received from, for example, the user 1230 within a predetermined period of time. When the touch input \textcircled{1} and the drag inputs \textcircled{2} and \textcircled{3} are received, the processor may control to display the English letter “B” on the display module 1210 in response to the drag inputs.

FIG. 12C illustrates an example of receiving, from the user 1230, an input for displaying the English letter “C” on the electronic device 1200. As illustrated in FIG. 12C, the input for displaying the English letter “C” on the electronic device 1200 may include a continuous drag input from the first sub-area 1221 to the fifth sub-area 1225 via the fourth sub-area 1224. The drag input may be received from, for example, the user 1230. When the drag input is received, the processor may control to display the English letter “C” on the display module 1210 in response to the drag input.

FIG. 12D illustrates an example of receiving, from the user 1230, an input for displaying the English letter “D” on the electronic device 1200. As illustrated in FIG. 12D, the input for displaying the English letter “D” on the electronic device 1200 may include a continuous drag input from the fourth sub-area 1224 to the fifth sub-area 1225 via the first sub-area 1221 and the second sub-area 1222. The drag input may be received from, for example, the user 1230. When the drag input is received, the processor may control to display the English letter “D” on the display module 1210 in response to the drag input.

FIG. 12E illustrates an example of receiving, from the user 1230, an input for displaying the English letter “E” on the electronic device 1200. As illustrated in FIG. 12E, the input for displaying the English letter “E” on the electronic device 1200 may include a continuous drag input that starts from the first sub-area 1221 and returns to the first sub-area 1221 via the fourth sub-area 1224 and the fifth sub-area 1225. The drag input may be received from, for example, the user 1230. When the drag input is received, the processor may control to display the English letter “E” on the display module 1210 in response to the drag input.

FIG. 12F illustrates an example of receiving, from the user 1230, an input for displaying the English letter “F” on the electronic device 1200. As illustrated in FIG. 12F, the input for displaying the English letter “F” on the electronic device 1200 may include a continuous drag input from the first sub-area 1221 to the fifth sub-area 1225 via the fourth sub-area 1224. The drag input may be received from, for example, the user 1230. When the drag input is received, the processor may control to display the English letter “F” on the display module 1210 in response to the drag input.

FIG. 12G illustrates an example of receiving, from the user 1230, an input for displaying the English letter “G” on the electronic device 1200. As illustrated in FIG. 12G, the input for displaying the English letter “G” on the electronic device 1200 may include a continuous drag input from the first sub-area 1221 to the second sub-area 1222 via the fourth sub-area 1224 and the fifth sub-area 1225. The drag input may be received from, for example, the user 1230. When the drag input is received, the processor may control to display the English letter “G” on the display module 1210 in response to the drag input.

FIG. 12H illustrates an example of receiving, from the user 1230, an input for displaying the English letter “H” on the electronic device 1200. As illustrated in FIG. 12H, the input for displaying the English letter “H” on the electronic device 1200 may include a continuous drag input from the fourth sub-area 1224 to the second sub-area 1222 via the first sub-area 1221. The drag input may be received from, for example, the user 1230. When the drag input is received, the processor may control to display the English letter “H” on the display module 1210 in response to the drag input.

FIG. 12I illustrates an example of receiving, from the user 1230, an input for displaying the English letter “I” on the electronic device 1200. As illustrated in FIG. 12I, the input for displaying the English letter “I” on the electronic device 1200 may include a touch input for the second sub-area 1222. The touch input may be received from, for example, the user 1230. When the touch input is received, the processor may control to display the English letter “I” on the display module 1210 in response to the touch input. According to various embodiments of the present disclosure, the fourth sub-area 1224 may also be used to input the English letter “I,” instead of the second sub-area 1222.

FIG. 12J illustrates an example of receiving, from the user 1230, an input for displaying the English letter “J” on the electronic device 1200. As illustrated in FIG. 12J, the input for displaying the English letter “J” on the electronic device 1200 may include a continuous drag input from the first sub-area 1221 to the second sub-area 1222. The drag input may be received from, for example, the user 1230. When the drag input is received, the processor may control to display the English letter “J” on the display module 1210 in response to the drag input.

FIG. 12K illustrates an example of receiving, from the user 1230, an input for displaying the English letter “K” on the electronic device 1200. As illustrated in FIG. 12K, the input for displaying the English letter “K” on the electronic device 1200 may include a continuous drag input that starts from the fourth sub-area 1224 and returns to the fourth sub-area 1224 via the second sub-area 1222. The drag input may be received from, for example, the user 1230. When the drag input is received, the processor may control to display the English letter “K” on the display module 1210 in response to the drag input.

FIG. 12L illustrates an example of receiving, from the user 1230, an input for displaying the English letter “L” on the electronic device 1200. As illustrated in FIG. 12L, the input for displaying the English letter “L” on the electronic device 1200 may include a continuous drag input from the fourth sub-area 1224 to the fifth sub-area 1225. The drag input may be received from, for example, the user 1230. When the drag input is received, the processor may control to display the English letter “L” on the display module 1210 in response to the drag input.

FIG. 12M illustrates an example of receiving, from the user 1230, an input for displaying the English letter “M” on the electronic device 1200. As illustrated in FIG. 12M, the input for displaying the English letter “M” on the electronic device 1200 may include a continuous drag input that starts from the second sub-area 1222, returns to the second sub-area 1222 via the fourth sub-area 1224, and then proceeds to the fourth sub-area 1224 again. The drag input may be received from, for example, the user 1230. When the drag input is received, the processor may control to display the English letter “M” on the display module 1210 in response to the drag input.

FIG. 12N illustrates an example of receiving, from the user 1230, an input for displaying the English letter “N” on the electronic device 1200. As illustrated in FIG. 12N, the input for displaying the English letter “N” on the electronic device 1200 may include a continuous drag input that starts from the second sub-area 1222 and returns to the second sub-area 1222 via the fourth sub-area 1224. The drag input may be received from, for example, the user 1230. When the drag input is received, the processor may control to display the English letter “N” on the display module 1210 in response to the drag input.

FIG. 12O illustrates an example of receiving, from the user 1230, an input for displaying the English letter “O” on the electronic device 1200. As illustrated in FIG. 12O, the input for displaying the English letter “O” on the electronic device 1200 may include a touch input for the third sub-area 1223. The touch input may be received from, for example, the user 1230. When the touch input is received, the processor may control to display the English letter “O” on the display module 1210 in response to the touch input.

FIG. 12P illustrates an example of receiving, from the user 1230, an input for displaying the English letter “P” on the electronic device 1200. As illustrated in FIG. 12P, the input for displaying the English letter “P” on the electronic device 1200 may include a continuous drag input that starts from the fourth sub-area 1224 and returns to the fourth sub-area 1224 via the first sub-area 1221 and the second sub-area 1222. The drag input may be received from, for example, the user 1230. When the drag input is received, the processor may control to display the English letter “P” on the display module 1210 in response to the drag input.

FIG. 12Q illustrates an example of receiving, from the user 1230, an input for displaying the English letter “Q” on the electronic device 1200. As illustrated in FIG. 12Q, the input for displaying the English letter “Q” on the electronic device 1200 may include a continuous drag input from the first sub-area 1221 to the third sub-area 1223 via the fourth sub-area 1224, the fifth sub-area 1225, and the second sub-area 1222. The drag input may be received from, for example, the user 1230. When the drag input is received, the processor may control to display the English letter “Q” on the display module 1210 in response to the drag input. According to various embodiments of the present disclosure, the English letter “Q” may also be input to the electronic device 1200 (in the form of a wearable device) through a continuous drag input from the third sub-area 1223 to the second sub-area 1222.

FIG. 12R illustrates an example of receiving, from the user 1230, an input for displaying the English letter “R” on the electronic device 1200. As illustrated in FIG. 12R, the input for displaying the English letter “R” on the electronic device 1200 may include a continuous drag input from the fourth sub-area 1224 to the fifth sub-area 1225 via the first sub-area 1221, the second sub-area 1222, and the fourth sub-area 1224. The drag input may be received from, for example, the user 1230. When the drag input is received, the processor may control to display the English letter “R” on the display module 1210 in response to the drag input.

FIG. 12S illustrates an example of receiving, from the user 1230, an input for displaying the English letter “S” on the electronic device 1200. As illustrated in FIG. 12S, the input for displaying the English letter “S” on the electronic device 1200 may include a continuous drag input from the first sub-area 1221 to the fifth sub-area 1225 via the second sub-area 1222 and the fourth sub-area 1224. The drag input may be received from, for example, the user 1230. When the drag input is received, the processor may control to display the English letter “S” on the display module 1210 in response to the drag input.

FIG. 12T illustrates an example of receiving, from the user 1230, an input for displaying the English letter “T” on the electronic device 1200. As illustrated in FIG. 12T, the input for displaying the English letter “T” on the electronic device 1200 may include a continuous drag input from the first sub-area 1221 to the fourth sub-area 1224. The drag input may be received from, for example, the user 1230. When the drag input is received, the processor may control to display the English letter “T” on the display module 1210 in response to the drag input.

FIG. 12U illustrates an example of receiving, from the user 1230, an input for displaying the English letter “U” on the electronic device 1200. As illustrated in FIG. 12U, the input for displaying the English letter “U” on the electronic device 1200 may include a continuous drag input from the fourth sub-area 1224 to the second sub-area 1222 via the fifth sub-area 1225. The drag input may be received from, for example, the user 1230. When the drag input is received, the processor may control to display the English letter “U” on the display module 1210 in response to the drag input.

FIG. 12V illustrates an example of receiving, from the user 1230, an input for displaying the English letter “V” on the electronic device 1200. As illustrated in FIG. 12V, the input for displaying the English letter “V” on the electronic device 1200 may include a continuous drag input from the fourth sub-area 1224 to the second sub-area 1222. The drag input may be received from, for example, the user 1230. When the drag input is received, the processor may control to display the English letter “V” on the display module 1210 in response to the drag input.

FIG. 12W illustrates an example of receiving, from the user 1230, an input for displaying the English letter “W” on the electronic device 1200. As illustrated in FIG. 12W, the input for displaying the English letter “W” on the electronic device 1200 may include a continuous drag input that starts from the fourth sub-area 1224, returns to the fourth sub-area 1224 via the second sub-area 1222, and then proceeds to the second sub-area 1222 again. The drag input may be received from, for example, the user 1230. When the drag input is received, the processor may control to display the English letter “W” on the display module 1210 in response to the drag input.

FIG. 12X illustrates an example of receiving, from the user 1230, an input for displaying the English letter “X” on the electronic device 1200. As illustrated in FIG. 12X, the input for displaying the English letter “X” on the electronic device 1200 may include a continuous drag input from the second sub-area 1222 to the fourth sub-area 1224. The drag input may be received from, for example, the user 1230. When the drag input is received, the processor may control to display the English letter “X” on the display module 1210 in response to the drag input.

FIG. 12Y illustrates an example of receiving, from the user 1230, an input for displaying the English letter “Y” on the electronic device 1200. As illustrated in FIG. 12Y, the input for displaying the English letter “Y” on the electronic device 1200 may include a touch input \textcircled{2} for the second sub-area 1222 that is input within a predetermined period of time after a continuous drag input \textcircled{1} from the fourth sub-area 1224 to the second sub-area 1222. According to various embodiments of the present disclosure, the touch input \textcircled{2} may include a short touch input. The drag input \textcircled{1} and the touch input \textcircled{2} may be received from, for example, the user 1230. When the drag input \textcircled{1} and the touch input \textcircled{2} are received, the processor may control to display the English letter “Y” on the display module 1210 in response to the drag inputs.

FIG. 12Z illustrates an example of receiving, from the user 1230, an input for displaying the English letter “Z” on the electronic device 1200. As illustrated in FIG. 12Z, the input for displaying the English letter “Z” on the electronic device 1200 may include a continuous drag input from the first sub-area 1221 to the fifth sub-area 1225 via the second sub-area 1222. The drag input may be received from, for example, the user 1230. When the drag input is received, the processor may control to display the English letter “Z” on the display module 1210 in response to the drag input.

In FIGS. 12A to 12Z, the drag inputs and/or the touch inputs have been exemplified as the inputs for displaying the English alphabet. However, the drag inputs and/or the touch inputs may be replaced by various types of input events, such as a touch, hovering, a tap, a swipe, a flick, and/or rotation. The inputs for displaying the characters (e.g., the English alphabet) may be listed in Table IV below with reference to FIG. 5. The mapping table, which is defined as in Table IV below, may have been stored in a storage module (e.g., the memory 230) of the electronic device 1200. When an input for displaying an English letter is received, the processor may determine which English letter is indicated by the received input based on the mapping table, such Table IV, which has been stored in the storage module. “Comma (,)” in Table IV below may mean that inputs before and after the “Comma (,)” are not continuously performed.

### Table IV

Character Input Sequence
“A” (2)→(4)→(5)
“B” (4), (1)→(2)→(5), (1)→(2)→(5)
“C” (1)→(4)→(5)
“D” (4)→(1)→(2)→(5)
“E” (1)→(4)→(5)→(1)
“F” (1)→(4)→(5)
“G” (1)→(4)→(5)→(2)
“H” (4)→(1)→(2)
“I” (2)
“J” (1)→(2)
“K” (4)→(2)→(4)
Character Input Sequence
“L” (4)→(5)
“M” (2)→(4)→(2)→(4)
“N”(2)→(4)→(2)
“O” (3)
“P” (4)→(1)→(2)→(4)
“Q” (1)→(4)→(5)→(2)→(3)
“R” (4)→(1)→(2)→(4)→(5)
“S” (1)→(2)→(4)→(5)
“T” (1)→(4)
“U” (4)→(5)→(2)
“V” (4)→(2)
“W” (4)→(2)→(4)→(2)
“X” (2)→(4)
“Y” (4)→(2), (2)
“Z” (1)→(2)→(5)

Although the capital letters are illustrated as English letters in FIGS. 12A to 12Z, this is only for description of the present disclosure. According to various embodiments of the present disclosure, the capital letters may be changed by lowercase letters according to the setting of the user 1230.

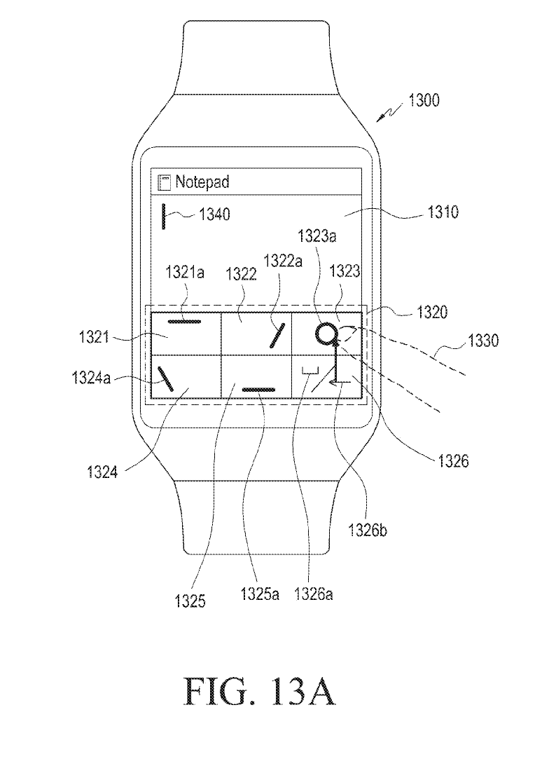

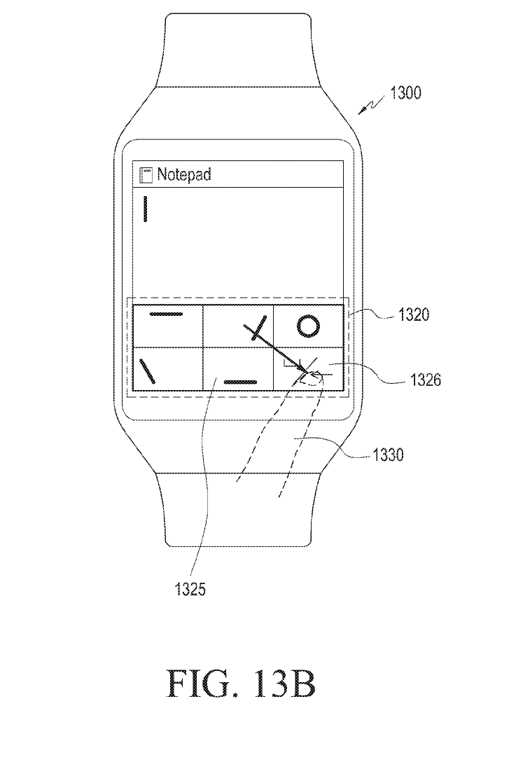

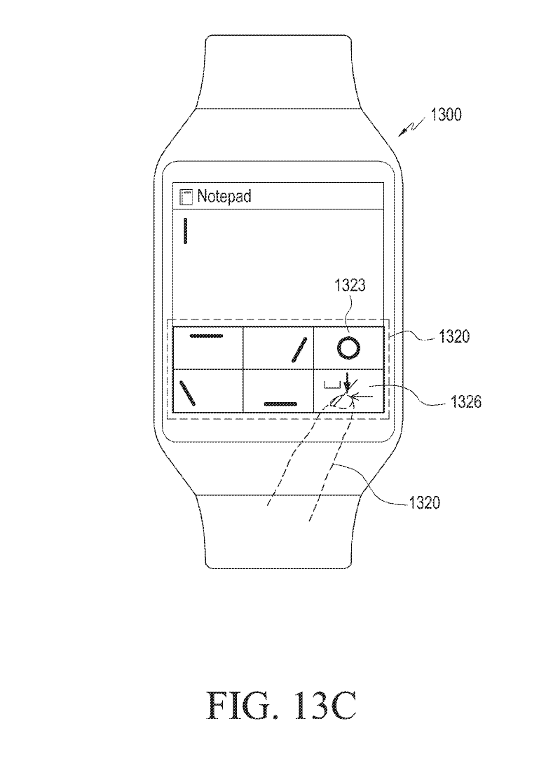

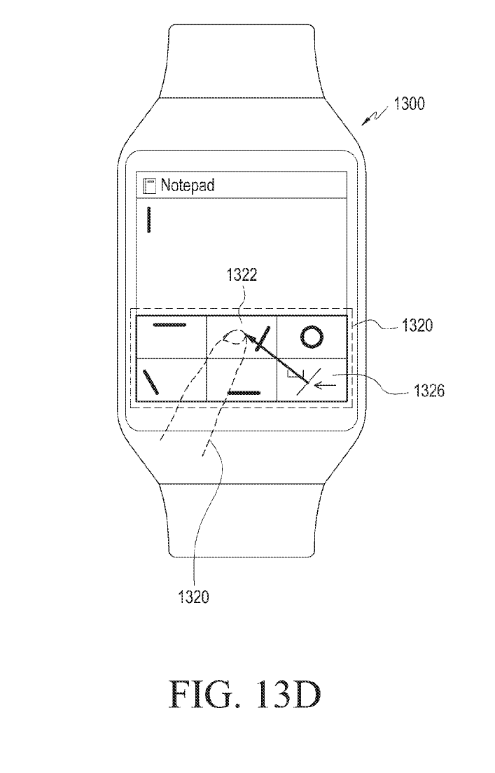

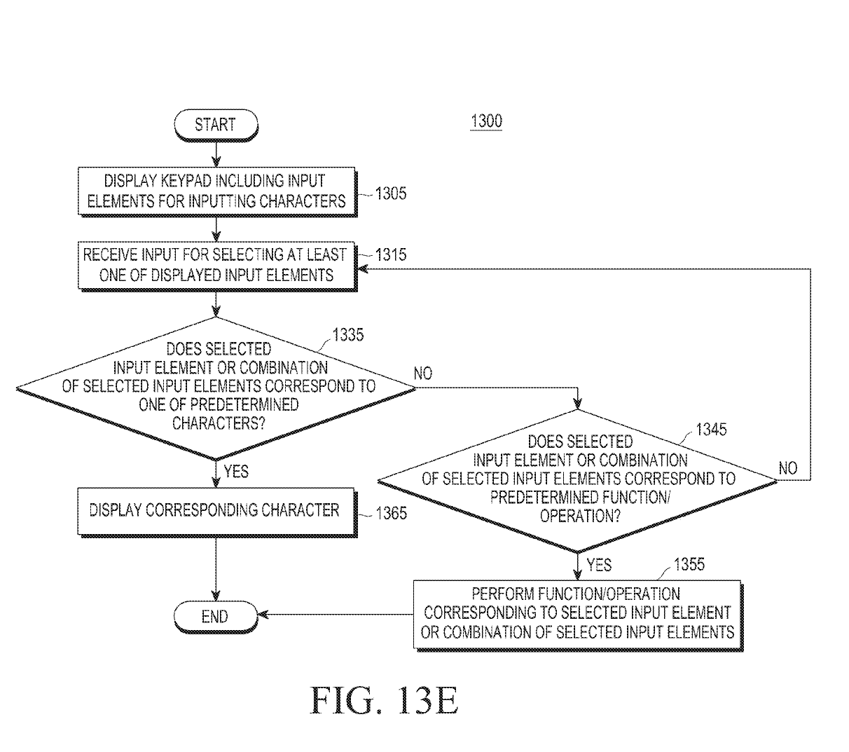

FIGS. 13A to 13D are exemplary views illustrating various function(s) or operation(s) that are performed by an electronic device in the form of a wearable device 1300 according to a user input. Referring to FIG. 13A, a keypad 1320 may be displayed on a display module 1310 of the wearable device 1300 according to various embodiments of the present disclosure. The keypad 1320 may include a first sub-area 1321, a second sub-area 1322, a third sub-area 1323, a fourth sub-area 1324, a fifth sub-area 1325, and a sixth sub-area 1326. A first input element 1321a, a second input element 1322a, a third input element 1323a, a fourth input element 1324a, and a fifth input element 1325a may be displayed in the first sub-area 1321, the second sub-area 1322, the third sub-area 1323, the fourth sub-area 1324, and the fifth sub-area 1325, respectively. According to the various embodiments of the present disclosure, a sixth input element 1326a and a seventh input element 1326b may be displayed in the sixth sub-area 1326. A cursor 1340 may be displayed on the display module 1310.

Referring to FIG. 13A, in an English input mode, the wearable device 1300 may receive, from a user 1330, a continuous drag input as illustrated in FIG. 13A. When the continuous drag input from the sixth sub-area 1326 to the third sub-area 1323 is received as illustrated in FIG. 13A, the processor (e.g., the processor 220) of the wearable device 1300 may change from a capital-letter input mode to a lowercase-letter input mode (or, from the lowercase-letter input mode to the capital-letter input mode).

Referring to FIG. 13B, the wearable device 1300 may receive, from the user 1330, a continuous drag input as illustrated in FIG. 13B. When the continuous drag input from the second sub-area 1322 to the sixth sub-area 1326 is received as illustrated in FIG. 13B, the processor may control to perform a function or operation (e.g., a function or operation performed by a backspace key) that is specified by the seventh input element 1326b. Although not illustrated, according to various embodiments of the present disclosure, when a short touch (namely, a touch input for a predetermined period of time or less) to the sixth sub-area 1326 is received from the user, the processor may control to perform a function or operation (e.g., a function or operation performed by a space key) that is specified by the sixth input element 1326a.

Referring to FIG. 13C, the wearable device 1300 may receive, from the user 1330, a long touch input as illustrated in FIG. 13C. When the long touch input is received as illustrated in FIG. 13C, the processor may control to display a user setting screen on the display module 1310. The user setting screen may include various items that can control: the attributes of the keypad 1320, such as a capital/lowercase letter switching item, a resolution adjusting item, and/or an item for adjusting the size of the keypad 1320; and/or the attributes of characters that are input through the keypad 1320. For example, the user may also switch between the capital letter and the lowercase letter of an English letter, which is input to the wearable device 1300, by selecting the capital/lowercase letter switching item that is included in the user setting screen.

Referring to FIG. 13D, the wearable device 1300 may receive, from the user 1330, a continuous drag input as illustrated in FIG. 13D. When the continuous drag input from the sixth sub-area 1326 to the second sub-area 1322 is received as illustrated in FIG. 13D, the processor may control to display a screen (namely, a numeric keypad) for inputting a number on the wearable device 1300. Although not illustrated, when a continuous drag input from the fifth sub-area 1325 to the sixth sub-area 1326 is received, the processor, according to the various embodiments of the present disclosure, may control to display a screen for inputting a symbol (namely, a special character). The symbol may include various symbols, such as a circle character, a mathematical operator, a parenthesis character, a figure, and the like.

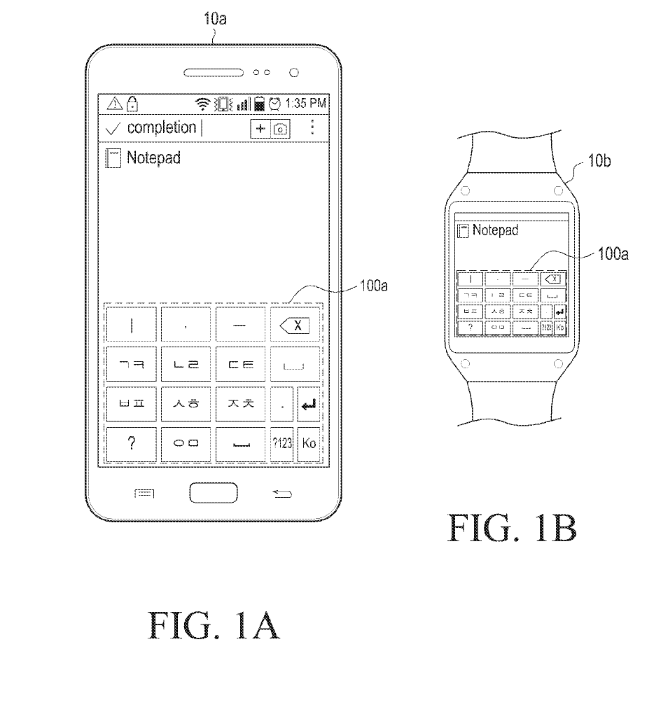

The drag inputs and/or the touch inputs have been exemplified as the inputs for performing the various functions or operations described in connection with FIGS. 13A to 13D. According to various embodiments of the present disclosure, the drag inputs and/or the touch inputs may be replaced by various types of input events, such as a touch, hovering, a tap, a swipe, a flick, and/or rotation. In order to perform the various function(s) or operation(s) described in connection with FIGS. 13A to 13D, the storage module of the wearable device 1300 may store a mapping table in which a relation between the functions or operations that have been described in connection with FIGS. 13A to 13D and the inputs of the user 1330 that are illustrated in FIGS. 13A to 13D is defined. Further, the various functions or operations described in connection with FIGS. 13A to 13D may also be identically performed in the Hangul input mode although the case where the inputs of the user 1330 are received in the English input mode is illustrated in FIGS. 13A to 13D. FIG. 13E is a flowchart illustrating a process 1300 in which the method of operating an electronic device (e.g., the electronic device 101 of FIG. 1), according to the various embodiments of the present disclosure, which is illustrated in FIG. 10, is performed in connection with the function(s) or operation(s) that are illustrated in FIGS. 13A to 13D.

At block 1305, the electronic device 101 displays a keypad that includes input elements for inputting characters. At block 1315, the electronic device 101 receives an input for selecting at least one of the displayed input elements. At block 1335, the electronic device 101 1335 determines whether the selected input element or a combination of the selected input elements corresponds to one of the predetermined characters (e.g., the Hangul or the English alphabet). At block 1365, the electronic device 101 displays the corresponding character on the wearable device when the selected input element or a combination of the selected input elements corresponds to one of the predetermined characters. At block 1345, the electronic device 101 determines whether the selected input element or the combination of the selected input elements corresponds to a predetermined function/operation in cases where the selected input element or a combination of the selected input elements does not correspond to one of the predetermined characters. At block 1355, the electronic device 101 performs the corresponding function/operation when the determination result in block 1345 shows that the selected input element or the combination of the selected input elements corresponds to the predetermined function/operation. The function/operation that corresponds to the selected input element or the combination of the selected input elements may include the various function(s) or operation(s) described in connection with FIGS. 13A to 13D. The electronic device 101 repeats block 1315 when the determination result in operation 1345 shows that the selected input element or the combination of the selected input elements does not correspond to the predetermined function/operation. In addition, the above descriptions regarding FIGS. 10 and 13A to 13D may be identically applied to the method of operating the electronic device, according to the various embodiments of the present disclosure, which is associated with FIG. 13E, within a range in which the descriptions do not conflict with the contents that have been described in connection with FIG. 13E.

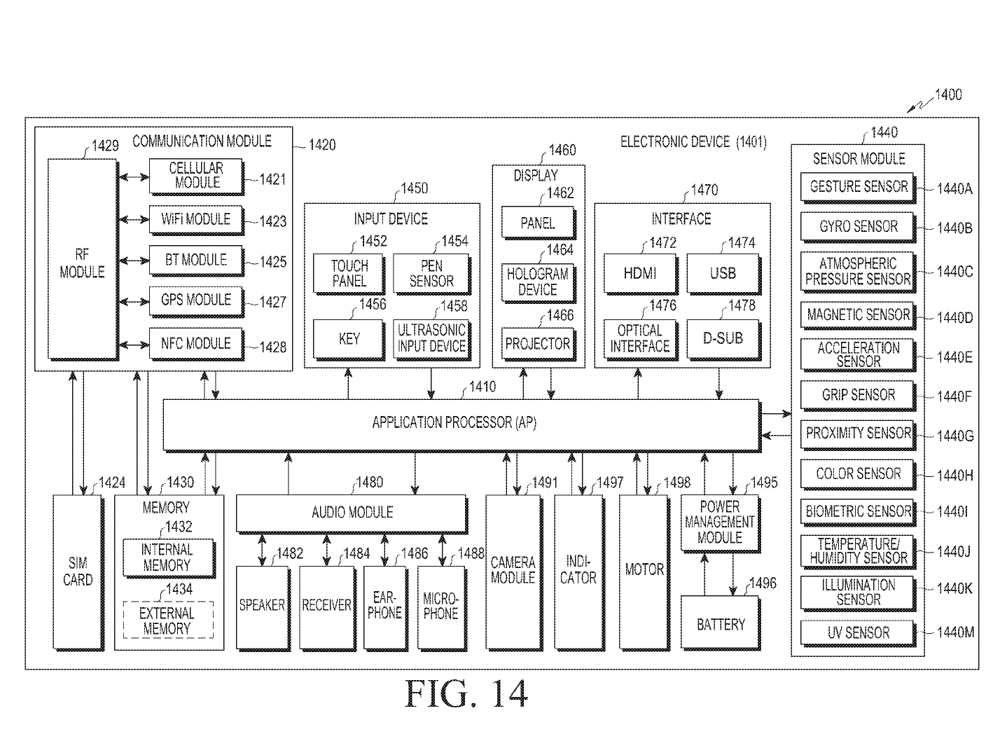

FIG. 14 is a block diagram of an electronic device according to various embodiments of the present disclosure.

Referring to FIG. 14, the electronic device 1400 may include, for example, the entirety or a part of the electronic device 201 illustrated in FIG. 2. The electronic device 1400 may include an Application Processor (AP) 1410, a communication module 1420, a Subscriber Identification Module (SIM) card 1424, a memory 1430, a sensor module 1440, an input device 1450, a display 1460, an interface 1470, an audio module 1480, a camera module 1491, a power management module 1495, a battery 1496, an indicator 1497, and a motor 1498.

The AP 1410, for example, may control a plurality of hardware or software elements connected thereto and may perform a variety of data processing and calculations by driving an operating system or applications. The AP 1410 may be embodied as, for example, a System on Chip (SoC). According to an embodiment, the AP 1410 may further include a Graphic Processing Unit (GPU) and/or an image signal processor. The AP 1410 may also include at least some (e.g., a cellular module 1421) of the elements illustrated in FIG. 14. The AP 1410 may load instructions or data, which are received from at least one other element (e.g., a non-volatile memory), in a volatile memory to process the loaded instructions or data, and may store various types of data in a non-volatile memory.

The communication module 1420 may have the same or a similar configuration to the communication interface 270 of FIG. 2. The communication module 1420 may include, for example, the cellular module 1421, a Wi-Fi module 1423, a Bluetooth (BT) module 1425, a GPS module 1427, a near field communication (NFC) module 1428, and a Radio Frequency (RF) module 1429.

The cellular module 1421 may provide, for example, a voice call, video call, a text message service, or an Internet service through a communication network. According to an embodiment, the cellular module 1421 may distinguish and authenticate the electronic device 1400 in the communication network by using a subscriber identification module (e.g., the SIM card 1424). According to an embodiment, the cellular module 1421 may perform at least some of the functions that the AP 1410 may provide. According to an embodiment, the cellular module 1421 may include a Communication Processor (CP).

The Wi-Fi module 1423, the BT module 1425, the GPS module 1427, or the NFC module 1428 may include, for example, a processor for processing data transmitted/received through the corresponding module. According to an embodiment, at least some (two or more) of the cellular module 1421, the Wi-Fi module 1423, the BT module 1425, the GPS module 1427, and the NFC module 1428 may be included in a single Integrated Chip (IC) or a IC package.

The RF module 1429 may transmit/receive, for example, a communication signal (e.g., an RF signal). The RF module 1429 may include, for example, a transceiver, a Power Amp Module (PAM), a frequency filter, a Low Noise Amplifier (LNA), an antenna, etc. According to another embodiment, at least one of the cellular module 1421, the Wi-Fi module 1423, the BT module 1425, the GPS module 1427, and the NFC module 1428 may transmit/receive an RF signal through a separate RF module.

The SIM card 1424 may include, for example, a card that includes a subscriber identification module and/or an embedded SIM, and may contain unique identification information (e.g., an Integrated Circuit Card Identifier (ICCID)) or subscriber information (e.g., an International Mobile Subscriber Identity (IMSI)).

The memory 1430 (e.g., the memory 230) may include, for example, an internal memory 1432 or an external memory 1434. The internal memory 1432 may include at least one of, for example, a volatile memory (e.g., a Dynamic Random Access Memory (DRAM), a Static Random Access Memory (SRAM), a Synchronous Dynamic Random Access Memory (SDRAM), etc.) and a non-volatile memory (e.g., a One Time Programmable Read Only Memory (OTPROM), a Programmable Read Only Memory (PROM), an Erasable and Programmable Read Only Memory (EPROM), an Electrically Erasable and Programmable Read Only Memory (EEPROM), a mask Read Only Memory, a flash Read Only Memory, a flash memory (e.g., a Not AND (NAND) flash memory, a Not OR (NOR) flash memory, etc.), a hard disc drive, or a Solid State Drive (SSD)).

The external memory 1434 may further include a flash drive, for example, a Compact Flash (CF), a Secure Digital (SD), a Micro Secure Digital (Micro-SD), a Mini Secure Digital (Mini-SD), an extreme Digital (xD), a memory stick, and etc. The external memory 1434 may be functionally and/or physically connected to the electronic device 1400 through various interfaces.

The sensor module 1440 may, for example, measure a physical quantity or detect the operating state of the electronic device 1400, and may convert the measured or detected information to an electrical signal. The sensor module 1440 may include at least one of, for example, a gesture sensor 1440A, a gyro sensor 1440B, an atmospheric pressure sensor 1440C, a magnetic sensor 1440D, an acceleration sensor 1440E, a grip sensor 1440F, a proximity sensor 1440G, a color sensor 1440H (e.g., Red, Green, and Blue (RGB) sensor), a biometric sensor 1440I, a temperature/humidity sensor 1440I, an illumination sensor 1440K, and an Ultra Violet (UV) sensor 1440M. Additionally or alternatively, the sensor module 1440 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1440 may further include a control circuit for controlling at least one sensor included therein. In an embodiment, the electronic device 1400 may further include a processor that is configured to control the sensor module 1440 as a part of the AP 1410 or separately from the AP 1410, and may control the sensor module 1440 while the AP 1410 is in a sleep state.

The input device 1450 may include, for example, a touch panel 1452, a (digital) pen sensor 1454, a key 1456, and an ultrasonic input unit 1458. The touch panel 1452 may use at least one of, for example, a capacitive type, a resistive type, an infrared type, and an ultrasonic type. In addition, the touch panel 1452 may further include a control circuit. The touch panel 1452 may further include a tactile layer to provide a tactile reaction to a user.

The (digital) pen sensor 1454 may be, for example, a part of the touch panel, or may include a separate recognition sheet. The key 1456 may include, for example, a physical button, an optical key, or a keypad. The ultrasonic input unit 1458 may identify data by sensing sound waves with a microphone (e.g., the microphone 1488) in the electronic device 1400 through an input tool that generates ultrasonic signals.

The display 1460 (e.g., the display 260) may include a panel 1462, a hologram device 1464, or a projector 1466. The panel 1462 may include the same or a similar configuration to the display 260 of FIG. 2. The panel 1462 may be embodied to be, for example, flexible, transparent, or wearable. The panel 1462, together with the touch panel 1452, may also be configured as a single module. The hologram device 1464 may show a stereoscopic image in the air by using interference of light. The projector 1466 may project light onto a screen to display an image. For example, the screen may be located in the interior or on the exterior of the electronic device 1400. According to an embodiment, the display 1460 may further include a control circuit for controlling the panel 1462, the hologram device 1464, or the projector 1466.

The interface 1470 may include, for example, a High-Definition Multimedia Interface (HDMI) 1472, a Universal Serial Bus (USB) 1474, an optical interface 1476, or a D-subminiature (D-sub) 1478. The interface 1470 may be included in, for example, the communication interface 270 illustrated in FIG. 2. Additionally or alternatively, the interface 1470 may include, for example, a Mobile High-definition Link (MHL) interface, a Secure Digital (SD) card/Multi-Media Card (MMC) interface, or an Infrared Data Association (IrDA) standard interface.

The audio module 1480, for example, may convert a sound into an electrical signal, and vice versa. At least some elements of the audio module 1480 may be included in, for example, the input/output interface 250 illustrated in FIG. 2. The audio module 1480 may process sound information that is input or output through, for example, a speaker 1482, a receiver 1484, earphones 1486, the microphone 1488, etc.

The camera module 1491 may take a still image and a moving image. According to an embodiment, the camera module 291 may include one or more image sensors (e.g., a front sensor and a rear sensor), a lens, an Image Signal Processor (ISP), or a flash (e.g., an LED or a xenon lamp).

The power management module 1495, for example, may manage the power of the electronic device 1400. According to an embodiment, the power management module 1495 may include a Power Management Integrated Circuit (PMIC), a charger Integrated Circuit (IC), or a battery or fuel gauge. The PMIC may have a wired and/or wireless charging scheme. Examples of the wireless charging method may include, for example, a magnetic resonance method, a magnetic induction method, an electromagnetic wave method, etc. Additional circuits (e.g., a coil loop, a resonance circuit, a rectifier, etc.) for wireless charging may be further included. The battery gauge may measure, for example, the residual quantity of the battery 1496 and a charging voltage, current, or temperature. The battery 1496 may include, for example, a rechargeable battery and/or a solar battery.

The indicator 1497 may indicate a specific status of the electronic device 1400 or a part thereof (e.g., the AP 1410), for example, a booting status, a message status, a charging status, etc. The motor 1498 may convert an electrical signal into a mechanical vibration, and may generate a vibration or haptic effect. Although not illustrated, the electronic device 1400 may include a processing device (e.g., a GPU) for supporting mobile TV. The processing device for supporting mobile TV may process media data according to a standard of Digital Multimedia Broadcasting (DMB), Digital Video Broadcasting (DVB), media flow, etc.

Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements. Further, some of the components of the electronic device according to the various embodiments of the present disclosure may be combined to form a single entity, and thus, may equivalently execute functions of the corresponding elements prior to the combination.

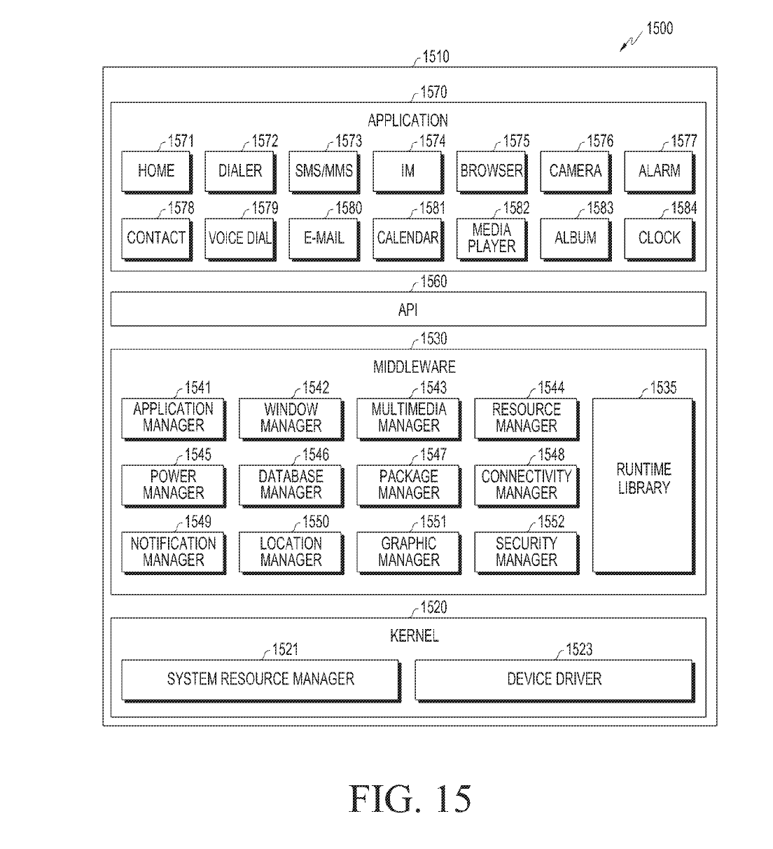

FIG. 15 is a block diagram of a program module according to various embodiments of the present disclosure.

Referring to FIG. 15, according to an embodiment, the program module 1510 (e.g., the program 240) may include an Operating System (OS) that controls resources related to an electronic device (e.g., the electronic device 201) and/or various applications (e.g., the applications 247) that are executed in the operating system. The operating system may be, for example, Android, iOS, Windows, Symbian, Tizen, Bada, and etc.

The program module 1510 may include a kernel 1520, middleware 1530, an Application Programming Interface (API) 1560, and/or applications 1570. At least a part of the program module 1510 may be preloaded in the electronic device, or may be downloaded from a server (e.g., the server 206).

The kernel 1520 (e.g., the kernel 241) may include, for example, a system resource manager 1521 or a device driver 1523. The system resource manager 1521 may control, allocate, or collect the system resources. According to an embodiment, the system resource manager 1521 may include a process management unit, a memory management unit, a file system management unit, etc. The device driver 1523 may include, for example, a display driver, a camera driver, a Bluetooth driver, a shared-memory driver, a USB driver, a keypad driver, a WI-FI driver, an audio driver, or an Inter-Process Communication (IPC) driver.

The middleware 1530 may provide, for example, a function required by the applications 1570 in common, or may provide various functions to the applications 1570 through the API 1560 so that the applications 1570 can efficiently use the limited system resources in the electronic device. According to an embodiment, the middleware 1530 may include at least one of a runtime library 1535, an application manager 1541, a window manager 1542, a multimedia manager 1543, a resource manager 1544, a power manager 1545, a database manager 1546, a package manager 1547, a connectivity manager 1548, a notification manager 1549, a location manager 1550, a graphic manager 1551, and a security manager 1552.

The runtime library 1535 may include, for example, a library module that a compiler uses in order to add new functions through a programming language while the applications 1570 are executed. The runtime library 1535 may perform input/output management, memory management, a function for an arithmetic function, etc.

The application manager 1541 may manage, for example, the life cycle of at least one of the applications 1570. The window manager 1542 may manage Graphic User Interface (GUI) resources that are used in a screen. The multimedia manager 1543 may identify formats that are required for reproducing various types of media files, and may encode or decode a media file using a codec suitable for the corresponding format. The resource manager 1544 may manage resources of at least one of the applications 1570, such as a source code, a memory, a storage space, etc.

The power manager 1545 may operate together with, for example, a Basic Input/Output System (BIOS) so as to manage a battery or power, and may provide power information required for the operation of the electronic device. The database manager 1546 may generate, search, or change a database to be used by at least one of the applications 1570. The package manager 1547 may manage the installation or updating of an application that is distributed in the form of a package file.

The connectivity manager 1548 may manage, for example, wireless connections, such as WI-FI, Bluetooth, etc. The notification manager 1549 may display or notify of events, such as a received message, an appointment, a proximity notification, etc., to a user without disturbance. The location manager 1550 may manage the location information of the electronic device. The graphic manager 1551 may manage graphic effects to be provided to a user and user interfaces related to the graphic effects. The security manager 1552 may provide various security functions required for system security, user authentication, etc. According to an embodiment, in cases where the electronic device (e.g., electronic device 201) has a telephone call function, the middleware 1530 may further include a telephony manager for managing a voice call function or a video call function of the electronic device.

The middleware 1530 may include a middleware module that forms a combination of various functions of the aforementioned elements. The middleware 1530 may provide specialized modules according to the types of operating systems in order to provide differentiated functions. In addition, the middleware 1530 may dynamically remove some of the existing elements, or may add new elements.

The API 1560 (e.g., the API 245) is a set of API programming functions, and may include different configurations according to operating systems. For example, in the case of Android or iOS, one API set may be provided for each platform. In the case of Tizen, two or more API sets may be provided for each platform.

The applications 1570 (e.g., the applications 247 of FIG. 2) may include one or more of, for example, a home application 1571, a dialer application 1572, an SMS/MMS application 1573, an Instant Message (IM) application 1574, a browser application 1575, a camera application 1576, an alarm application 1577, a contact application 1578, a voice dial application 1579, and e-mail application 1580, a calendar application 1581, a media player application 1582, an album application 1583, a clock application 1584, a health care application (e.g., an application for measuring a work rate or blood sugar), and an environmental information application (e.g., an application for providing atmospheric pressure, humidity, or temperature information).

According to an embodiment, the applications 1570 may include an application (hereinafter, referred to as an “information exchange application” for convenience of description) that supports information exchange between the electronic device (e.g., the electronic device 201) and an external electronic device (e.g., the first electronic device 202 or the second electronic device 204). The information exchange application may include, for example, a notification relay application for transmitting specific information to the external electronic device, or a device management application for managing the external electronic device.

For example, the notification relay application may include a function of transferring, to the external electronic device (e.g., the first electronic device 202 or the second electronic device 204), notification information that is generated from the other applications of the electronic device (e.g., the SMS/MMS application, the e-mail application, the health management application, the environmental information application, etc.). Further, the notification relay application, for example, may receive notification information from the external electronic device and may provide the received notification information to a user. The device management application may manage (e.g., install, delete, or update), for example, at least one function of the external electronic device (e.g., the second electronic device 204) that communicates with the electronic device (e.g., a function of turning on/off the external electronic device itself (or some elements thereof) or a function of adjusting the brightness (or resolution) of a display), an application that is executed in the external electronic device, or a service that is provided from the external electronic device (e.g., a telephone call service or a message service).

According to an embodiment, the applications 1570 may include an application (e.g., a health management application) that is specified according to the attribute (e.g., the attribute of an electronic device, the type of which is a mobile medical device) of the external electronic device (e.g., the first electronic device 202, or the second electronic device 204). According to an embodiment, the applications 1570 may include an application received from the external electronic device (e.g., the first electronic device 202, the second electronic device 204, or the server 206). According to an embodiment, the applications 1570 may include a preloaded application or a third party application that can be downloaded from a server. Names of the elements of the program module 1510, according to the above-described embodiments of the present disclosure, may change depending on the type of OS.

According to various exemplary embodiments of the present disclosure, at least some of the program module 1510 may be implemented in software, firmware, hardware, or a combination of two or more thereof. At least some of the programming module 1510 may be implemented (e.g., executed) by, for example, the processor. The programming module 1510 may include, for example, a module, program, routine, sets of instructions, process, or the like for performing one or more functions.

The term “module” as used herein may, for example, mean a unit including one of hardware, software, and firmware or a combination of two or more of them. The “module” may be interchangeably used with, for example, the term “unit,” “logic,” “logical block,” “component,” or “circuit.” The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (e.g., modules or functions thereof) or the method (e.g., operations) according to the present disclosure may be implemented by a command stored in a computer-readable storage medium in a programming module form. The instruction, when executed by a processor (e.g., the processor 220), may cause the one or more processors to execute the function corresponding to the instruction. The computer-readable storage medium may be, for example, the memory 230.

The computer readable recoding medium may include a hard disk, a floppy disk, magnetic media (e.g., a magnetic tape), optical media (e.g., a Compact Disc Read Only Memory (CD-ROM) and a Digital Video Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

What is claimed is:

1. An electronic device comprising:
a display module; and
a processor that controls to display, on the display module, a keypad having a plurality of input elements to input a character to the electronic device,
wherein some of the plurality of the input elements displayed correspond to a location where a character element that forms the character is disposed and a pattern in which a user uses the character.

2. The electronic device of claim 1, wherein some of the plurality of input elements are displayed as a plurality of sub-areas of the keypad.

3. The electronic device of claim 2, wherein some of the plurality of input elements comprise a first input element, a second input element, a third input element, a fourth input element, a fifth input element, a sixth input element, and a seventh input element, and the sub-areas comprise a first sub-area, a second sub-area, a third sub-area, a fourth sub-area, a fifth sub-area, and a sixth sub-area, wherein the first input element, the second input element, the third input element, the fourth input element, the fifth input element, and the sixth input element are displayed on the electronic device while being included in the first sub-area, the second sub-area, the third sub-area, the fourth sub-area, the fifth sub-area, and the sixth sub-area, respectively.

4. The electronic device of claim 3, wherein the first input element is displayed to be located on an upper side of the first sub-area with respect to a center line of the first sub-area.

5. The electronic device of claim 3, wherein the fifth input element is displayed to be located on a lower side of the fifth sub-area with respect to a center line of the fifth sub-area.

6. The electronic device of claim 3, wherein the second and fourth input elements are displayed in the second and fourth sub-areas so as to be inclined at a predetermined angle, respectively.

7. The electronic device of claim 1, wherein the display module comprises a touch screen, and the touch screen receives a touch input to select at least one of the input elements displayed in order to input the character.

8. The electronic device of claim 7, wherein the processor determines whether the input element selected or a combination of some of the input elements selected corresponds to one of a plurality of predetermined characters.

9. A method of operating an electronic device, comprising:
displaying a keypad having a plurality of input elements to input a character;
receiving an input to select at least one of the input elements displayed; and
displaying a character corresponding to some of the plurality of input elements selected,
wherein some of the plurality of the input elements displayed correspond to a location of a character element that forms the character and a use pattern of the character.

10. The method of claim 9, wherein some of the plurality of input elements are displayed as a plurality of sub-areas of the keypad.

11. The method of claim 10, wherein some of the plurality of input elements comprise a first input element, a second input element, a third input element, a fourth input element, a fifth input element, a sixth input element, and a seventh input element, and the sub-areas comprise a first sub-area, a second sub-area, a third sub-area, a fourth sub-area, a fifth sub-area, and a sixth sub-area, wherein the first input element, the second input element, the third input element, the fourth input element, the fifth input element, and the sixth input element are displayed on the electronic device while being included in the first sub-area, the second sub-area, the third sub-area, the fourth sub-area, the fifth sub-area, and the sixth sub-area, respectively.

12. The method of claim 11, wherein the first input element is displayed to be located on an upper side of the first sub-area with respect to a center line of the first sub-area.

13. The method of claim 11, wherein the fifth input element is displayed to be located on a lower side of the fifth sub-area with respect to a center line of the fifth sub-area.

14. The method of claim 11, wherein the second and fourth input elements are displayed in the second and fourth sub-areas so as to be inclined at a predetermined angle, respectively.

15. The method of claim 9, wherein receiving of the input to select some of the plurality of input elements is performed through a touch input on the keypad.

16. The method of claim 9, further comprising:
determining whether the input element selected or a combination of the input elements selected corresponds to one of a plurality of predetermined characters.

17. A computer readable recording medium that has instructions stored therein to allow a processor to perform an operation, wherein the operation comprises:
displaying a keypad having a plurality of input elements to input a character;
receiving an input to select at least one of the input elements displayed; and
displaying a character corresponding to the at least one input element selected based on the at least one input element selected,
wherein at least some of the input elements displayed correspond to a location of a character element that forms the character and a use pattern of the character.
